(19) United States
(12) Patent Application Publication
(10) Pub. No.: US 2025/0349052 A1
(43) Pub. Date: Nov. 13, 2025

(54) TECHNIQUES FOR MANIPULATING CONTENT

(71) Applicant: Apple Inc., Cupertino, CA (US)

(72) Inventors: Daniel T. PRESTON, San Jose, CA (US); Aram D. KUDURSHIAN, San Francisco, CA (US); Matthew J. SUNDSTROM, Campbell, CA (US); Robert Garcia, III, San Francisco, CA (US); Stephen O. LEMAY, Palo Alto, CA (US)

(21) Appl. No.: 19/074,090

(22) Filed: Mar. 7, 2025

Related U.S. Application Data
(60) Provisional application No. 63/646,620, filed on May 13, 2024.
(60) Provisional application No. 63/657,508, filed on Jun. 7, 2024.

(51) Int. Cl. G06T 11/60; G06F 3/04845; G06T 11/20

(52) U.S. Cl. CPC G06T 11/60; G06F 3/04845; G06T 11/203

(57) ABSTRACT

The present disclosure generally relates to manipulating content. Some techniques are for generating and/or interacting with content in a space in accordance with some embodiments. Other techniques are for generating and/or interacting with content based on displayed content in accordance with some embodiments. Other techniques are for generating and/or interacting with content based on displayed text in accordance with some embodiments. Other techniques are for generating content in a generative state in accordance with some embodiments.

### CROSS-REFERENCE TO RELATED APPLICATIONS

This application claims priority to U.S. Provisional patent application Ser. No. 63/657,508, entitled “TECHNIQUES FOR MANIPULATING CONTENT” filed Jun. 7, 2024, and to U.S. Provisional patent application Ser. No. 63/646,620, entitled “TECHNIQUES FOR MANIPULATING CONTENT” filed May 13, 2024, which are hereby incorporated by reference in their entireties for all purposes.

### FIELD

The present disclosure relates generally to computer user interfaces, and more specifically to techniques for manipulating content.

### BACKGROUND

Existing techniques for generating content are generally cumbersome and inefficient. For example, some existing techniques use a complex and time-consuming user interface, which may include multiple key presses or keystrokes. Some existing techniques require more time than necessary, especially when users want to manipulate generated content, wasting user time and device energy.

### SUMMARY

Some techniques for manipulating content using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for manipulating content. Such methods and interfaces optionally complement or replace other methods for manipulating content. Such methods and interfaces reduce the cognitive burden on a user and produce a more efficient human-machine interface. For battery-operated computing devices, such methods and interfaces conserve power, increase the time between battery charges, and/or reduce number of unnecessary, extraneous, and/or repetitive inputs.

In some embodiments, a method that is performed at a computer system that is in communication with a display generation component and one or more input devices is described. In some embodiments, the method comprises: while displaying, via the display generation component, first content, detecting, via the one or more input devices, a first input corresponding to a first location; and in response to detecting the first input corresponding to the first location, displaying, via the display generation component: a first indication of the first input; and a second indication corresponding to a portion of the first content; and detecting, via the one or more input devices, a set of one or more inputs, wherein a second input of the set of one or more inputs is detected while displaying the second indication corresponding to the portion of the first content; and in response to detecting the set of one or more inputs, displaying, via the display generation component, second content corresponding to the second indication, wherein the second content is displayed at the first location, and wherein the second content is different from the first content.

In some embodiments, a non-transitory computer-readable storage medium storing one or more programs configured to be executed by one or more processors of a computer system that is in communication with a display generation component and one or more input devices is described. In some embodiments, the one or more programs includes instructions for: while displaying, via the display generation component, first content, detecting, via the one or more input devices, a first input corresponding to a first location; and in response to detecting the first input corresponding to the first location, displaying, via the display generation component: a first indication of the first input; and a second indication corresponding to a portion of the first content; and detecting, via the one or more input devices, a set of one or more inputs, wherein a second input of the set of one or more inputs is detected while displaying the second indication corresponding to the portion of the first content; and in response to detecting the set of one or more inputs, displaying, via the display generation component, second content corresponding to the second indication, wherein the second content is displayed at the first location, and wherein the second content is different from the first content.

In some embodiments, a transitory computer-readable storage medium storing one or more programs configured to be executed by one or more processors of a computer system that is in communication with a display generation component and one or more input devices is described. In some embodiments, the one or more programs includes instructions for: while displaying, via the display generation component, first content, detecting, via the one or more input devices, a first input corresponding to a first location; and in response to detecting the first input corresponding to the first location, displaying, via the display generation component: a first indication of the first input; and a second indication corresponding to a portion of the first content; and detecting, via the one or more input devices, a set of one or more inputs, wherein a second input of the set of one or more inputs is detected while displaying the second indication corresponding to the portion of the first content; and in response to detecting the set of one or more inputs, displaying, via the display generation component, second content corresponding to the second indication, wherein the second content is displayed at the first location, and wherein the second content is different from the first content.

In some embodiments, a computer system configured to communicate with a display generation component and one or more input devices is described. In some embodiments, the computer system comprises one or more processors and memory storing one or more programs configured to be executed by the one or more processors. In some embodiments, the one or more programs includes instructions for: while displaying, via the display generation component, first content, detecting, via the one or more input devices, a first input corresponding to a first location; and in response to detecting the first input corresponding to the first location, displaying, via the display generation component: a first indication of the first input; and a second indication corresponding to a portion of the first content; and detecting, via the one or more input devices, a set of one or more inputs, wherein a second input of the set of one or more inputs is detected while displaying the second indication corresponding to the portion of the first content; and in response to detecting the set of one or more inputs, displaying, via the display generation component, second content corresponding to the second indication, wherein the second content is displayed at the first location, and wherein the second content is different from the first content.

In some embodiments, a computer system configured to communicate with a display generation component and one or more input devices is described. In some embodiments, the computer system comprises means for performing each of the following steps: while displaying, via the display generation component, first content, detecting, via the one or more input devices, a first input corresponding to a first location; and in response to detecting the first input corresponding to the first location, displaying, via the display generation component: a first indication of the first input; and a second indication corresponding to a portion of the first content; and detecting, via the one or more input devices, a set of one or more inputs, wherein a second input of the set of one or more inputs is detected while displaying the second indication corresponding to the portion of the first content; and in response to detecting the set of one or more inputs, displaying, via the display generation component, second content corresponding to the second indication, wherein the second content is displayed at the first location, and wherein the second content is different from the first content.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: while displaying, via the display generation component, first content, detecting, via the one or more input devices, a first input corresponding to a first location; and in response to detecting the first input corresponding to the first location, displaying, via the display generation component: a first indication of the first input; and a second indication corresponding to a portion of the first content; and detecting, via the one or more input devices, a set of one or more inputs, wherein a second input of the set of one or more inputs is detected while displaying the second indication corresponding to the portion of the first content; and in response to detecting the set of one or more inputs, displaying, via the display generation component, second content corresponding to the second indication, wherein the second content is displayed at the first location, and wherein the second content is different from the first content.

In some embodiments, a method that is performed at a computer system that is in communication with a display generation component and one or more input devices is described. In some embodiments, the method comprises: while displaying, via the display generation component, first content, detecting, via the one or more input devices, a first input corresponding to a portion of the first content; in response to detecting the first input corresponding to the portion of the first content, displaying, via the display generation component: a representation of the portion of the first content; and an input mechanism; detecting, via the one or more input devices, a set of one or more inputs, wherein a second input of the set of one or more inputs is detected while displaying the representation of the portion of the first content; and in response to detecting the set of one or more inputs, displaying, via the display generation component, second content corresponding to the representation of the portion of the first content, wherein the second content is different from the first content.

In some embodiments, a non-transitory computer-readable storage medium storing one or more programs configured to be executed by one or more processors of a computer system that is in communication with a display generation component and one or more input devices is described. In some embodiments, the one or more programs includes instructions for: while displaying, via the display generation component, first content, detecting, via the one or more input devices, a first input corresponding to a portion of the first content; in response to detecting the first input corresponding to the portion of the first content, displaying, via the display generation component: a representation of the portion of the first content; and an input mechanism; detecting, via the one or more input devices, a set of one or more inputs, wherein a second input of the set of one or more inputs is detected while displaying the representation of the portion of the first content; and in response to detecting the set of one or more inputs, displaying, via the display generation component, second content corresponding to the representation of the portion of the first content, wherein the second content is different from the first content.

In some embodiments, a transitory computer-readable storage medium storing one or more programs configured to be executed by one or more processors of a computer system that is in communication with a display generation component and one or more input devices is described. In some embodiments, the one or more programs includes instructions for: while displaying, via the display generation component, first content, detecting, via the one or more input devices, a first input corresponding to a portion of the first content; in response to detecting the first input corresponding to the portion of the first content, displaying, via the display generation component: a representation of the portion of the first content; and an input mechanism; detecting, via the one or more input devices, a set of one or more inputs, wherein a second input of the set of one or more inputs is detected while displaying the representation of the portion of the first content; and in response to detecting the set of one or more inputs, displaying, via the display generation component, second content corresponding to the representation of the portion of the first content, wherein the second content is different from the first content.

In some embodiments, a computer system configured to communicate with a display generation component and one or more input devices is described. In some embodiments, the computer system comprises one or more processors and memory storing one or more programs configured to be executed by the one or more processors. In some embodiments, the one or more programs includes instructions for: while displaying, via the display generation component, first content, detecting, via the one or more input devices, a first input corresponding to a portion of the first content; in response to detecting the first input corresponding to the portion of the first content, displaying, via the display generation component: a representation of the portion of the first content; and an input mechanism; detecting, via the one or more input devices, a set of one or more inputs, wherein a second input of the set of one or more inputs is detected while displaying the representation of the portion of the first content; and in response to detecting the set of one or more inputs, displaying, via the display generation component, second content corresponding to the representation of the portion of the first content, wherein the second content is different from the first content.

In some embodiments, a computer system configured to communicate with a display generation component and one or more input devices is described. In some embodiments, the computer system comprises means for performing each of the following steps: while displaying, via the display generation component, first content, detecting, via the one or more input devices, a first input corresponding to a portion of the first content; in response to detecting the first input corresponding to the portion of the first content, displaying, via the display generation component: a representation of the portion of the first content; and an input mechanism; detecting, via the one or more input devices, a set of one or more inputs, wherein a second input of the set of one or more inputs is detected while displaying the representation of the portion of the first content; and in response to detecting the set of one or more inputs, displaying, via the display generation component, second content corresponding to the representation of the portion of the first content, wherein the second content is different from the first content.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: while displaying, via the display generation component, first content, detecting, via the one or more input devices, a first input corresponding to a portion of the first content; in response to detecting the first input corresponding to the portion of the first content, displaying, via the display generation component: a representation of the portion of the first content; and an input mechanism; detecting, via the one or more input devices, a set of one or more inputs, wherein a second input of the set of one or more inputs is detected while displaying the representation of the portion of the first content; and in response to detecting the set of one or more inputs, displaying, via the display generation component, second content corresponding to the representation of the portion of the first content, wherein the second content is different from the first content.

In some embodiments, a method that is performed at a computer system that is in communication with a display generation component and one or more input devices is described. In some embodiments, the method comprises: while displaying, via the display generation component, first content, detecting, via the one or more input devices, a first input corresponding to a first portion of the first content; in response to detecting the first input corresponding to the first portion of the first content, displaying, via the display generation component: a representation of the first portion of the first content; and an indication corresponding to a second portion of the first content, wherein the indication corresponding to the second portion of the first content is different from the representation of the first portion of the first content; detecting, via the one or more input devices, a set of one or more inputs, wherein a second input of the set of one or more inputs is detected while displaying the indication corresponding to the second portion of the first content; and in response to detecting the set of one or more inputs, displaying, via the display generation component, second content corresponding to the indication corresponding to the second portion of the first content, wherein the second content is different from the first content.

In some embodiments, a non-transitory computer-readable storage medium storing one or more programs configured to be executed by one or more processors of a computer system that is in communication with a display generation component and one or more input devices is described. In some embodiments, the one or more programs includes instructions for: while displaying, via the display generation component, first content, detecting, via the one or more input devices, a first input corresponding to a first portion of the first content; in response to detecting the first input corresponding to the first portion of the first content, displaying, via the display generation component: a representation of the first portion of the first content; and an indication corresponding to a second portion of the first content, wherein the indication corresponding to the second portion of the first content is different from the representation of the first portion of the first content; detecting, via the one or more input devices, a set of one or more inputs, wherein a second input of the set of one or more inputs is detected while displaying the indication corresponding to the second portion of the first content; and in response to detecting the set of one or more inputs, displaying, via the display generation component, second content corresponding to the indication corresponding to the second portion of the first content, wherein the second content is different from the first content.

In some embodiments, a transitory computer-readable storage medium storing one or more programs configured to be executed by one or more processors of a computer system that is in communication with a display generation component and one or more input devices is described. In some embodiments, the one or more programs includes instructions for: while displaying, via the display generation component, first content, detecting, via the one or more input devices, a first input corresponding to a first portion of the first content; in response to detecting the first input corresponding to the first portion of the first content, displaying, via the display generation component: a representation of the first portion of the first content; and an indication corresponding to a second portion of the first content, wherein the indication corresponding to the second portion of the first content is different from the representation of the first portion of the first content; detecting, via the one or more input devices, a set of one or more inputs, wherein a second input of the set of one or more inputs is detected while displaying the indication corresponding to the second portion of the first content; and in response to detecting the set of one or more inputs, displaying, via the display generation component, second content corresponding to the indication corresponding to the second portion of the first content, wherein the second content is different from the first content.

In some embodiments, a computer system configured to communicate with a display generation component and one or more input devices is described. In some embodiments, the computer system comprises one or more processors and memory storing one or more programs configured to be executed by the one or more processors. In some embodiments, the one or more programs includes instructions for: while displaying, via the display generation component, first content, detecting, via the one or more input devices, a first input corresponding to a first portion of the first content; in response to detecting the first input corresponding to the first portion of the first content, displaying, via the display generation component: a representation of the first portion of the first content; and an indication corresponding to a second portion of the first content, wherein the indication corresponding to the second portion of the first content is different from the representation of the first portion of the first content; detecting, via the one or more input devices, a set of one or more inputs, wherein a second input of the set of one or more inputs is detected while displaying the indication corresponding to the second portion of the first content; and in response to detecting the set of one or more inputs, displaying, via the display generation component, second content corresponding to the indication corresponding to the second portion of the first content, wherein the second content is different from the first content.

In some embodiments, a computer system configured to communicate with a display generation component and one or more input devices is described. In some embodiments, the computer system comprises means for performing each of the following steps: while displaying, via the display generation component, first content, detecting, via the one or more input devices, a first input corresponding to a first portion of the first content; in response to detecting the first input corresponding to the first portion of the first content, displaying, via the display generation component: a representation of the first portion of the first content; and an indication corresponding to a second portion of the first content, wherein the indication corresponding to the second portion of the first content is different from the representation of the first portion of the first content; detecting, via the one or more input devices, a set of one or more inputs, wherein a second input of the set of one or more inputs is detected while displaying the indication corresponding to the second portion of the first content; and in response to detecting the set of one or more inputs, displaying, via the display generation component, second content corresponding to the indication corresponding to the second portion of the first content, wherein the second content is different from the first content.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: while displaying, via the display generation component, first content, detecting, via the one or more input devices, a first input corresponding to a first portion of the first content; in response to detecting the first input corresponding to the first portion of the first content, displaying, via the display generation component: a representation of the first portion of the first content; and an indication corresponding to a second portion of the first content, wherein the indication corresponding to the second portion of the first content is different from the representation of the first portion of the first content; detecting, via the one or more input devices, a set of one or more inputs, wherein a second input of the set of one or more inputs is detected while displaying the indication corresponding to the second portion of the first content; and in response to detecting the set of one or more inputs, displaying, via the display generation component, second content corresponding to the indication corresponding to the second portion of the first content, wherein the second content is different from the first content.

In some embodiments, a method that is performed at a computer system that is in communication with a display generation component and one or more input devices is described. In some embodiments, the method comprises: while displaying, via the display generation component, a first indication corresponding to first content, detecting, via the one or more input devices, a first input corresponding to a request to generate content; in response to detecting the first input corresponding to the request to generate content, displaying, via the display generation component, second content corresponding to the first indication while maintaining display of the first indication corresponding to the first content, wherein the second content is different from the first content; while displaying the second content corresponding to the first indication and the first indication corresponding to the first content, detecting, via the one or more input devices, a second input; in response to detecting the second input, displaying, via the display generation component, third content corresponding to the first indication while maintaining display of the first indication corresponding to the first content without displaying the second content, wherein the third content is different from the first content and the second content; while displaying the third content and the first indication, detecting, via the one or more input devices, a third input; and in response to detecting the third input: maintaining display of, via the display generation component, the third content; and ceasing display of, via the display generation component, the first indication.

In some embodiments, a non-transitory computer-readable storage medium storing one or more programs configured to be executed by one or more processors of a computer system that is in communication with a display generation component and one or more input devices is described. In some embodiments, the one or more programs includes instructions for: while displaying, via the display generation component, a first indication corresponding to first content, detecting, via the one or more input devices, a first input corresponding to a request to generate content; in response to detecting the first input corresponding to the request to generate content, displaying, via the display generation component, second content corresponding to the first indication while maintaining display of the first indication corresponding to the first content, wherein the second content is different from the first content; while displaying the second content corresponding to the first indication and the first indication corresponding to the first content, detecting, via the one or more input devices, a second input; in response to detecting the second input, displaying, via the display generation component, third content corresponding to the first indication while maintaining display of the first indication corresponding to the first content without displaying the second content, wherein the third content is different from the first content and the second content; while displaying the third content and the first indication, detecting, via the one or more input devices, a third input; and in response to detecting the third input: maintaining display of, via the display generation component, the third content; and ceasing display of, via the display generation component, the first indication.

In some embodiments, a transitory computer-readable storage medium storing one or more programs configured to be executed by one or more processors of a computer system that is in communication with a display generation component and one or more input devices is described. In some embodiments, the one or more programs includes instructions for: while displaying, via the display generation component, a first indication corresponding to first content, detecting, via the one or more input devices, a first input corresponding to a request to generate content; in response to detecting the first input corresponding to the request to generate content, displaying, via the display generation component, second content corresponding to the first indication while maintaining display of the first indication corresponding to the first content, wherein the second content is different from the first content; while displaying the second content corresponding to the first indication and the first indication corresponding to the first content, detecting, via the one or more input devices, a second input; in response to detecting the second input, displaying, via the display generation component, third content corresponding to the first indication while maintaining display of the first indication corresponding to the first content without displaying the second content, wherein the third content is different from the first content and the second content; while displaying the third content and the first indication, detecting, via the one or more input devices, a third input; and in response to detecting the third input: maintaining display of, via the display generation component, the third content; and ceasing display of, via the display generation component, the first indication.

In some embodiments, a computer system configured to communicate with a display generation component and one or more input devices is described. In some embodiments, the computer system comprises one or more processors and memory storing one or more programs configured to be executed by the one or more processors. In some embodiments, the one or more programs includes instructions for: while displaying, via the display generation component, a first indication corresponding to first content, detecting, via the one or more input devices, a first input corresponding to a request to generate content; in response to detecting the first input corresponding to the request to generate content, displaying, via the display generation component, second content corresponding to the first indication while maintaining display of the first indication corresponding to the first content, wherein the second content is different from the first content; while displaying the second content corresponding to the first indication and the first indication corresponding to the first content, detecting, via the one or more input devices, a second input; in response to detecting the second input, displaying, via the display generation component, third content corresponding to the first indication while maintaining display of the first indication corresponding to the first content without displaying the second content, wherein the third content is different from the first content and the second content; while displaying the third content and the first indication, detecting, via the one or more input devices, a third input; and in response to detecting the third input: maintaining display of, via the display generation component, the third content; and ceasing display of, via the display generation component, the first indication.

In some embodiments, a computer system configured to communicate with a display generation component and one or more input devices is described. In some embodiments, the computer system comprises means for performing each of the following steps: while displaying, via the display generation component, a first indication corresponding to first content, detecting, via the one or more input devices, a first input corresponding to a request to generate content; in response to detecting the first input corresponding to the request to generate content, displaying, via the display generation component, second content corresponding to the first indication while maintaining display of the first indication corresponding to the first content, wherein the second content is different from the first content; while displaying the second content corresponding to the first indication and the first indication corresponding to the first content, detecting, via the one or more input devices, a second input; in response to detecting the second input, displaying, via the display generation component, third content corresponding to the first indication while maintaining display of the first indication corresponding to the first content without displaying the second content, wherein the third content is different from the first content and the second content; while displaying the third content and the first indication, detecting, via the one or more input devices, a third input; and in response to detecting the third input: maintaining display of, via the display generation component, the third content; and ceasing display of, via the display generation component, the first indication.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: while displaying, via the display generation component, a first indication corresponding to first content, detecting, via the one or more input devices, a first input corresponding to a request to generate content; in response to detecting the first input corresponding to the request to generate content, displaying, via the display generation component, second content corresponding to the first indication while maintaining display of the first indication corresponding to the first content, wherein the second content is different from the first content; while displaying the second content corresponding to the first indication and the first indication corresponding to the first content, detecting, via the one or more input devices, a second input; in response to detecting the second input, displaying, via the display generation component, third content corresponding to the first indication while maintaining display of the first indication corresponding to the first content without displaying the second content, wherein the third content is different from the first content and the second content; while displaying the third content and the first indication, detecting, via the one or more input devices, a third input; and in response to detecting the third input: maintaining display of, via the display generation component, the third content; and ceasing display of, via the display generation component, the first indication.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for manipulating content, thereby increasing the effectiveness, efficiency, and user satisfaction with such devices. Such methods and interfaces may complement or replace other methods for manipulating content.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6N illustrate exemplary user interfaces for generating and/or interacting with content in a space in accordance with some embodiments.

FIGS. 7A-7J illustrate exemplary user interfaces for generating and/or interacting with content based on displayed content in accordance with some embodiments.

FIGS. 8A-8F illustrate exemplary user interfaces for generating and/or interacting with content based on displayed text in accordance with some embodiments.

FIG. 9 is a flow diagram illustrating a method for generating and/or interacting with content in a space in accordance with some embodiments.

FIG. 10 is a flow diagram illustrating a method for generating and/or interacting with content based on displayed content in accordance with some embodiments.

FIG. 11 is a flow diagram illustrating a method for generating and/or interacting with content based on displayed text in accordance with some embodiments.

FIG. 12 is a flow diagram illustrating a method for generating content in a generative state in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for generating and manipulating content. For example, generated content can be based on words and phrases in other content, such as typed and/or handwritten content. The generated content can also be customized by adding and/or deleting words and phrases from the other content, changing a style of the generated content, and/or selecting suggested variations of the generated content. Such techniques can reduce the cognitive burden on a user who wants to add relevant content to a document, thereby enhancing productivity. Further, such techniques can reduce processor and battery power otherwise wasted on redundant user inputs.

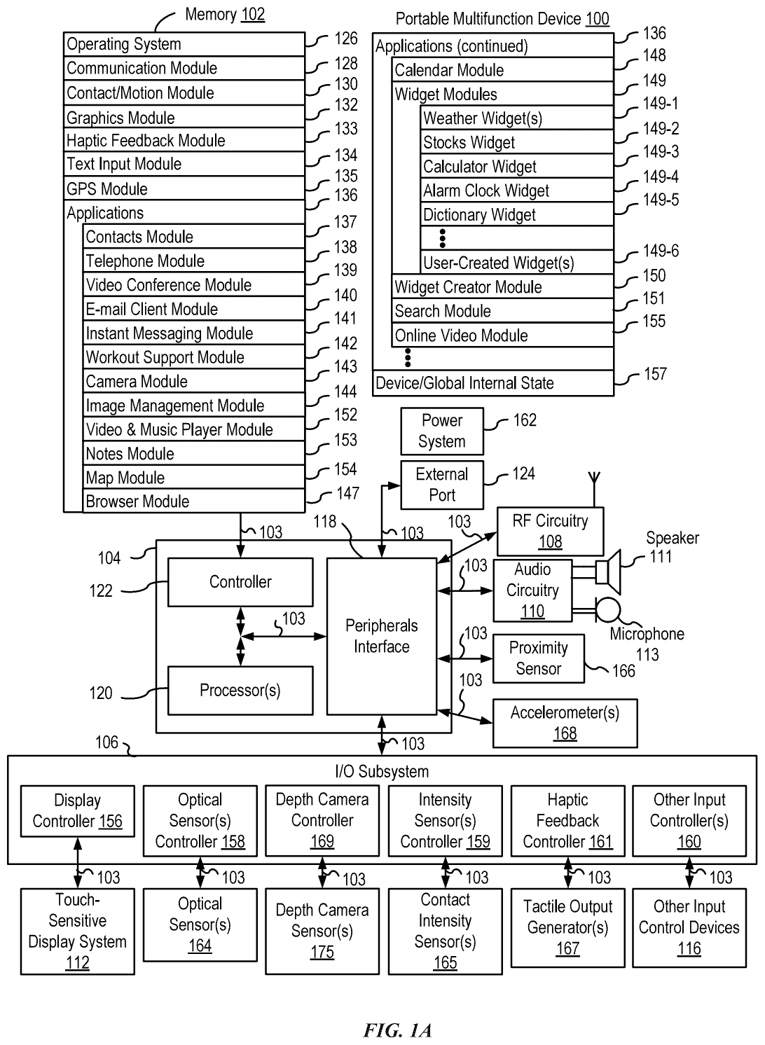

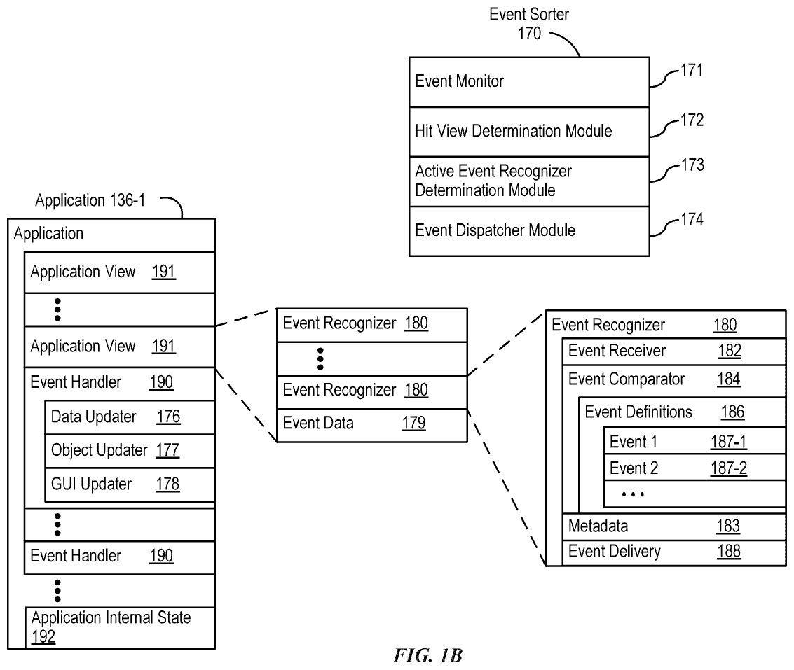

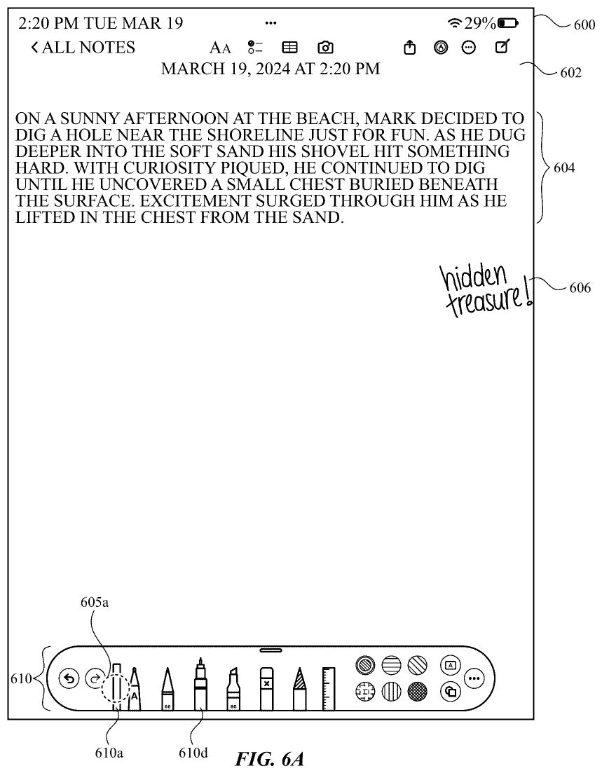

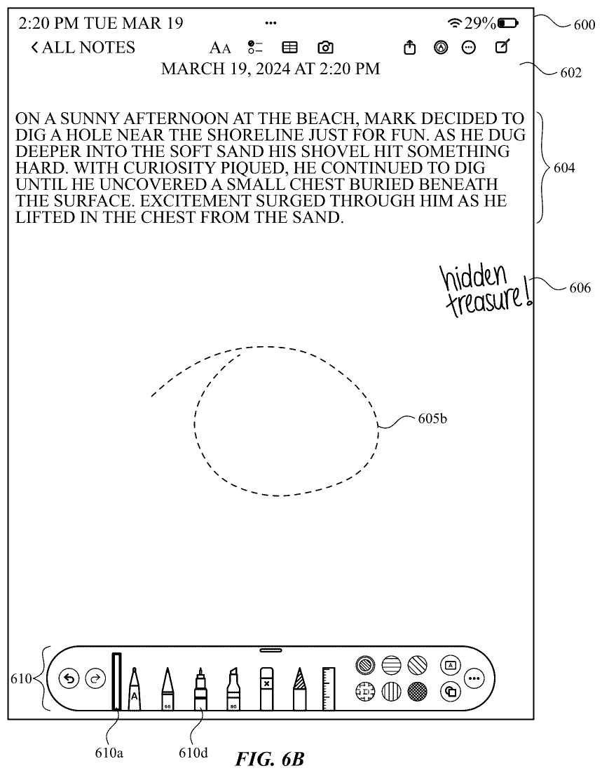

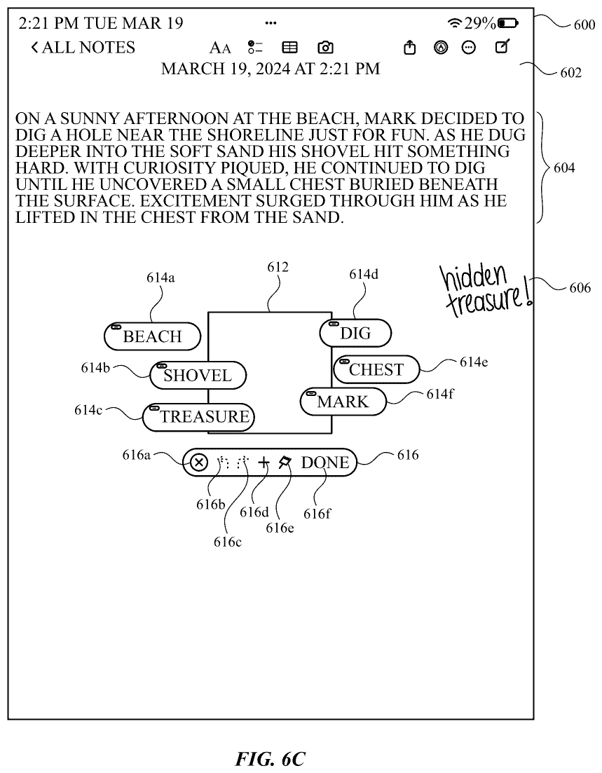

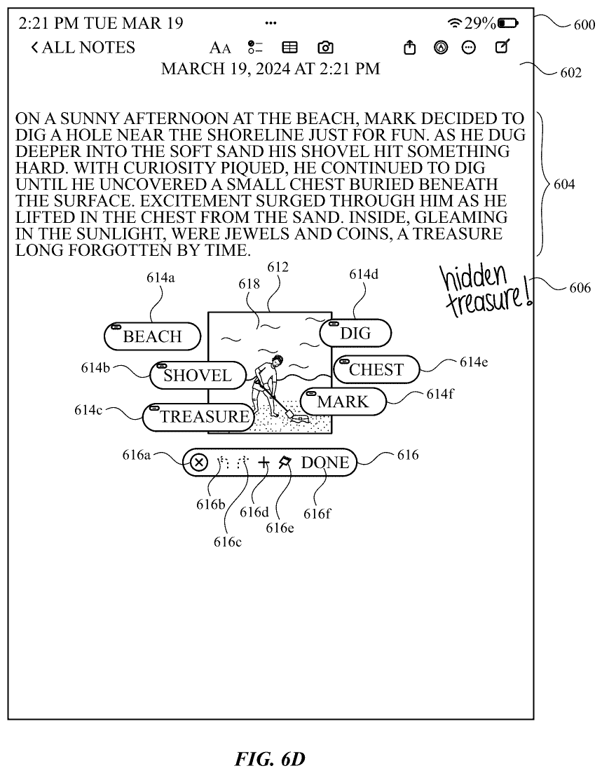

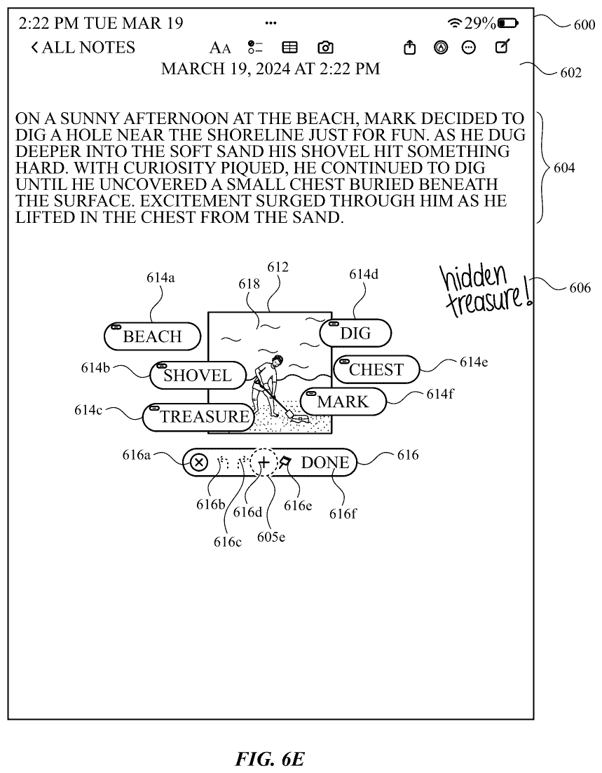

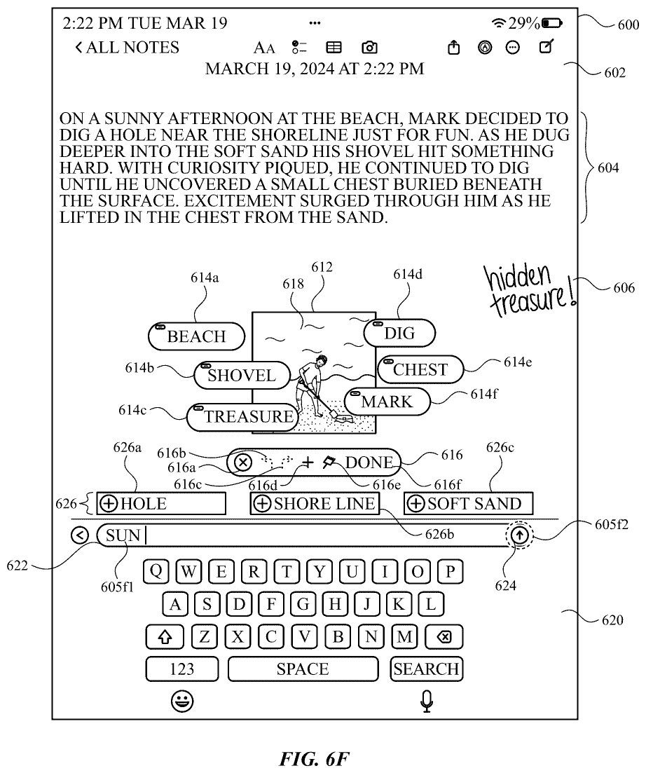

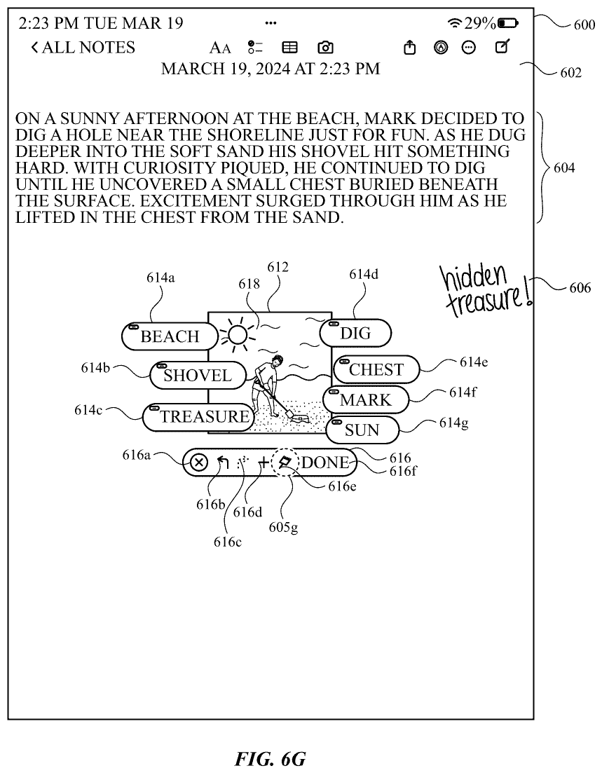

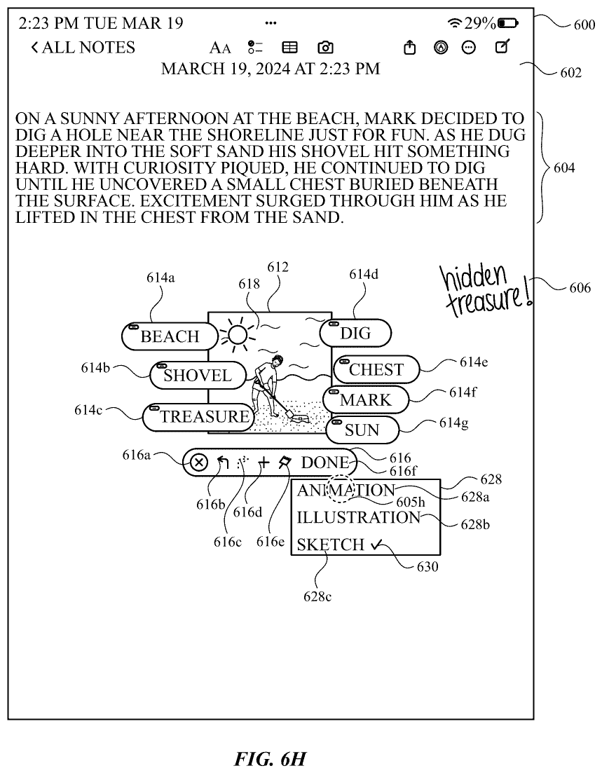

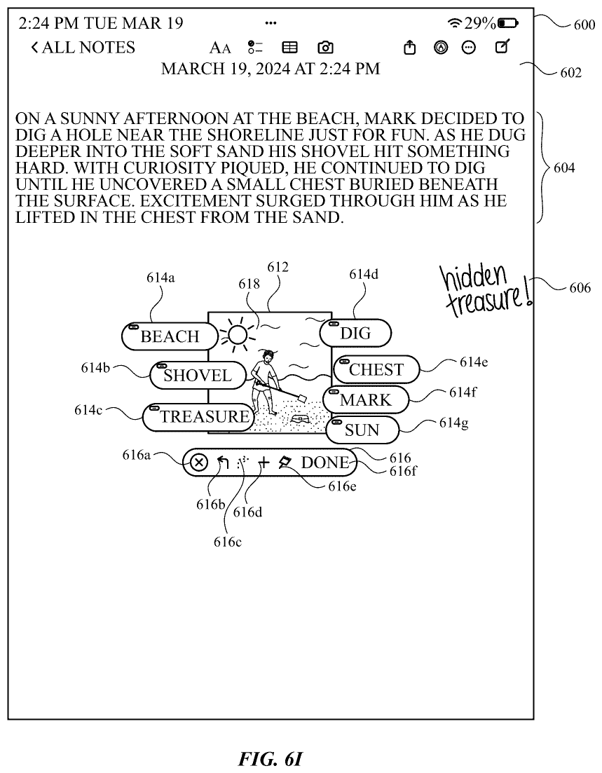

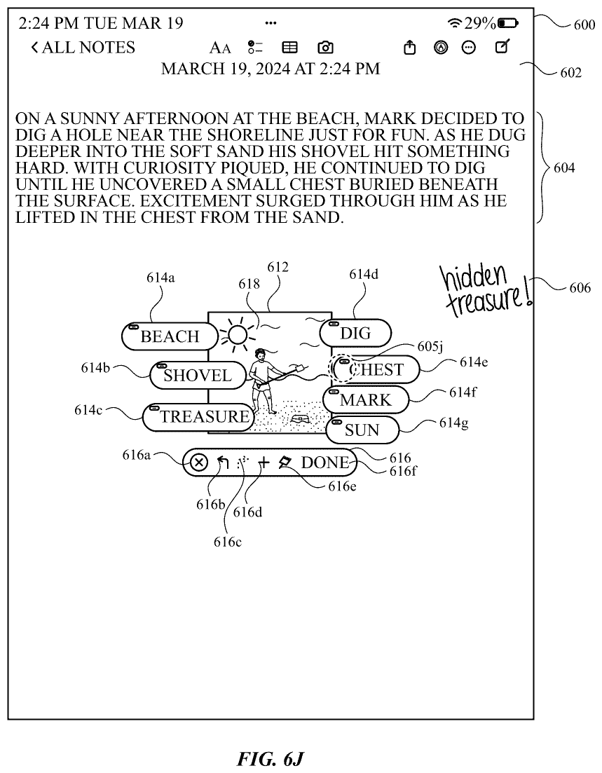

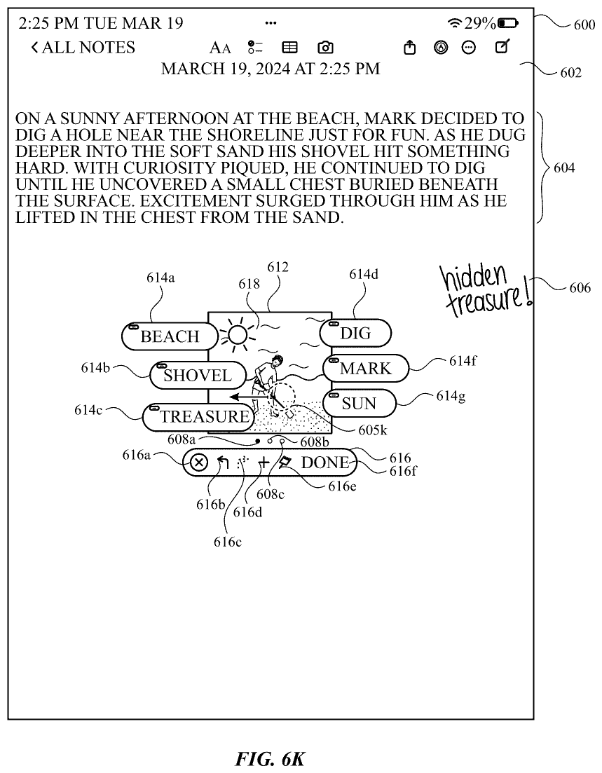

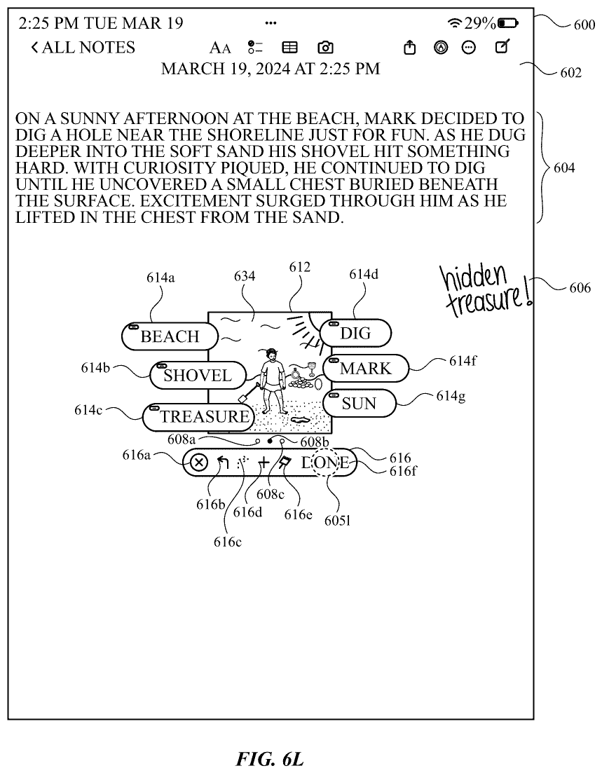

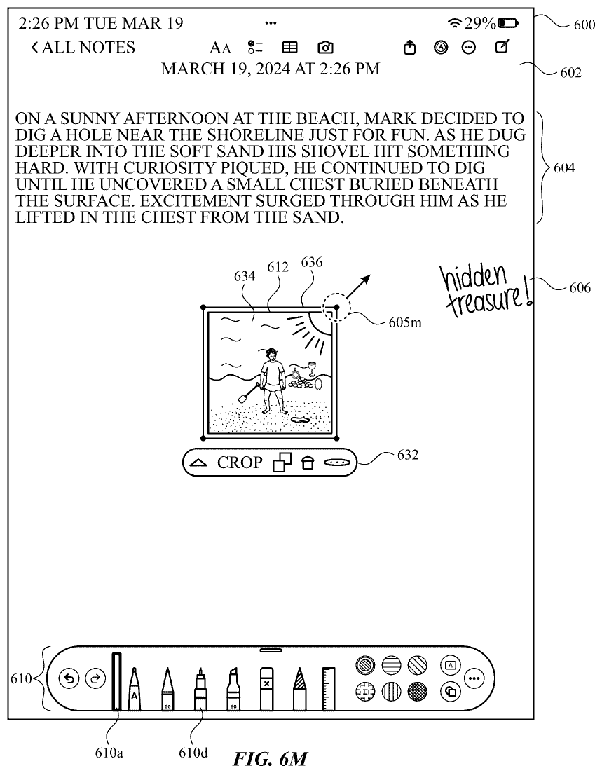

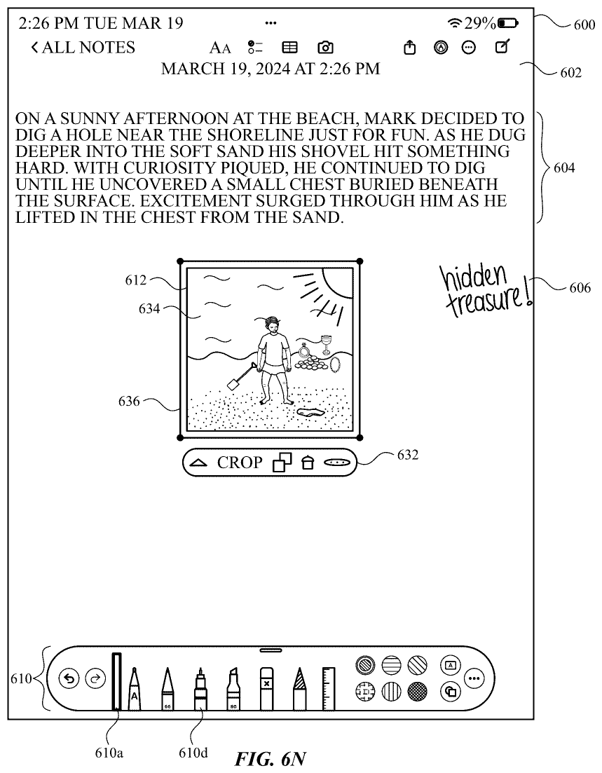

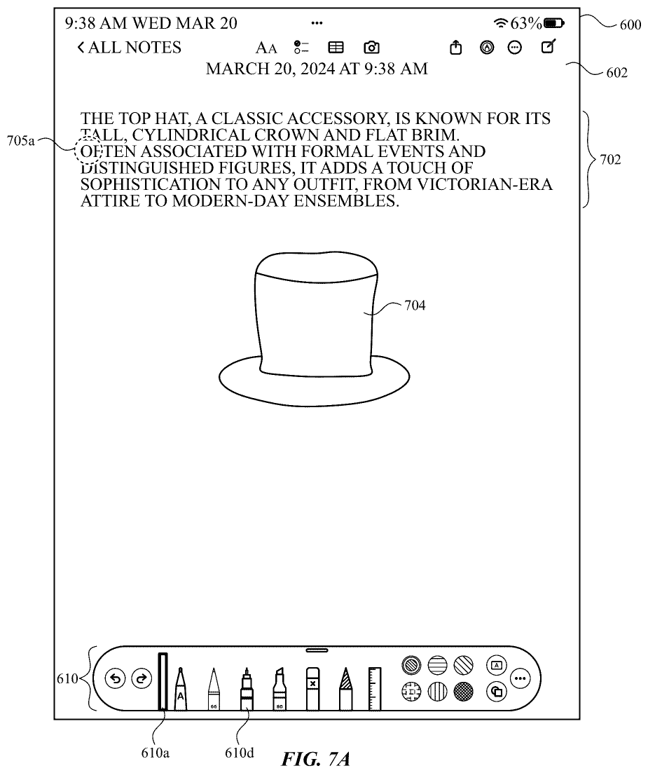

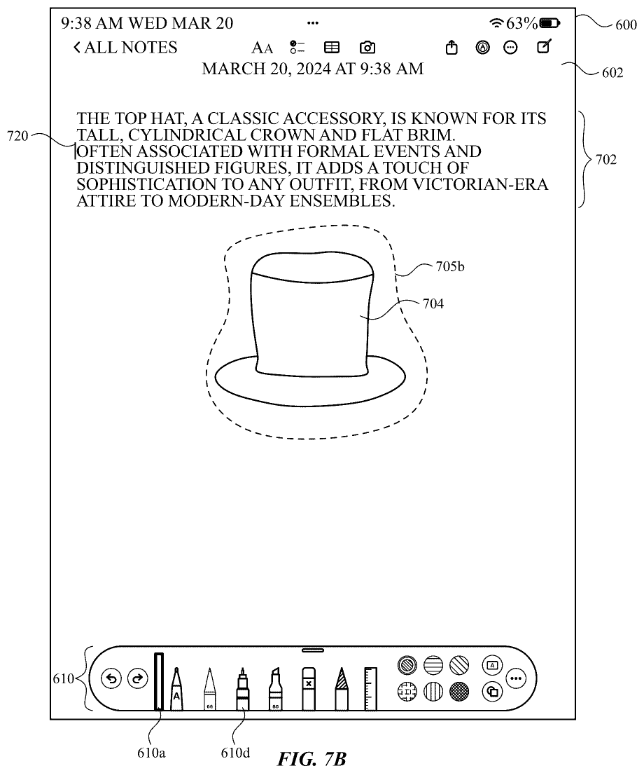

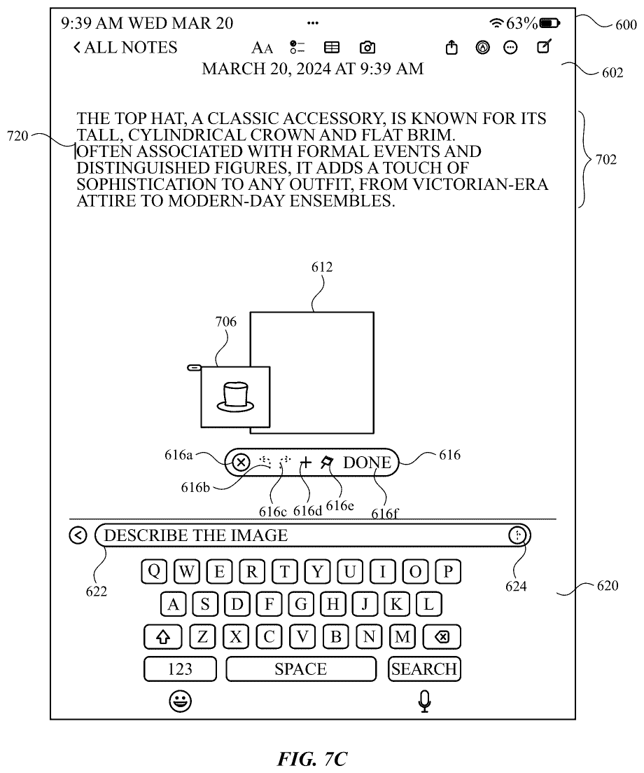

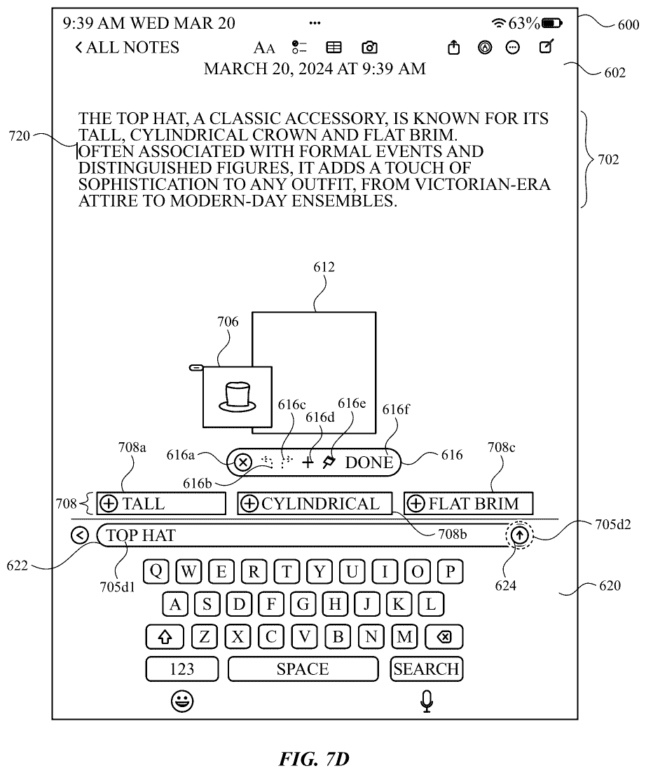

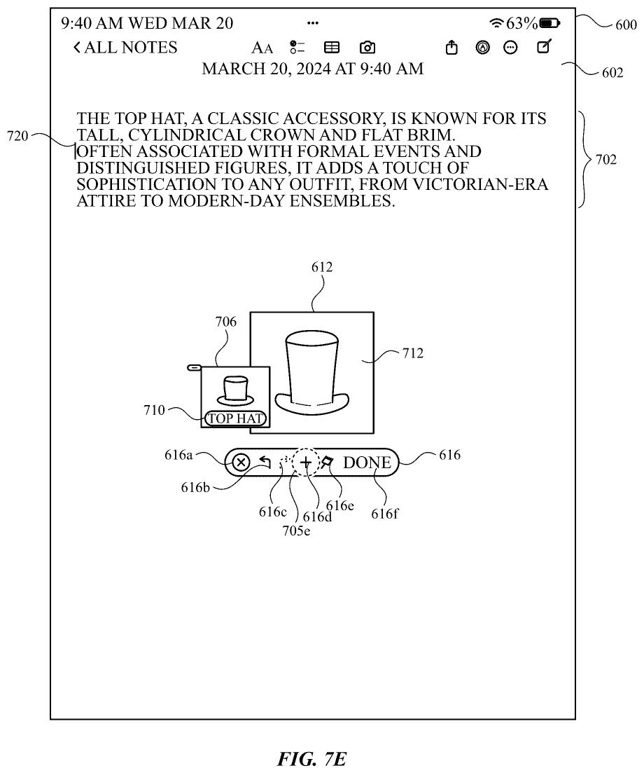

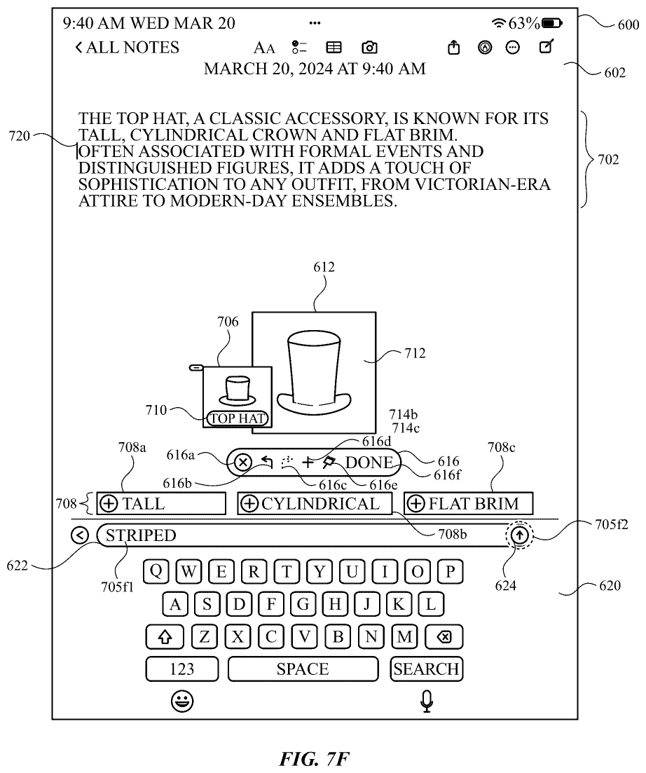

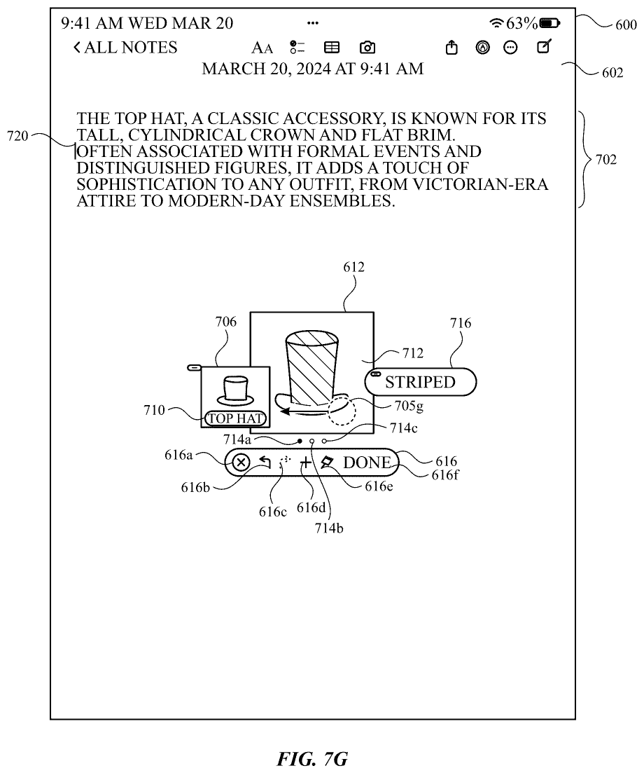

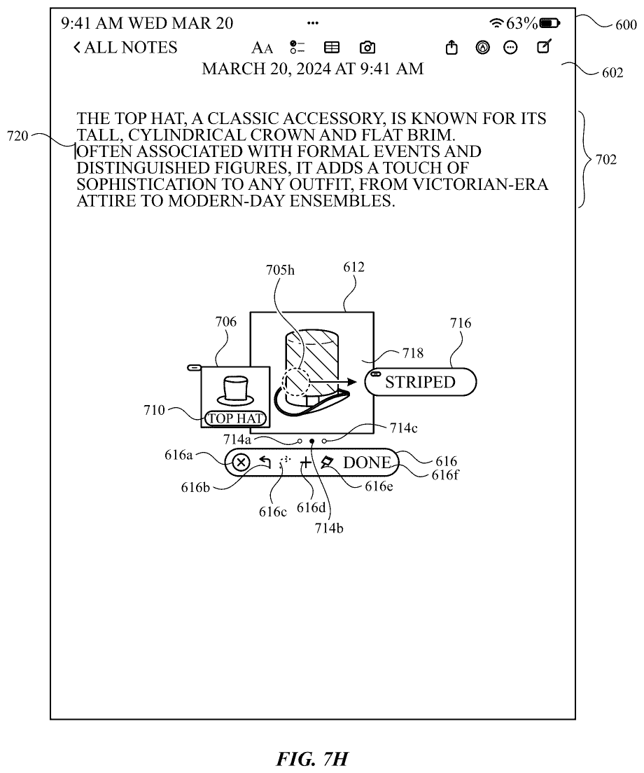

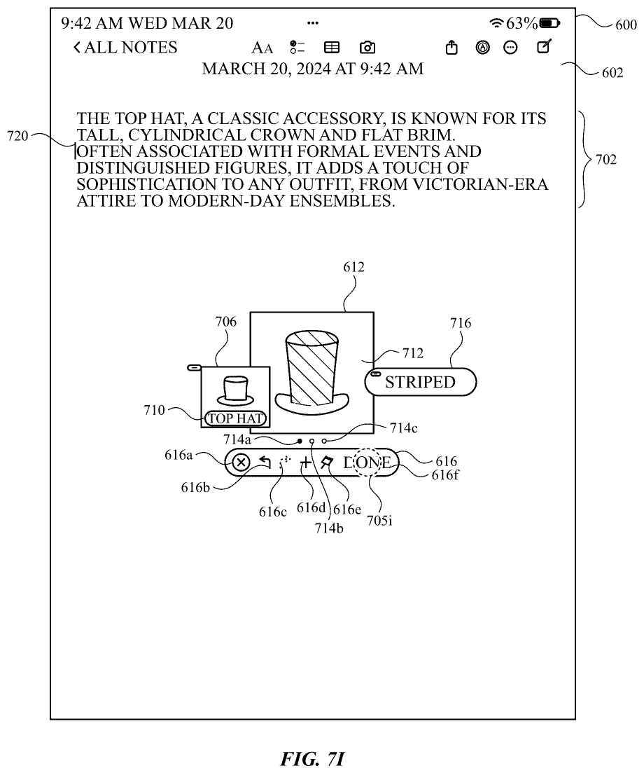

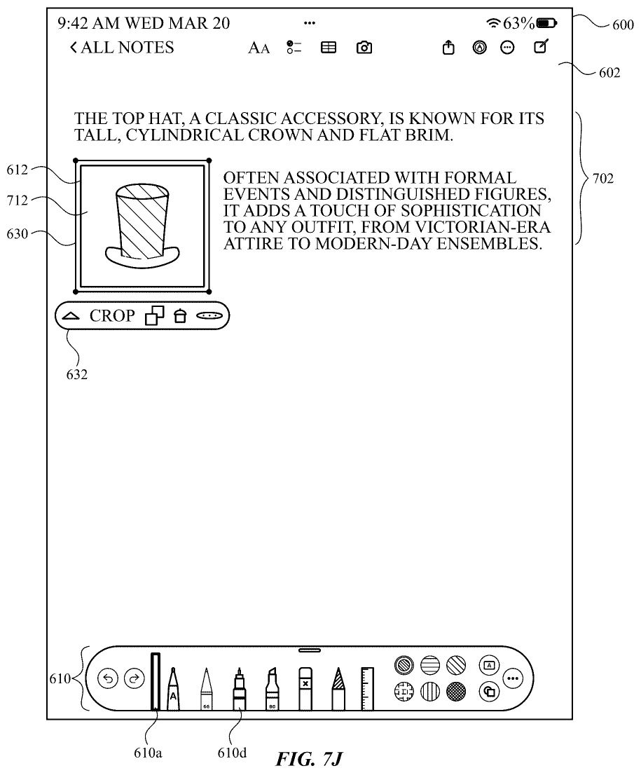

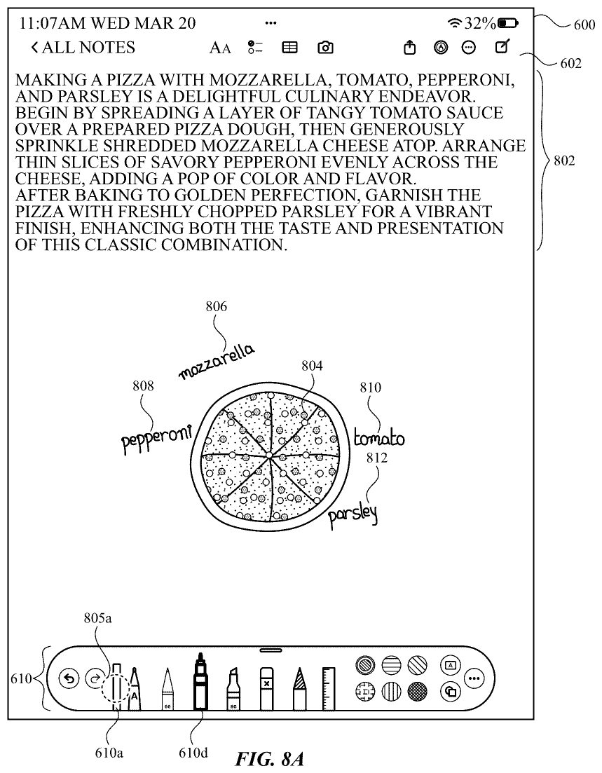

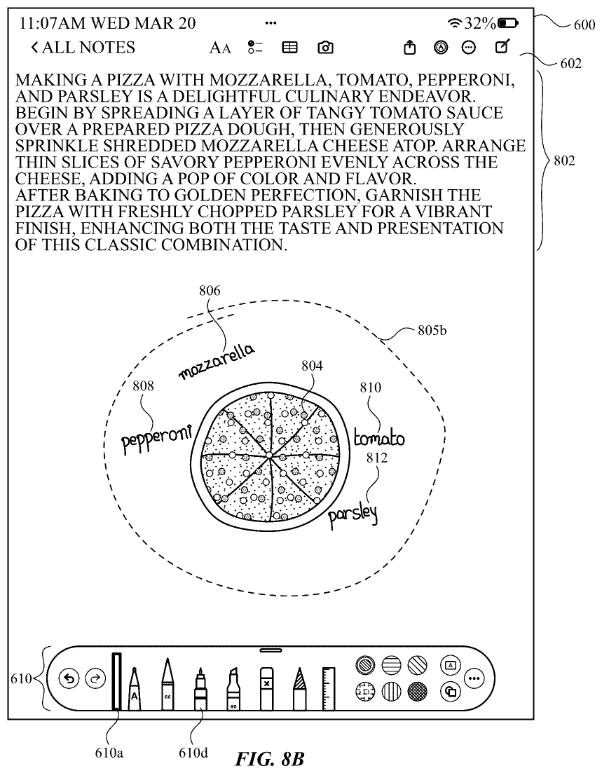

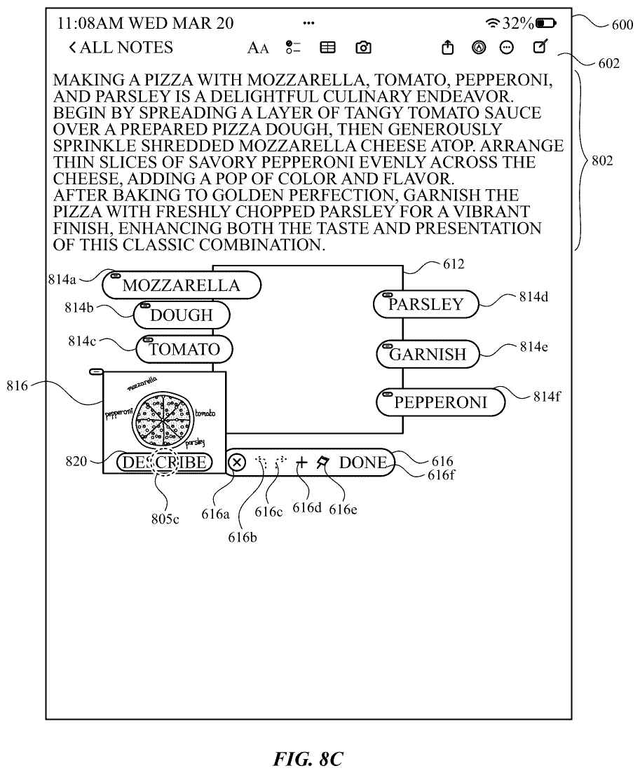

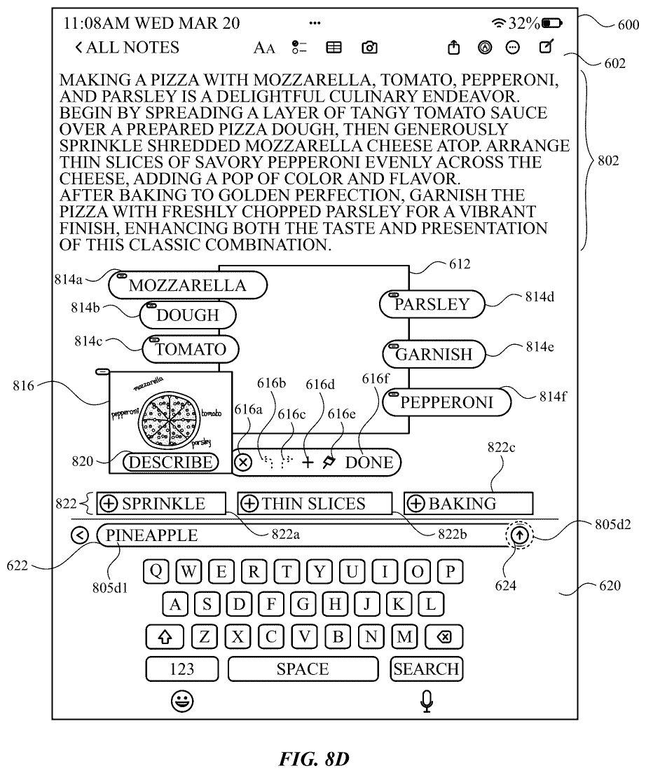

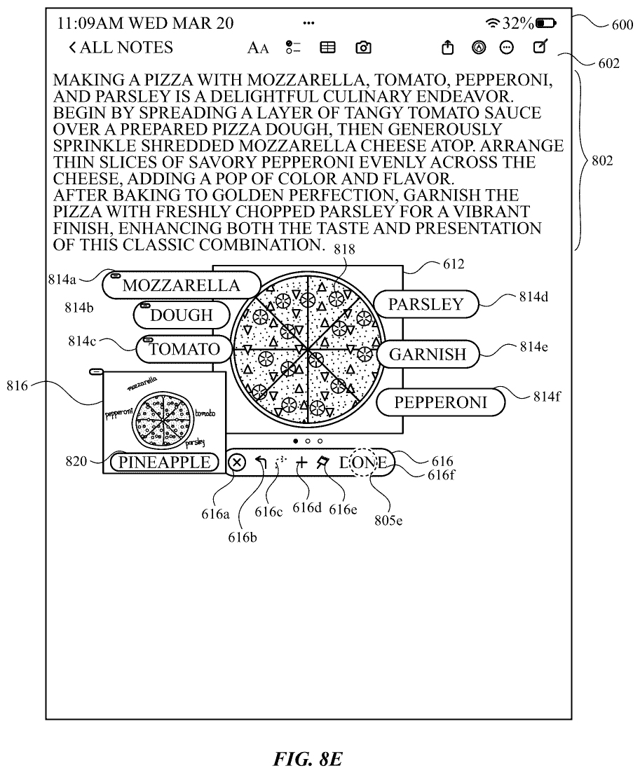

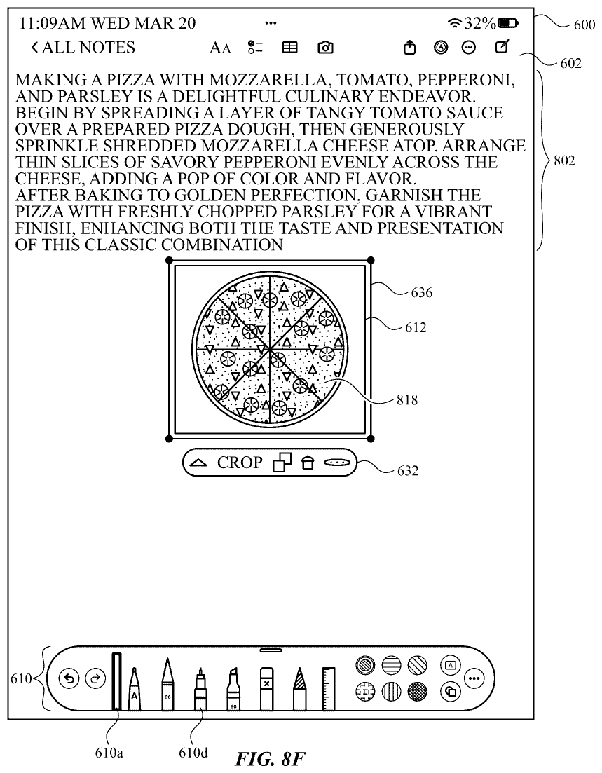

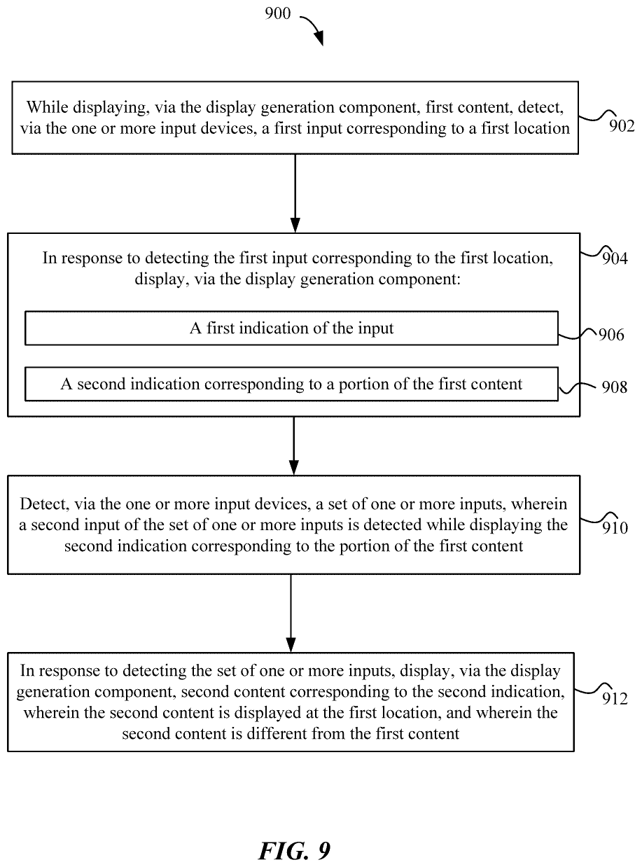

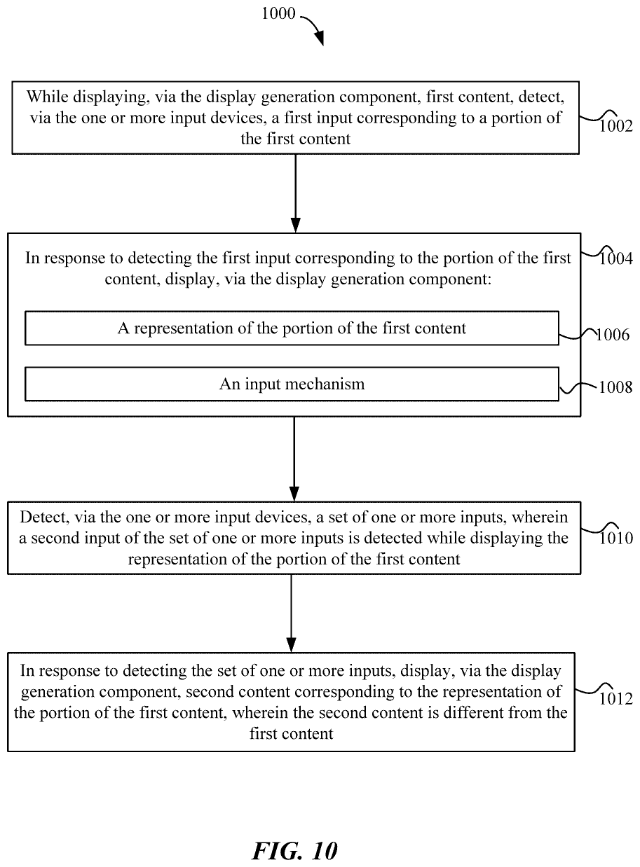

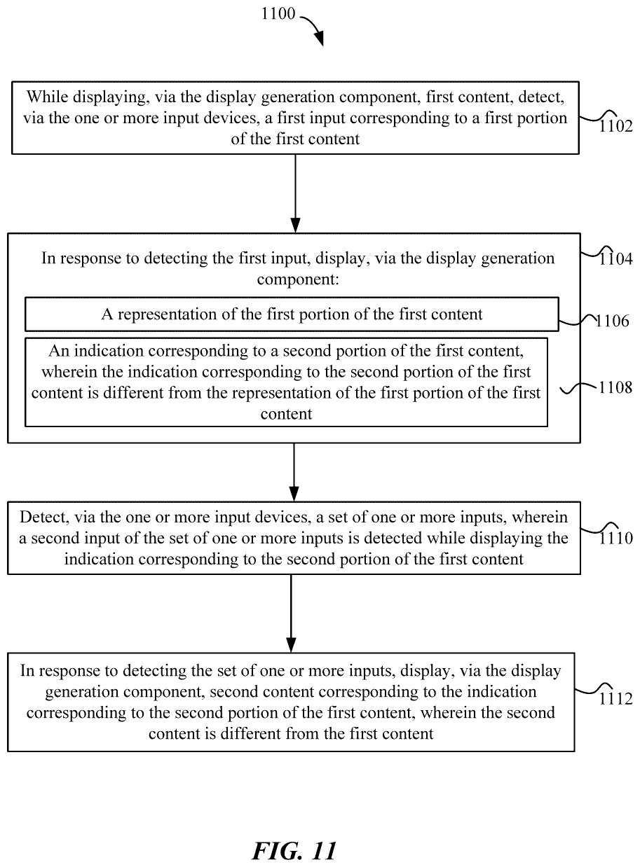

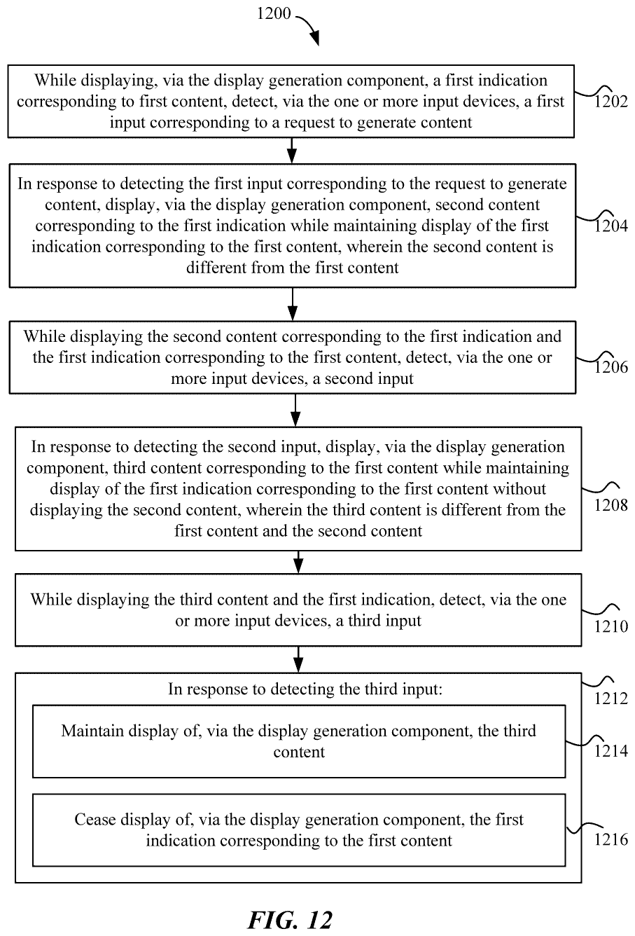

Below, FIGS. 1A-1B, 2, 3, 4A-4B, and 5A-5B provide a description of exemplary devices for performing the techniques for manipulating content. FIGS. 6A-6N illustrate exemplary user interfaces for generating and/or interacting with content in a space in accordance with some embodiments. FIGS. 7A-7J illustrate exemplary user interfaces for generating and/or interacting with content based on displayed content in accordance with some embodiments. FIGS. 8A-8F illustrate exemplary user interfaces for generating and/or interacting with content based on displayed text in accordance with some embodiments. FIG. 9 is a flow diagram illustrating a method for generating and/or interacting with content in a space in accordance with some embodiments. The user interfaces in FIGS. 6A-6N are used to illustrate the processes described below, including the processes in FIG. 9. FIG. 10 is a flow diagram illustrating a method for generating and/or interacting with content based on displayed content in accordance with some embodiments. The user interfaces in FIGS. 7A-7J are used to illustrate the processes described below, including the processes in FIG. 10. FIG. 11 is a flow diagram illustrating a method for generating and/or interacting with content based on displayed text in accordance with some embodiments. The user interfaces in FIGS. 8A-8F are used to illustrate the processes described below, including the processes in FIG. 11. FIG. 12 is a flow diagram illustrating a method for generating content in a generative state in accordance with some embodiments. The user interfaces in FIGS. 6A-6N, 7A-7J, and 8A-8F are used to illustrate the processes described below, including the processes in FIG. 12.

The processes described below enhance the operability of the devices and make the user-device interfaces more efficient (e.g., by helping the user to provide proper inputs relevant to an operation and/or minimizing the number of interactions with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

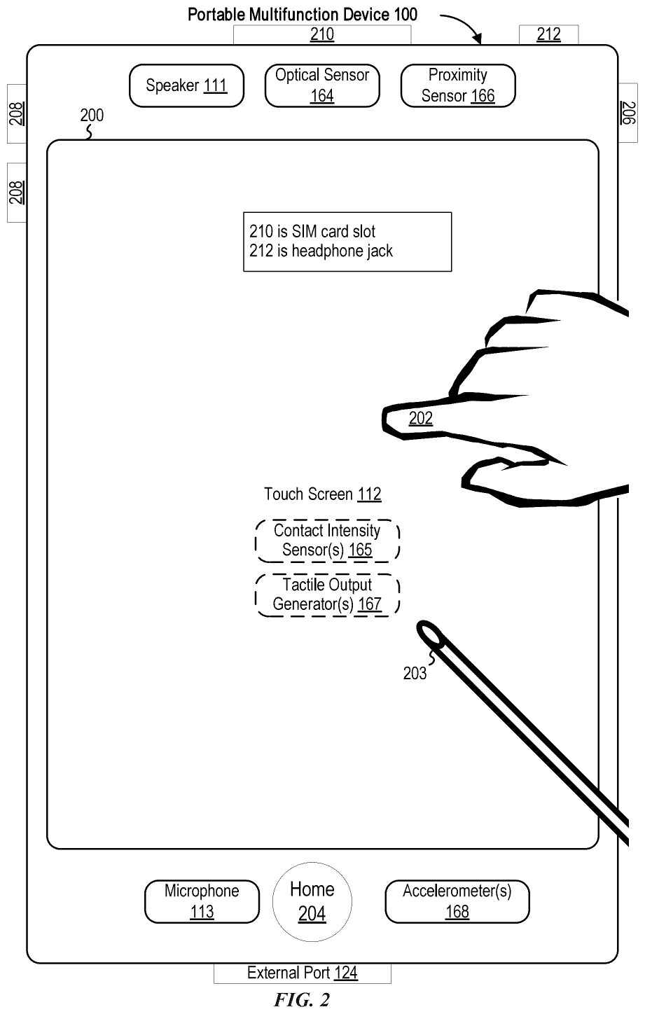

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

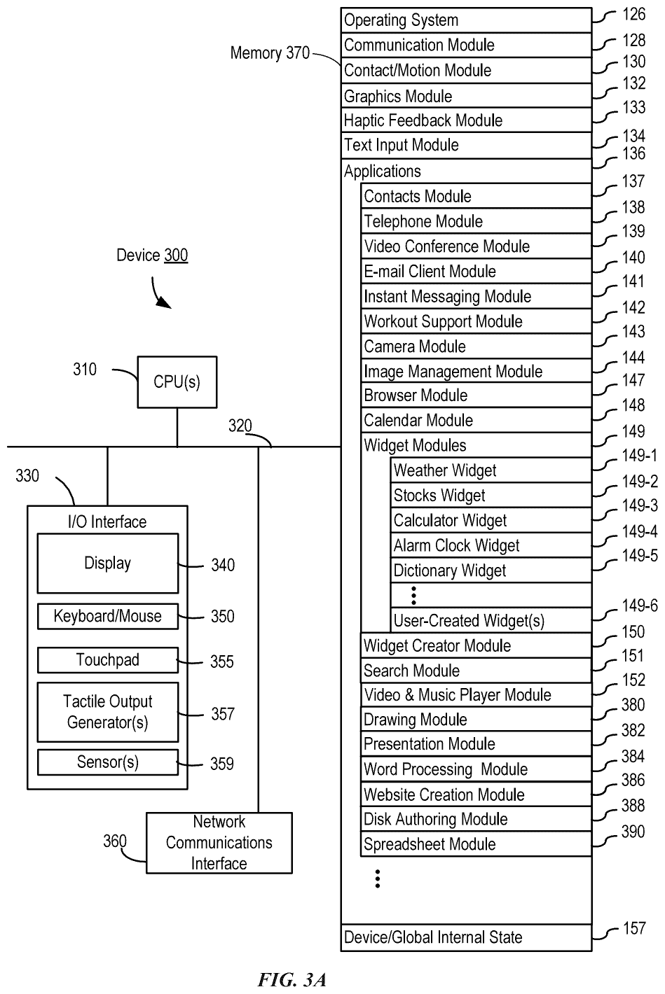

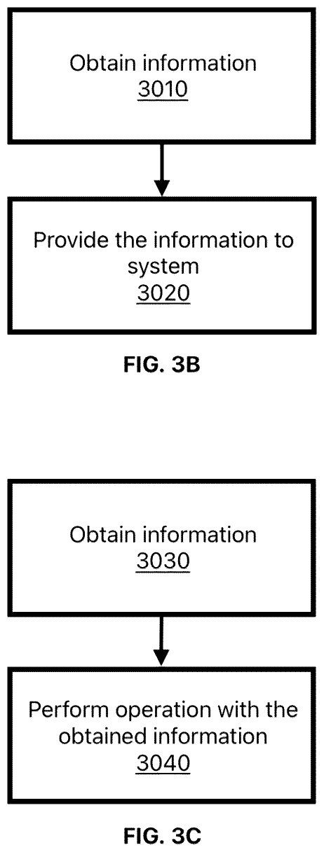

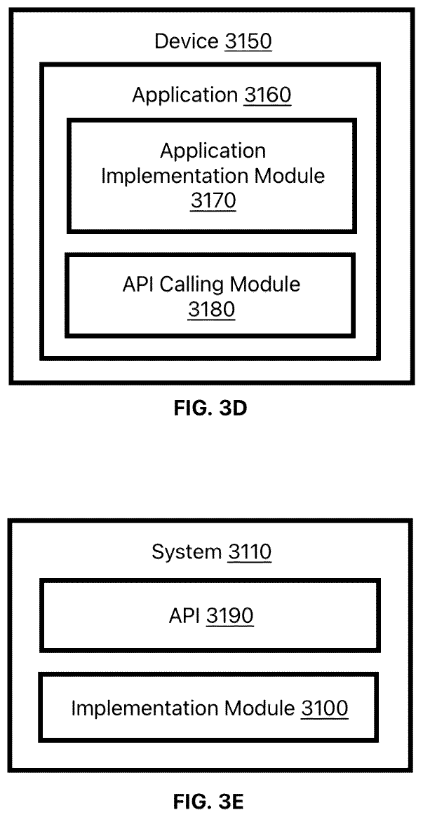

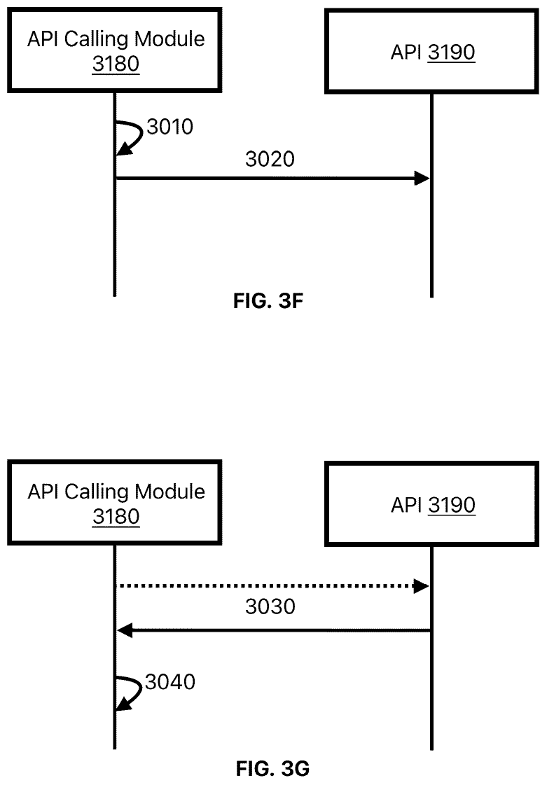

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 0.3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device.) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection (e.g., with an accessory), a device detection API (e.g., for locating nearby devices (e.g., media devices and/or smartphone)), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected, the direct sensor data is frequently processed into one or more input events that are provided (e.g., via an API) to a receiving software process that makes some determination based on the input events, and then sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by AP I-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

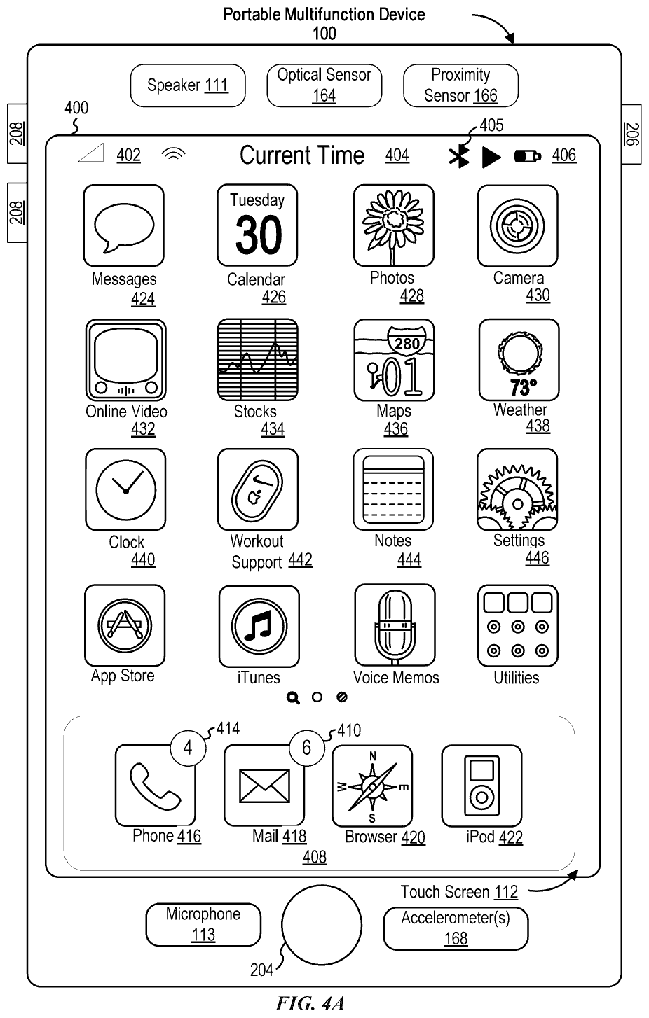

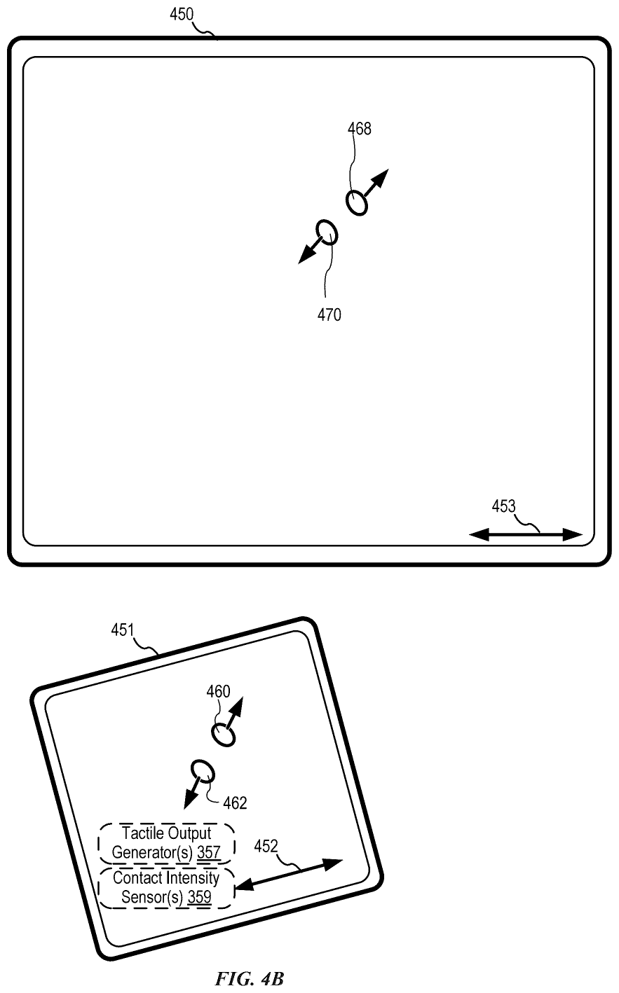

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

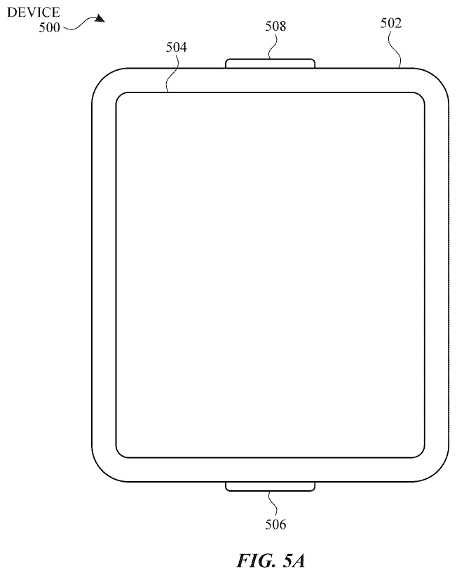

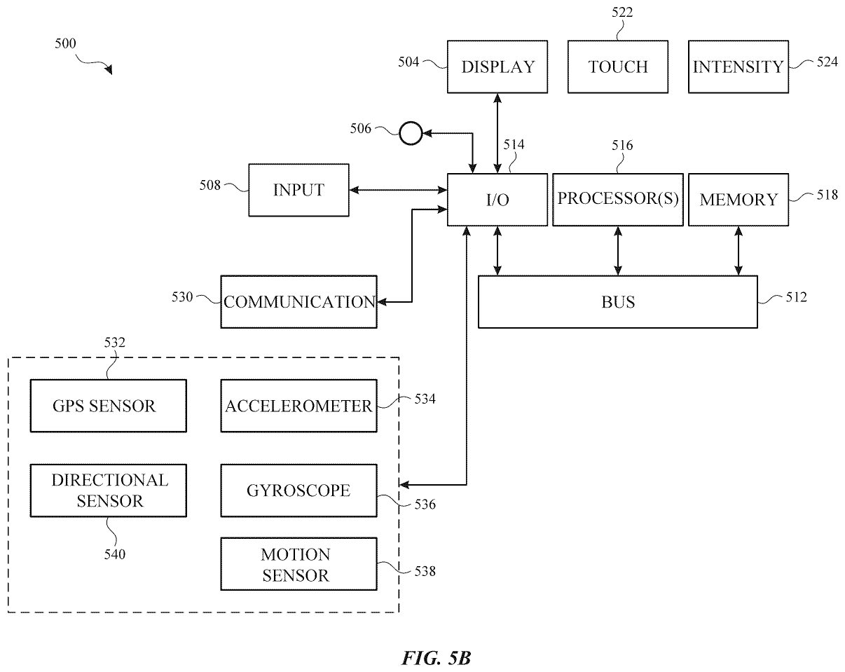

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 900, 1000, 1100, and 1200 (FIGS. 9, 10, 11, and 12). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

FIGS. 6A-6N illustrate exemplary user interfaces for generating and/or interacting with content in a space (e.g., an empty space in a document) in accordance with some embodiments. The user interfaces in these figures are used to illustrate the processes described below, including the processes in FIG. 9 and FIG. 12.

FIGS. 6A-6F illustrate computer system 600 as a personal device of a user such as a tablet. It should be recognized that computer system 600 can be other types of computer systems, such as a smart phone, a smart watch, a laptop, a movable device, a rotatable device, a smart display device, a communal device, a smart speaker, an accessory, a personal gaming system, a desktop computer, a fitness tracking device, a media device, a television, and/or a head-mounted display (HMD) device. In some embodiments, computer system 600 includes and/or is in communication with one or more input devices (e.g., a camera, a depth sensor, a microphone, an electronic stylus, an electronic pencil, a hardware input mechanism, a rotatable input mechanism, a heart monitor, a temperature sensor, and/or a touch-sensitive surface). In some embodiments, computer system 600 includes and/or is in communication with one or more output devices (e.g., display screen, projector, touch-sensitive display, haptic output device, and/or speaker). In some embodiments, computer system 600 includes one or more components and/or features described above in relation to portable multifunction device 100, device 300, or device 500.

FIG. 6A illustrates computer system 600 displaying user interface 602. User interface 602 is an interface of an application (e.g., a note-taking application). As illustrated in FIG. 6A, user interface 602 includes tools 610, typed text content 604, and handwritten content 606.

Computer system 600 displays tools 610 in a bottom area of user interface 602. Tools 610 includes a set of tools with which a user can draw, write, erase, color, and/or otherwise interact with user interface 602 via the one or more input devices. Examples of different tools in tools 610 include a highlighter, a pen, a pencil, an eraser, and a variety of colors. As illustrated in FIG. 6A, computer system 600 displays pencil tool 610d as emphasized, indicating that pencil tool 610d is the currently selected tool. In some embodiments, pencil tool 610d being active causes lines to be displayed within user interface 602 in response to computer system 600 detecting one or more inputs via the one or more input devices. For example, a touch-and-drag input on user interface 602 while pencil tool 610d is active can cause a line to be displayed starting at where the touch-and-drag input started and finishing at where the touch-and-drag input finished.

Computer system 600 displays typed text content 604 in an editable area of user interface 602. Typed text content 604 is a typed paragraph of a story about a boy digging in the sand and finding a buried chest. In some embodiments, typed text content 604 is inputted by a user via computer system 600 detecting a set of one or more inputs via the one or more input devices. In other embodiments, typed text content 604 is (1) received by computer system 600 from another computer system and/or (2) automatically generated content 605.

Computer system 600 displays handwritten content 606 below and to the right of typed text content 604. Handwritten content 606 is a phrase (e.g., “hidden treasure!”) written in user interface 602. In some embodiments, handwritten content 606 is written by a user on user interface 602 via computer system 600 detecting a set of one or more inputs via the one or more input devices while a tool (e.g., pencil tool 610d) from tools 610 is active. In other embodiments, handwritten content 606 is (1) received by computer system 600 from another computer system and/or (2) automatically generated. It should be noted that typed text content 604 and handwritten content 606 are examples of what content can be included in user interface 602 and where content can be located; however, computer system 600 can display different types of content and/or content at different location within user interface 602.

At FIG. 6A, computer system 600 detects tap input 605a on magic wand tool 610a. It should be recognized that tap input 605a can be other types of inputs, such as a voice input requesting that magic wand tool 610a be activated.

As illustrated in FIG. 6B, in response to detecting tap input 605a, computer system 600 displays magic wand tool 610a as emphasized and pencil tool 610d as deemphasized, indicating that computer system 600 disabled pencil tool 610d and enabled magic wand tool 610a. In some embodiments, magic wand tool 610a represents a content generation tool that is used to generate content.

At FIG. 6B, computer system 600 detects input 605b directed to a selected location of user interface 602. This selected location is the location where a generated image should be displayed. In this example, the selected location is an empty space between typed text content 604 and tools 610. However, this selected location can be anywhere in the editable portion of the user interface 602 and is bounded by input 605b. As illustrated in FIG. 6B, input 605b is a hand-drawn circular bounded shape.

As illustrated in FIG. 6C, when magic wand tool 610a is enabled and in response to detecting input 605b, computer system 600 enters a generative state. In some embodiments, the generative state indicates (e.g., visually and/or audibly) that a process of generating content (e.g., media, an image, a video, and/or text) has been initiated. In this example, computer system 600 will generate an image based on one or more words extracted from content currently in the editable portion of user interface 602 (e.g., typed text content 604 and/or handwritten content 606). In some embodiments, computer system 600 enters the generative state when (1) the magic wand tool 610a is enabled and (2) a bounded location of the editable portion of the user interface 602 is selected (e.g., highlighted, outlined, and/or surrounded by a closed object or a bounded shape). In such embodiments, computer system 600 does not enter the generative state if a tool other than magic wand tool 610a is enabled when detecting input 605b. In addition, computer system 600 does not enter the generative state if input 605b is not bounded.

As illustrated in FIG. 6C, in response to entering the generative state and/or detecting input 605b, computer system 600 (1) ceases display of tools 610 and (2) displays bounded area 612. In some embodiments, bounded area 612 is an indication of the selected location of input 605b. For example, computer system 600 can convert the selected location of input 605b to bounded area 612 and display bounded area 612 at the same location that computer system 600 detected input 605b (e.g., the empty space between typed text content 604 and tools 610). As illustrated in FIG. 6C, bounded area 612 is the same size as input 605b. That is, computer system 600 displays bounded area 612 at a size based on and/or corresponding to the size of input 605b received when selecting location for the generated image. In some embodiments, computer system 600 uses bounded area 612 as a canvas to generate content corresponding to typed text content 604, handwritten content 606, and/or other content added to the edible portion of user interface 602 while the application is in the generative state. In some embodiments, computer system 600 displays bounded area 612 as a bounded shape other than a square (e.g., circle, rectangle, abstract shape, and/or a shape of input 605b).

As also illustrated in FIG. 6C, computer system 600 displays text bubbles 614a-f near and/or on top of the borders of bounded area 612. Text bubbles 614a-f include words from and/or based on content in the editable region of user interface 602 (e.g., typed text content 604 and handwritten content 606). For example, text bubble 614a (“beach”), text bubble 614b (“shovel”), text bubble 614d (“dig”), text bubble 614e (“chest”), and text bubble 614f (“Mark”) are from typed content 604 and text bubble 614c (“treasure”) is from handwritten content 606. It should be recognized that more words, fewer words, and/or different words can be extracted from content in the editable region of user interface 602, including words that are not literally included in the content (e.g., typed text content 604 and/or handwritten content 606), but are inferred from the context. Computer system 600 displays text bubbles 614a-f as encircled words with a deletion control, illustrated in FIG. 6C as a minus sign within text bubbles 614a-f. In some embodiments, computer system 600 displays the deletion control as a symbol other than a minus sign (e.g., an “x” symbol). In some embodiments, text bubbles include emojis, pictures, drawings, and/or content other than text. As illustrated in FIG. 6C, computer system 600 displays text bubbles 614 with varying amounts of overlap onto bounded area 612. For example, computer system 600 displays text bubble 614a as completely outside of bounded area 612 while displaying text bubble 614b as partially overlapping bounded area 612. It should be recognized that, in some embodiments, text bubbles can overlap more, less, or differently than illustrated in FIG. 6C.

Below bounded area 612, computer system 600 displays controls 616. Controls 616 includes exit control 616a, undo control 616b, redo control 616c, add control 616d, style control 616e, and done control 616f. These controls are for controlling actions while the application is in the generative state. Although the controls are shown below the bounded area 612, they may be displayed anywhere in user interface 602. In some embodiments, in response to detecting an input corresponding to exit control 616a, computer system 600 exits the generative state without adding content to user interface 602. In such embodiments, exiting the generative state can cause bounded area 612, text bubbles 614a-f, and/or controls 616 to no longer be displayed while tools 610 are again displayed. In some embodiments, in response to detecting an input corresponding to undo control 616b or redo control 616c, computer system 600 undoes or redoes, respectively, one or more actions, such as adding or deleting a text bubble, generating content, and/or changing a style of the content. As illustrated in FIG. 6C, undo control 616b and redo control 616c are illustrated as dotted because they are not yet able to be used (e.g., no action has been performed that can be undone or redone since entering the generative state). In some embodiments, in response to detecting an input corresponding to add control 616d, computer system 600 adds a text bubble to the generative state as further discussed below with respect to FIGS. 6E-6G. In some embodiments, in response to detecting an input corresponding to style control 616e, computer system enters a process to change a style (e.g., animation, sketch, and/or illustration) of the content as further discussed below with respect to FIGS. 6G-6I. In some embodiments, in response to detecting an input corresponding to done control 616f, computer system 600 exits the generative state and adds content to user interface 602 as further discussed below with respect to FIGS. 6L-6M.

As illustrated in FIG. 6D, after some time has passed since the application has entered the generative state, computer system 600 displays content 618 within bounded area 612. Content 618 is a computer-generated image that is generated based on text bubbles 614a-fI. In this example, content 618 is an image of a boy (e.g., incorporating text “Mark” from text bubble 614f) on a beach (incorporating “beach” from text bubble 614a) digging up a treasure chest (e.g., incorporating “dig,” “treasure,” and “chest” from text bubbles 614c-e) with a shovel (e.g., incorporating “shovel” from text bubble 614b). In some embodiments, computer system 600 transitions from bounded area 612 being blank or empty as illustrated in FIG. 6C to including a generated image as illustrated in FIG. 6D after a period of time (e.g., 5 seconds) has passed since the application of computer system 600 entered the generative state. In other embodiments, user interface 602 transitions from bounded area 612 being blank or empty as illustrated in FIG. 6C to bounded area 612 including a generated image as illustrated in FIG. 6D after content 618 is generated. In some embodiments, content 618 is generated (e.g., by computer system 600 and/or another computer system in communication with computer system 600) after detecting a state of inactivity from the user for at least a predefined period of time (e.g., 10-30 seconds). In some embodiments, content 618 is generated after a determination that no more text bubbles can be added (e.g., a maximum number of text bubbles has been reached). In some embodiments, content 618 is generated after detecting an input from a user indicating that the user is ready for the image to be generated, e.g., a tap input on bounded area 612.

At FIG. 6E, computer system 600 detects tap input 605e on add control 616d. It should be recognized that tap input 605a can be other types of inputs, such as a voice input requesting that a text bubble be added.

As illustrated in FIG. 6F, in response to detecting tap input 605e on add control 616d, computer system 600 displays keyboard 620 concurrently with user interface 602. Keyboard 620 includes type bar 622 where a user can type words to add to text bubbles 614a-f to provide additional context for a generated image (e.g., content 618). Keyboard 620 also includes send control 624, which allows a user to submit the typed word(s) to re-generate content based on existing text bubbles and the typed word(s). FIG. 6F also illustrates computer system 600 displaying suggested words and/or phrases 626 above keyboard 620. In some embodiments, one or more of the words that computer system 600 provides as suggestions are sourced from content in the editable region of user interface 602, e.g., typed text content 604 and/or handwritten content 606. For example, computer system 600 can extract the words “hole,” “shoreline,” and “soft sand” directly from typed text content 604 and display them as suggestions 626a-c. In such embodiments, computer system 600 can provide words from typed text content 604 and/or handwritten content 606 in order to provide suggestions to the user that are relevant to content 618. In some embodiments, one or more words are not sourced from content within user interface 602 (e.g., handwritten content 606 and/or typed text content 604) and are instead based on previously used words, preferred words, and/or words related to content 618. As illustrated in FIG. 6F, computer system 600 displays a plus sign control next to each of suggestions 626a-c to provide the user with the ability to add each suggestion upon input of the plus sign control. It should be recognized that a keyboard is one example of a type of input mechanism that can be used with techniques described herein and that other input mechanisms can also be used, such as voice, navigation to a photo or a webpage, and/or a camera.

At FIG. 6F, computer system 600 detects input 605f1, the user typing the word “sun” in type bar 622. It should be recognized that input 605f1 can be a non-tap input such as a verbal input. After detecting input 605f1, computer system 600 detects tap input 605f2 on send control 624.

As illustrated in FIG. 6G, in response to detecting input 605f1 and input 605f2, computer system 600 displays text bubble 614g (which includes the word “sun”) below text bubble 614f (which contains the word “Mark”). At FIG. 6G, computer system 600 rearranges the order of text bubbles 614a-f to create space for text bubble 614g. Computer system 600 arranges text bubbles 614a-f so that they are in line with one another along the borders of bounded area 612. That is, in FIG. 6G, computer system 600 displays each of text bubbles 614a-g overlapping onto content 618. In some embodiments, text bubble 614a-g overlap content 618 with varying amounts of overlap. However, in other embodiments, text bubbles 614a-g overlap content 618 with similar overlap to create symmetry around bounded area 612 and/or content 618. In some embodiments, computer system 600 detects other inputs, similar to 605f1 and 605sf2, to add another new word(s) to the set of words in text bubbles which content 618 is based on. In response to computer system detecting the other inputs, computer system 600 displays another text bubble near 614a-c to even out the text bubbles on each side of content 618 in order to keep symmetry.

As illustrated in FIG. 6G, in response to detecting input 605f1 and input 605f2, content 618 is modified to include a sun. That is, in response to detecting the user adding the word “sun” to the set of words in text bubbles from which content 618 is based, content 618 is modified to include a sun. In some embodiments, the transition of content 618 in FIG. 6F and FIG. 6G includes an intermediary step where computer system 600 displays bounded area 612 as a blank canvas (e.g., similar to the blank bounded area illustrated in FIG. 6C). In some embodiments, the transition of content 618 in FIG. 6F and FIG. 6G is not immediate and computer system 600 may not display the change in content 618 as soon as computer system 600 displays text bubble 614g (“sun”).

As also illustrated in FIG. 6G, computer system 600 displays undo control 616b as selectable (e.g., not dotted). Computer system 600 displays undo control 616b as selectable in response to detecting the user making an input with respect to content 618 and/or while in the generative state that can be undone. Specifically, the user adding text bubble 614g is an action that computer system 600 can undo upon detecting the user directing an input toward undo control 616b. At FIG. 6G, computer system 600 detects tap input 605g on styles control 616e. It should be recognized that tap input 605g can be other types of inputs, such as a voice input requesting that a current style of the generative state be changed.

As illustrated in FIG. 6H, in response to detecting input 605g, computer system 600 displays menu 628 below styles control 616e. Menu 628 includes options of potential style formats of content 618, such as option 628a (“Animation”), option 628b (“Illustration”), and option 628c (“Sketch”). In some embodiments, option 628a corresponds to a video and/or animated image, option 618b correspond to an image that includes colors and or contouring, and option 628c corresponds to black and white images that are similar to sketches. It should be recognized that such options are just examples and that other styles can be used with techniques described herein, such as renaissance, gothic, painted, water colored, and/or anime. As illustrated in FIG. 6H, computer system 600 displays indicator 630 (e.g., a checkmark) next to option 628c to indicate that option 628c (“Sketch”) is the current style of content 618. At FIG. 6H, computer system 600 detects tap input 605h on option 628a (“Animation”). It should be recognized that tap input 605h can be other types of inputs, such as a voice input requesting that a current style of the generative state be changed to animation.

As illustrated in FIG. 6I, in response to detecting tap input 605h, computer system 600 changes the style of content 618 from a sketch to an animation. In some embodiments, other generated content (e.g., represented with indicator 6b and/or 6c) would also change from sketch to animation. However, in some embodiments, only the displayed generated content (e.g., content 618) will change styles. At FIG. 6I, computer system 600 displays content 618 as an animation, indicated by the shovel that the boy is holding positioned higher in the air than in content 618 as illustrated in FIG. 6H. Computer system 600 displaying the shovel moving indicates that content 618 is moving frame-by-frame. In some embodiments, the transition of content 618 in FIG. 6H and FIG. 6I includes an intermediary step where computer system 600 displays bounded area 612 as a blank canvas (e.g., similar to the blank canvas illustrated in FIG. 6C) after detecting input 605h. In some embodiments, the transition of content 618 in FIG. 6H and FIG. 6I is not immediate and computer system 600 may not display the change in content 618 to animation as soon as computer system 600 detects tap input 605h.

As illustrated in FIG. 6J, computer system 600 continues to display content 618 as animated. In FIG. 6J, computer system 600 displays the shovel even higher in the air than in content 618 as illustrated in FIG. 6I, which indicates that computer system 600 is continuing to display content 618 as moving and changing in an animated style. At FIG. 6J, computer system 600 detects tap input 605j directed to the deletion control corresponding to text bubble 614e (“chest”). It should be recognized that tap input 605j can be other types of inputs, such as a voice input requesting that text bubble 614e be removed.

As illustrated in FIG. 6K, in response to detecting tap input 605j, computer system 600 ceases displaying text bubble 604e as well as the chest that computer system 600 depicts in content 618. In some embodiments, the transition of content 618 in FIG. 6J and FIG. 6K includes an intermediary step where computer system 600 displays bounded area 612 as a blank canvas (e.g., similar to the blank canvas illustrated in FIG. 6C) after detecting input 605j and/or removing the display of text bubble 604e. In some embodiments, the transition of content 618 in FIG. 6H and FIG. 6I is not immediate and computer system 600 may not display the change in content 618 as soon as computer system 600 detects tap input 605j while ceasing display of text bubble 604e. Because the word “chest” is no longer a factor on which content 618 is based (e.g., the word “chest” is not added to the words in the query for generating the image), the chest is removed from content 618. That is, computer system 600 displays content 618 with features from words within the text bubbles. In some embodiments, computer system 600 maintains display of features on content 618 sourced from words that computer system 600 deleted. For example, if computer system extracted two similar words from content in the editable region of user interface 602 (e.g., beach and sand), a user could delete text bubble corresponding to “sand”. However, computer system 600 could determine the generated content should still include sand in the image to incorporate text bubble corresponding to beach.

Also illustrated in FIG. 6K, computer system 600 displays indicators 608a-c below bounded area 612 indicating that multiple images have been generated. In some embodiments, indicators 608a-c indicate that other content has been generated in addition to content 618. Computer system 600 displays indicators 608a-c as three small circles with indicator 608a being shaded, reflecting that content 618 corresponds to indicator 608a. The number of indicators corresponds to the number of generated content. That is, two additional content items have been generated, which correspond to indicators 608a-c. It should be recognized that the inclusion, computer system 600 may display indicators 608a-c anytime computer system 600 generates new content and the inclusion if the indicators 608a-c in FIG. 6K is an exemplar order and can be shifted in other examples. At FIG. 6K, computer system 600 detects leftward swipe input 605k directed toward content 618. It should be recognized that leftward swipe input 605k can be other types of inputs, such as a voice input requesting that next content be displayed or an input on an indicator (e.g., indicators 608b-c).

As illustrated in FIG. 6L, in response to detecting leftward swipe input 605k, computer system 600 ceases to display content 618 and begins to display content 634. That is, in response to detecting leftward swipe input 605k directed toward content 618, computer system 600 displays content 618 as sliding leftward (e.g., ceasing to be displayed) and content 634 as appearing to slide in from the right. Also illustrated in FIG. 6L, computer system 600 displays indicator 608a as unshaded and indicator 608b as shaded. The number of indicators 608 corresponds to the number of generated content. Therefore, computer system 600 displaying indicator 608b (e.g., the second indicator) as shaded indicates that the second generated image (e.g., content 634) is the content that computer system 600 is currently displaying.

Computer system 600 displays the second generated content, content 634, as animated content different from content 618. Even though the contents are different, they have key features in common. Specifically, computer system 600 displays content 618 and content 634 each with a sun, a beach, a shovel, a boy (e.g., Mark), and a scene of digging up treasure. However, computer system 600 displays content 634 with a different interpretation of those elements. For example, computer system 600 displays content 634 including the sun in a different area of the sky, the shovel on the ground instead of in the boy's hand, a hole in the sand, and jewels and treasure laying next to a dug-in hole. In some embodiments, because computer system 600 detected the input to delete text bubble 614e, computer system 600 incorporates an element of “treasure” (e.g., indicated by the word “treasure” in text bubble 614c) into content 634 in a way other than a treasure chest. Computer system 600 incorporates the element of “treasure” into content 634 by displaying jewels laying in the sand.

At FIG. 6L, computer system 600 detects tap input 605l on done control 616f. It should be recognized that leftward tap input 605l can be other types of inputs, such as a voice input requesting that the generative state be exited.

As illustrated in FIG. 6M, in response to detecting input 605l, computer system 600 exits the generative state and completes the generation of media, content 634. Because computer system 600 displayed content 634 while detecting input 605l, content 634, and not content 618 or content corresponding to indictor 608a or 608c, is the media that computer system 600 generates. Computer system 600 ceases displaying the text bubbles (e.g., 614a, 614b, 614c, 614d, 614f, and 614g) when exiting the generative state and completing the generation of media. At FIG. 6M, computer system 600 displays content 634 as a fully generated moveable image within user interface 602. Content 634 is located in the same location and/or size as the selected location of input 605b.

As also illustrated in FIG. 6M, in response to detecting input 605l, computer system 600 displays controls 632, e.g., below content 634. Controls 632 are controls for the user to interact with content 634, such as cropping and/or deleting the image. As also illustrated in FIG. 6M, in response to detecting input 605l, computer system 600 redisplays tools 610, such as magic wand tool 610a and pencil tool 610d, at the bottom of user interface 602. As also illustrated in FIG. 6M, in response to detecting input 605l, computer system 600 displays resizing indicator 636 surrounding content 634. Indicator 636 includes controls on each corner with which a user can resize and/or move content 634. At FIG. 6M, computer system 600 detects touch and drag input 605m in an outwards direction on a corner control of indicator 636. It should be recognized that touch and drag input 605m can be other types of inputs, such as a voice input requesting that the generated content be enlarged by a certain percentage.

As illustrated in FIG. 6N, in response to detecting touch and drag input 605m on indicator 636, computer system 600 enlarges content 634 from its appearance as illustrated in FIG. 6M. Computer system 600 continues to display indicator 636 surrounding content 634 in FIG. 6N to allow the user the ability to continue resizing and/or moving content 634 around user interface 602.

FIGS. 7A-7J illustrate exemplary user interfaces for generating and/or interacting with content based on displayed content in accordance with some embodiments. The user interfaces in these figures are used to illustrate the processes described below, including the processes in FIG. 10 and FIG. 12.

FIG. 7A illustrates computer system 600 displaying user interface 602. As illustrated in FIG. 7A, user interface 602 includes content 702, sketch 704, and tools 610 of an editable portion of the user interface 602. Content 702 is a typed paragraph of information about top hats. In some embodiments, content 702 is (e.g., or can) include handwritten text. In some embodiments, sketch 704 is a hand-drawn sketch of a top hat by a user of computer system 600. In other embodiments, sketch 704 is received by computer system 600 and not hand-drawn by a user of computer system 600. In some embodiments, sketch 700 can be text inputted by the user. Similarly to FIG. 6A, computer system 600 displays tools 610 at the bottom of user interface 602. As illustrated in FIG. 7A, computer system 600 displays magic wand tool 610a as the selected tool (e.g., emphasized).

At FIG. 7A, computer system 600 detects tap input 705a directed to a selected location within content 702. In this example, computer system 600 detects tap input 705a at a selected location corresponding to just before the word “Often” in content 702. However, this selected location can be anywhere in the editable portion of the user interface 602 In response to detecting tap input 705a, computer system 600 defines the selected location as where generated content will be added after exiting the generative state. This process will be discussed further below.

As illustrated in FIG. 7B, in response to detecting tap input 705a, computer system 600 displays cursor 720 before the word “Often” in content 702. Computer system 600 displays cursor 720 to represent the selected location of any future input and/or content that computer system 600 generates, detects, adds, deletes, and/or receives. At FIG. 7B, computer system 600 detects input 705b. FIG. 7B illustrates input 705b as an abstract shape surrounding sketch 704. Computer system 600 detects a user performing input 705b using magic wand tool 610a. In some embodiments, the content around which computer system 600 detects an input is typed content, such as content 702.

As illustrated in FIG. 7C, when the magic wand tool is enabled, in response to detecting input 705b, computer system 600 enters a generative state, as discussed above in relation to FIGS. 6B-6C. As illustrated in FIG. 7C, computer system 600 displays representation 706 partially overlapping the border of bounded area 612 without displaying one or more text bubbles. Representation 706 is a shrunken version of the content (e.g., sketch 704) that a user selected (e.g., via input 705b) in the editable region of user interface 602. Specifically, computer system 600 displays representation 706 as a shrunken version of the sketch of the top hat (e.g., content 704) illustrated in the editable portion of the user interface 602 of FIG. 7B, whereas computer system 600 displayed multiple text bubbles (e.g., and not shrunken representations) along the border of bounded area 612 in FIG. 6C. In some embodiments, representation 706 is not a shrunken version of sketch 704 and instead is the same size or bigger version of content in the editable region of user interface 602 (e.g., sketch 704). In some embodiments, one or more text bubbles from the editable region of user interface 602 are displayed in addition to representation 706. In response to detecting input 705b, computer system 600 also displays a deletion control (e.g., a minus sign) next to representation 706. Below bounded area 612, computer system 600 displays controls 616. These controls are for controlling actions while the application is in the generative state. Although the controls are shown below the bounded area 612, they may be displayed anywhere in user interface 602.

As also illustrated in FIG. 7C, in response to detecting input 705b, computer system 600 ceases display of tools 610 and begins display of keyboard 620 with type bar 622 and send control 624. Computer system 600 displays the prompt “Describe the image” in type bar 622 as an instruction to the user. Computer system 600 also displays send control 624 as dotted, which indicates that computer system 600 is unavailable to receive inputs via send control 624 due to the user having not provided any type inputs via type bar 622. It should be recognized that, in some embodiments, in response to detecting input 705b, computer system 600 can also display one or more suggestions with keyboard 620, as discussed above with respect to FIG. 6F.

At FIG. 7D, computer system 600 detects input 705d1. Input 705d1 can include a user typing “Top hat” in type bar 622 or an audible input from a user via a microphone. In response to detecting input 705d1, computer system 600 displays send control 624 as bolded (e.g., not dotted) to indicate that computer system 600 can receive inputs via send control 624. At FIG. 7D, computer system 600 makes a determination that a user is typing (e.g. or speaking) “Top hat” to describe representation 706. In some embodiments, in response to the determination, computer system 600 provides suggestions 708 above keyboard 620. Computer system 600 displays suggestions 708 as words used in content 704, such as “Tall” (e.g., suggestion 708a) and “Cylindrical” (e.g., suggestion 708b) that are sourced from content 702 and “Flat brim” (e.g., suggestion 708b) that is sourced from content 706. Computer system 600 provides suggestions 708 as potential descriptors of representation 706. In some embodiments, computer system 600 makes a content analysis on content 704 and/or representation 706. Computer system 600 displays a plus sign control next to each of suggestions 708a-c to provide the user with the ability to add each suggestion to bounded area 612 upon input of the plus sign control. In some embodiments, computer system 600 adds a suggested word to bounded area 612 via an input from the user on the plus sign control of the suggestion. At FIG. 7D, computer system 600 detects tap input 705d2 on send control 624. It should be recognized that tap input 705d2 can be other types of inputs, such as a voice input stating that the sketch is a top hat.

As illustrated in FIG. 7E, in response to detecting tap input 705b2 on send control 624, computer system 600 ceases display of keyboard 620. In some embodiments, computer system maintains keyboard 620 on the user interface in order to include more descriptive text bubbles to generate an image. As also illustrated in FIG. 7E, in response to detecting tap input 705d2 on send control 624, computer system 600 displays the typed content (e.g., “Top hat”) from FIG. 7D as text bubble 710. Computer system 600 displays text bubble 710 within representation 706 as a descriptor of representation 706.

As illustrated in FIG. 7E, in response to detecting tap input 705b2 on send control 624, computer system 600 displays content 712 in conjunction with displaying the typed content (e.g., “Top hat”) from FIG. 7D as text bubble 710. In some embodiments, in response to detecting that representation has a descriptor (e.g., text bubble 710), content 712 is generated and computer system 600 displays content 712. In some embodiments, computer system 600 generates content 712 based on the appearance of sketch 704 and the content of text bubble 710. That is, computer system 600 displays content 712 as a computer-generated image of a top hat that resembles what was sketched. It should be recognized that, in some embodiments, size, colors, and/or shading are also taken into considered when generating content 712. For example, if the representation 712 included a specific color scheme in sketch 704, computer system 600 can display representation 712 using the same color scheme. Computer system 600 can also take the same consideration for the user inputted content (e.g., typed or handwritten) in the editable region of user interface 602 when generating content 712.

As also illustrated in FIG. 7E, computer system 600 displays undo control 616b as selectable (e.g., not dotted), which indicates that computer system 600 can undo an action (e.g., the addition of text bubble 710). At FIG. 7E, computer system 600 detects tap input 705e directed to add control 616d. It should be recognized that tap input 705e can be other types of inputs, such as a voice input stating to add a limitation to generating content.

As illustrated in FIG. 7F, in response to detecting tap input 705e, computer system 600 displays keyboard 620 and suggestions 708. Suggestions 708 can be the same or different as described above with respect to FIG. 7D, including suggestions 708 in FIG. 7E might not be based on the sketch. At FIG. 7F, computer system 600 also detects tap input 705f2 directed to send control 624. It should be recognized that other types of inputs can be used, such as a voice input stating to add a limitation of “Striped” to generating content.

As illustrated in FIG. 7G, in response to detecting input 705f1 and input 705f2, computer system 600 ceases to display keyboard 620 and displays “Striped” as text bubble 716 along the borders of bounded area 612. As illustrated in FIG. 7G, computer system 600 displays text bubble 716 as partially overlapping the border of bounded area 612. Computer system 600 also displays a delete control next to text bubble 716. At FIG. 7G, content 712 is generated based on representation 706 (e.g., a sketch of a top hat), text bubble 710 (e.g., “Top hat”), and text bubble 716 (e.g., “Striped). As illustrated in FIG. 7G, computer system 600 modifies content 712 to include stripes in response to detecting the word “Striped” as a descriptor. That is, in response to detecting the user adding the word “Striped” from which content 712 is based, content 618 is modified to include stripes. In some embodiments, the transition of content 712 in FIG. 7F and FIG. 7G includes an intermediary step where computer system 600 displays bounded area 612 as a blank canvas (e.g., similar to the blank bounded area illustrated in FIG. 7D). In some embodiments, the transition of content 712 in FIG. 7F and FIG. 7G is not immediate and computer system 600 may not display the change in content 712 as soon as computer system 600 displays text bubble 716 (“Striped”).

As illustrated in FIG. 7G, computer system displays content indicators 714 below content 712. Recall from the description of FIG. 6K that computer system 600 displays indicators 714 to indicate that computer system 600 has generated other content in addition to content 712. Computer system 600 displays indicators 714 as three small circles with indicator 714a shaded. The number of indicators corresponds to the number of generated content. That is, computer system 600 generated content 712, which corresponds to indicator 714a, and also generated two additional content, which correspond to indicators 714b-c. Indicators 714 also indicate which content computer system 600 is currently displaying. That is, computer system 600 displays content corresponding to whichever indicator computer system 600 displays as shaded. For example, in FIG. 7K, computer system 600 displays indicator 714a as shaded and displays the modified generated content. In some embodiments, computer system 600 displays indicators 714 as numbers (e.g., 1, 2, 3) or as letters (A, B, C). It should be recognized that computer system 600 can also modify the other generated content not shown. That is, the two generated images corresponding to indicators 714b-c. At FIG. 7G, computer system 600 detects leftward swipe input 705g directed to content 712. It should be recognized that other types of inputs can be used, such as a voice input requesting to go to next content or an input on an indicator (e.g., indicators 714b-c).

As illustrated in FIG. 7H, in response to detecting swipe input 705g, computer system 600 displays different content (e.g., content 718). Content 718 is additional content generated based on representation 706, text bubble 710, and text bubble 716. That is, computer system 600 displays content 718 as a striped top hat. However, computer system 600 displays content 718 as a different striped top hat than content 712. Specifically, computer system 600 displays content 718 as a shorter, curved top hat as opposed to the taller, straight top hat of content 712. As also illustrated in FIG. 7H, computer system 600 displays content indicator 714a as unshaded and content indicator 714b as shaded, which indicates that computer system 600 is currently displaying content 718 instead of content 712. At FIG. 7H, computer system 600 detects rightward swipe input 705h directed toward content 718. It should be recognized that other types of inputs can be used, such as a voice input requesting to go back to previous content.

As illustrated in FIG. 7I, in response to detecting swipe input 705h, computer system 600 ceases to display content 718 and redisplays content 712 with a striped appearance, as illustrated in FIG. 7G. That is, in response to detecting rightward swipe input 705h directed toward content 718, computer system 600 displays content 718 as sliding rightward (e.g., ceasing to be displayed) and content 712 as appearing to slide in from the left. As also illustrated in FIG. 7I, computer system 600 displays indicator 714a as shaded and indicator 714b as unshaded, which indicates that computer system 600 is currently displaying content 712 and not content 718. At FIG. 7I, computer system 600 detects input 705i directed to done control 616f. It should be recognized that other types of inputs can be used, such as a voice input requesting to exit the generative state.

As illustrated in FIG. 7J, in response to detecting input 705i, computer system 600 exits the generative state. As also illustrated in FIG. 7J, in response to detecting input 705i, computer system 600 redisplays tools 610 and displays controls 632, as described above with respect to FIG. 6M. At FIG. 7J, in response to detecting input 705i, computer system 600 displays content 712 as a generated moveable image within user interface 602. Computer system 600 ceases displaying the text bubble 716 and representation 706 when exiting the generative state and displaying content 712 as a generated movable image. At FIG. 7J, in response to detecting input 705i, computer system 600 displays resizing indicator 636 surrounding content 712, as described above with respect to FIG. 6M.

Recall that computer system 600 defines the selected location of input 705a as illustrated in FIG. 7A as the location of content upon exiting the generative state. As illustrated in FIG. 7J, in response to detecting input 705i, computer system 600 displays content 712 at the selected location corresponding to input 705a as illustrated in FIG. 7A. In response to placing content 712 at the selected location of input 705a (e.g., to the left of the word “Often”), computer system 600 shifts a portion of content 702 to accommodate content 712. Specifically, computer system 600 shifts the word “Often” and the portion of content 702 that comes after the word “Often” to the right on user interface 602 to display content 712 in the selected location corresponding to input 705a. Note that computer system 600 displays resizing indicator 636 surrounding content 712 and controls 632 below content 712 in the selected location corresponding to input 705a. In some embodiments, computer system 600 detects an input directed to resizing indicator 636 to enlarge or shrink content 712.

FIGS. 8A-8F illustrate exemplary user interfaces for generating and/or interacting with content based on displayed text in accordance with some embodiments. The user interfaces in these figures are used to illustrate the processes described below, including the processes in FIGS. 11-12.

FIG. 8A illustrates computer system 600 displaying user interface 602. As illustrated in FIG. 8A, user interface 602 includes content 802, which computer system 600 displays as a typed paragraph including instructions for making a pizza. Computer system 600 also includes tools 610 at the bottom of user interface 602 and displays pencil tool 610d as selected. User interface 602 also includes sketch 804, a user inputted drawing of a pizza, as well as sketch 806, sketch 808, sketch 810, and sketch 812 surrounding sketch 804. Sketch 806 (“mozzarella”), sketch 808 (“pepperoni”), sketch 810 (“tomato”), and sketch 812 (“parsley”) are hand-written words surrounding sketch 804. In some embodiments, the sketches (e.g., sketches 804, 804, 808, 810 and/or 812) can includes handwritten content, typed content, and/or a computer-generated image inputted by the user. At FIG. 8A, computer system 600 detects input 805a on magic wand tool 610a.

As illustrated in FIG. 8B, in response to detecting input 805a, computer system 600 displays magic wand tool 610a as selected (e.g., emphasized). At FIG. 8B, computer system 600 detects input 805b, which is a hand-drawn input using magic wand tool 610a surrounding sketch 804, sketch 806, sketch 808, sketch 810, and sketch 812. That is, at FIG. 8B, computer system 600 detects the user making an input surrounding the sketch of the pizza and the words surrounding it. In some embodiments, computer system 600 detects the user making an input on a word (or a set of words (e.g., typed or handwritten)) or in an empty area of user interface 602 and the process describe below will still continue.

As illustrated in FIG. 8C, when the magic wand tool is enabled, in response to detecting input 805b, computer system 600 enters a generative state, as discussed above in relation to FIG. 6C. As described with respect to FIG. 6C, computer system 600 entering a generative state includes computer system 600 ceasing to display tools 610. As illustrated in FIG. 8C, in response to detecting input 805b, computer system 600 displays bounded area 612. Computer system 600 displays bounded area 612 as a blank square in the selected location that computer system 600 detected input 805b, the empty space between content 802 and tools 610. In some embodiments, computer system 600 displays bounded area 612 as a shape other than a square (e.g., circle, rectangle, abstract shape, shape of the input). Also illustrated in FIG. 8C, computer system 600 displays bounded area 612 at the same size of input 805b. That is, computer system 600 displays bounded area 612 at a size based on and corresponding to the size of input 805b. Computer system 600 will utilize bounded area 612 as a canvas to generate new content corresponding to content 802 and sketches 804-812.

As also illustrated in FIG. 8C, computer system 600 displays text bubbles 814a-f with deletion controls near the borders of bounded area 612. Text bubbles 814a-f include words directly from content 802 (e.g., text bubble 814b (“dough”) and text bubble 814e (“garnish”)) or 806 (e.g., text bubble 814a (“mozzarella”), text bubble 814c (“tomato”), text bubble 814d (“parsley”), and text bubble 814f (“pepperoni”)). Below bounded area 612, computer system 600 displays controls 616, as described above in relation to FIG. 6C.

As also illustrated in FIG. 8C, computer system 600 displays representation 816 below text bubble 814c as a text bubble with a deletion control. Computer system 600 displays representation 816 as a shrunken version of the sketches (e.g., sketches 804-812) around which computer system 600 detected input 805b. That is, computer system 600 displays representation 816 as a shrunken version of a hand-drawn pizza and the hand-written words as illustrated in FIGS. 8A-8B. In some embodiments, representation 816 is not a shrunken version of the sketches and instead is the same size or bigger than the sketches. In some embodiments, computer system 600 displays just sketch 804 in the sketches and the other sketches (e.g., sketches 804-812) are recognized as part of content 802 or another content. Representation 816 also includes control 820 (e.g., “Describe”), onto which the user can provide an input to add a word to describe the content of representation 816. In some embodiments, computer system 600 transforms the hand-written words in representation 816 into typed text bubbles that are then added to representation 816. Computer system 600 displays text bubbles 814a-f and representation 816 along bounded area 612 as descriptors of the new content that computer system 600 will generate within bounded area 612. That is, computer system 600 will generate content based on the sketch of the pizza, the hand-written words, and/or text bubbles 814a-f, which are words taken from content 802. In some embodiments, the handwritten words inside the sketches (e.g., sketches 808, 806, and 810) are not included in representation 816 and are instead added to text bubbles along bounded area612. It should be recognized that the order shown of representation 616 and text bubbles 814a-f is an exemplary arrangement and the order can be shifted in other examples. At FIG. 8C, computer system 600 detects tap input 805c directed toward control 820. It should be recognized that other types of inputs can be used, such as a voice input describing the sketch as pineapple.

As illustrated in FIG. 8D, in response to detecting tap input 805c, computer system 600 displays keyboard 620. Above keyboard 620, computer system 600 displays suggestions sourced from content in the editable region of user interface 602, e.g., 822 as words used in content 802, such as “Sprinkle” (e.g., suggestion 822a), “Thin slices” (e.g., suggestion 822b), and “Baking” (e.g., suggestion 822c). In some embodiments, the suggestion 822 are not words used in content 802 but is related to text bubbles 814a-f displayed near bounded area 612. In some embodiments, computer system 600 makes a content analysis on content 806 and/or representation 816. Computer system 600 provides suggestions 822 as potential descriptors of representation 816. Computer system 600 displays a plus sign control next to each of suggestions 822a-c to provide the user with the ability to add each suggestion to bounded area 612 upon computer system 600 detecting input directed to the plus sign control. In some embodiments, computer system 600 adds a suggested word to bounded area 612 in response to detecting an input from the user on the plus sign control of the suggestion. At FIG. 8D, computer system 600 detects input 805d1, the user typing “Pineapple” into type bar 622. At FIG. 8D, computer system 600 also detects tap input 805d2 on send control 624.

As illustrated in FIG. 8E, in response to detecting input 805d1 and input 805d2, computer system 600 displays control 820 as the word “Pineapple.” Recall that computer system 600 displays control 820 as a descriptor of the new content that computer system 600 will generate within bounded area 612 in addition to the other descriptors (e.g., representation 816 and text bubbles 814a-f. As illustrated in FIG. 8E, in response to detecting input 805d1 and input 805d2, content 818 is generated and computer system 600 displays content 818 within bounded area 612. Computer system 600 displays content 818 as a computer-generated image of a pizza based on components included in representation 816 and text bubbles 814a-f. For example, computer system 600 displays the pizza in content 818 as including mozzarella (e.g., text bubble 814a), dough (e.g., text bubble 814b), tomato (e.g., text bubble 814c), a garnish (e.g., text bubble 814e) of parsley (e.g., text bubble 814d), pepperoni (e.g., text bubble 814f), and pineapple (e.g., control 820). It should be recognized that size, colors, and/or shading can also be taken into consideration when generating content 818. That is, if the representation 816 included a specific color scheme in the sketches (e.g., sketches 804-812), computer system 600 can display representation 818 using the same color scheme. Computer system 600 can also take the same consideration for the user inputted text (e.g. typed or handwritten) when generating content 818.

As also illustrated in FIG. 8E, in response to detecting input 805d1 and input 805d2, computer system 600 displays undo control 616b as bolded (e.g., not dotted). Computer system 600 displays undo control 616b as bolded to indicate that computer system 600 detects an action that computer system 600 can undo (e.g., adding a descriptor word to control 820). At FIG. 8E, computer system 600 detects tap input 805e directed to done control 616f. It should be recognized that other types of inputs can be used, such as a voice input stating that the user is finished.

As illustrated in FIG. 8F, in response to detecting tap input 805e, computer system 600 exits the generative state. Exiting the generative state includes computer system 600 redisplaying tools 610 and displaying controls 632, as described above with respect to FIG. 6M. Note that computer system 600 displays magic wand tool 610a as emphasized (e.g., selected) in FIG. 8F. In FIG. 8F, in response to exiting the generative state, computer system 600 displays content 818 as a completely generated moveable image within user interface 602. Computer system 600 ceases displaying the text bubbles (e.g., 614a, 614b, 614c, 614d, 614f, and 614g) when exiting the generative state and completing the generation of media Computer system 600 also displays resizing indicator 636 surrounding content 818, as described above with respect to FIG. 6M.

FIG. 9 is a flow diagram illustrating a method (e.g., method 900) for generating (e.g., using an AI process or a generative AI process) and/or interacting with content in a space in accordance with some embodiments. Some operations in method 900 are, optionally, combined, the orders of some operations are, optionally, changed, and some operations are, optionally, omitted.

As described below, method 900 provides an intuitive way for generating and/or interacting with content in a space. Method 900 reduces the cognitive burden on a user, thereby creating a more efficient human-machine interface. For battery-operated computing devices, enabling a user to interact with such devices faster and more efficiently conserves power and increases the time between battery charges.

In some embodiments, method 900 is performed at a computer system (e.g., 600) that is in communication with a display generation component (e.g., a display screen, a projector, and/or a touch-sensitive display) and one or more input devices (e.g., a camera, a depth sensor, a microphone, an electronic stylus, an electronic pencil, a hardware input mechanism, a rotatable input mechanism, a heart monitor, a temperature sensor, and/or a touch-sensitive surface). In some embodiments, the computer system is a watch, a phone, a tablet, a fitness tracking device, a processor, a head-mounted display (HMD) device, a communal device, a media device, a speaker, a television, and/or a personal computing device.

While (e.g., after) displaying, via the display generation component, first content (e.g., 602, 604, 606, 634, 702, 704, 712, 802, 804, 806, 808, 810, 812, and/or 818) (e.g., an image, a video, text, a text box, a shape, a line, computer-generated content, and/or user inputted content, such as handwritten or typed content), the computer system detects (902), via the one or more input devices, a first input (e.g., 605b, 706a, 705b, and/or 805b) (e.g., a tap input, an hold-drag-and-release input that surrounds a portion of the first content (e.g., the portion of the first content described below), and/or a non-tap input (e.g., a verbal input, an audible request, an audible command, an audible statement, a swipe input, a hold-and-drag input, a gaze input, an air gesture, mouse movement, and/or a mouse click)) corresponding to a first location (e.g., as described above with respect to FIGS. 6A-6B). In some embodiments, the first location does not correspond to content (e.g., the first content and/or other content). In some embodiments, the first location corresponds to an empty space in a document being displayed via the display generation component.

In response to detecting the first input corresponding to the first location (and/or while displaying the first content), the computer system displays (904), via the display generation component: (906) a first indication (e.g., 612) (e.g., as described above with respect to FIG. 6C) of (and/or corresponding to) the first input (e.g., a text-insertion indication and/or a bounding area where content will be placed); and a (908) second indication (e.g., text and/or image) (e.g., 614a-f) (e.g., as described above with respect to FIG. 6C) corresponding to (and/or of) a portion of the first content. In some embodiments, a size of the first indication corresponds to (and/or is the same as) a size of the first input, such as an area within the first input. In some embodiments, the first indication is displayed at the first location. In some embodiments, the second indication includes a representation of the portion of the first content (e.g., a smaller or larger version of the portion of the first content). In some embodiments, the second indication includes the portion of the first content.

The computer system detects (910), via the one or more input devices, a set of one or more inputs (e.g., 605e, 605f1, 605f2, 605g, 605h, and/or 605l) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (and/or while displaying the first content), wherein a second input (e.g., 605e, 605f1, 605f2, 605g, 605h, and/or 605l) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) of the set of one or more inputs is detected while displaying the second indication corresponding to the portion of the first content (and/or while displaying the first indication of the first input). In some embodiments, another input (e.g., different from the second input) of the set of one or more inputs is detected while no longer displaying the first indication and/or the second indication. In some embodiments, another input (e.g., different from the second input) of the set of one or more inputs is directed to a user interface element to generate additional content.

In response to detecting the set of one or more inputs (and/or while displaying the first content), the computer system displays (912), via the display generation component, second content (e.g., 618 and/or 634) (e.g., media, generated content, an image, a video, and/or text) (e.g., automatically-generated visual content and or generative visual content) corresponding to (and/or generated based on) the second indication (and/or corresponding to the first content), wherein the second content is displayed at the first location, and wherein the second content is different from the first content (e.g., as described above with respect to FIGS. 6D-6M). Displaying the first indication of the first input and the second indication corresponding to the portion of the first content in response to detecting the first input allows the computer system to respond to an input with an indication of the input as well as contextual information obtained from content being displayed, thereby providing improved visual feedback and/or reducing the number of inputs need to perform an operation. Displaying the second content corresponding to the second indication in response to detecting the set of one or more inputs allows the computer system to display new content based on inputs received and other content being displayed, thereby providing improved visual feedback and/or performing an operation when a set of conditions has been met without requiring further user input.

In some embodiments, the second content (e.g., 618 and/or 634) is a generated image (e.g., as described above with respect to FIG. 6D, FIGS. 6I-6J, and/or FIG. 6M) (e.g., text, animation, and/or video) (e.g., automatically-generated visual content and or generative visual content). In some embodiments, the second content is generated content. In some embodiments, the second content is generated (e.g., using an AI process or a generative AI process) (e.g., by the computer system and/or another computer system different from the computer system) based on the second indication in response to detecting the first input corresponding to the first location, in response to detecting the set of one or more inputs, and/or in response to detecting an input of the set of one or more inputs. The second content being generated image allows the computer system to use provided content to easily create new media that is relevant to the content, thereby reducing the number of inputs needed to perform an operation.

In some embodiments, the second indication (e.g., 614a-f) (e.g., as described above with respect to FIG. 6C) corresponding to the portion of the first content overlaps (e.g., visually overlaps) a portion (e.g., an area, an edge, and/or a boundary) of the first indication (e.g., 612) (e.g., as described above with respect to FIG. 6C) corresponding to the first input. In some embodiments, a portion of the second indication overlays a portion of the first indication. In some embodiments, the second indication corresponding to the portion of the first input partially is overlaid on top of the first indication corresponding to the first input. The second indication overlapping a portion of the first indication allows the computer system to visually group the first indication and the second indication as part of an operation being performed, thereby providing improved visually feedback to the user and/or performing an operation when a set of conditions has been met without requiring further user input.

In some embodiments, the first input (e.g., 605b) corresponds to (and/or is) a respective size (e.g., size corresponding to the first input as described above at FIG. 6B). In some embodiments, an area within the first input is the respective size. In some embodiments, the first input defines a size for the second content (e.g., automatically-generated visual content and or generative visual content) to be the respective size. In some embodiments, a left-most, a top-most, a right-most, and/or a bottom-most portion of the first input defines the respective size. In some embodiments, in accordance with a determination that the respective size is a first size, the second content (e.g., 618 and/or 634) is the first size (e.g., as described above with respect to FIG. 6D-6M) (e.g., when displayed in response to detecting the set of one or more inputs). In some embodiments, in accordance with the determination that the respective size is the first size, the first indication is the first size. In some embodiments, in accordance with a determination that the respective size is a second size different from the first size, the second content is the second size (e.g., as described above with respect to FIG. 6D-6M) (e.g., when displayed in response to detecting the set of one or more inputs) (e.g., and not the first size). In some embodiments, in accordance with the determination that the respective size is the first size, the first indication is the second size (e.g., and not the first size). In some embodiments, in response to detecting the first input corresponding to the first location and in accordance with the determination that the respective size is the first size, the computer system displays, via the display generation component, the first indication of (and/or corresponding to) the first input at the first size. In some embodiments, in response to detecting the first input corresponding to the first location and in accordance with the determination that the respective size is the second size, the computer system displays, via the display generation component, the first indication of (and/or corresponding to) the first input at the second size. In some embodiments, a size of the first indication corresponds to (and/or is the same as) a size of the first input, such as an area within the input. In some embodiments, in response to detecting the set of one or more inputs and in accordance with the determination that the respective size is the first size, the computer system displays, via the display generation component, the second corresponding to the second indication (and/or corresponding to the first content) at the first size. In some embodiments, in response to detecting the set of one or more inputs and in accordance with the determination that the respective size is the second size, the computer system displays, via the display generation component, the second corresponding to the second indication (and/or corresponding to the first content) at the second size. The first input and the second content being the same size allows the computer system to signal to a user a size of content that is going to be generated based on an input detected from the user, thereby reducing the number inputs needed to perform an operation, performing an operation when a set of conditions has been met without requiring further user input, and/or providing improved visual feedback to the user.

In some embodiments, the first content (e.g., 604 and/or 606) includes handwritten content (e.g., 606) (e.g., detected via the one or more input devices and/or received by the computer system from another computer system different from the computer system). In some embodiments, the second indication (e.g., 614a-f) includes a representation (e.g., typed text (e.g., that is a transcription of the handwritten content), a larger reproduction, and/or a smaller reproduction) of the handwritten content (e.g., as described above with respect to FIG. 6C). The first content including handwritten content and the second indication including a representation of the handwritten content allows the computer system to be able to transcribe handwritten content to text and/or a representation of the handwritten content, thereby providing improved visual feedback to the user and/or performing an operation when a set of conditions has been met without requiring further user input.

In some embodiments, the first content (e.g., 604 and/or 606) includes typed content (e.g., 604) (e.g., detected via the one or more input devices and/or received by the computer system from another computer system different from the computer system). In some embodiments, the second indication (e.g., 614a-f) includes a representation (e.g., the typed content itself, the typed content in a different color, font, and/or size, a larger reproduction, and/or a smaller reproduction) of the typed content (e.g., as described above with respect to FIG. 6C). The first content including typed content and the second indication including a portion of the typed content allows the computer system to transform typed content in a manner that is more visually appealing to the user and/or more efficient from a screen usage perspective when displaying the first indication and the second indication, thereby providing improved visual feedback to the user and/or performing an operation when a set of conditions has been met without requiring further user input.

In some embodiments, the first location (e.g., corresponding to input 605b as described above with respect to FIG. 6C) corresponds (and/or is directed) to (and/or is, is a location with) an empty space (e.g., region, area, portion, and/or section) (e.g., of a document being displayed via the display generation component) while detecting the first input (e.g., 605b) (e.g., the first location does not include content while detecting the first input) (e.g., the first input corresponds to an area without content) (e.g., the first input is detected at a location without content). The first input corresponding to an empty space allows the user to provide a defining area for displaying the first indication, the second indication, and/or the second content, thereby providing improved visual feedback to the user and/or performing an operation when a set of conditions has been met without requiring further user input.

In some embodiments, the first indication (e.g., 612) of the first input is a bounding box (e.g., as described above with respect to FIG. 6C) (e.g., an enclosed shape that specifies a position and/or a size of the second content) (e.g., with a top edge, a left edge, a right edge, and/or a bottom edge). In some embodiments, the first indication is the same size as the first input. In some embodiments, a size of the first indication corresponds to a size of the first input. The first indication being a bounding box allows the computer system to signal to a user where the second content is going to be added-, thereby reducing the number inputs needed to perform an operation, performing an operation when a set of conditions has been met without requiring further user input, and/or providing improved visual feedback to the user.

In some embodiments, the second indication (e.g., 614a-f) includes a representation (e.g., a reproduction of the same size as, a typed text, a transcription, a graphical representation, a smaller reproduction, and/or a larger reproduction) of the portion of the first content (e.g., 604 and/or 606) (e.g., as described above with respect to FIG. 6C). The second indication including a representation of the portion of the first content allows the computer system to reflect what content that the computer system is going to use to generate the second content, thereby reducing the number inputs needed to perform an operation, performing an operation when a set of conditions has been met without requiring further user input, and/or providing improved visual feedback to the user.

In some embodiments, the second indication (e.g., 614a-f) includes text (e.g., as described above with respect to FIG. 6C) (e.g., corresponding to the portion of the first content (e.g., an image, a video, text, a text box, a shape, a line, computer-generated content, and/or user inputted content such as handwritten or typed content)).

In some embodiments, while (e.g., after) displaying the second indication (e.g., 614a-f) (and/or the first indication and/or the first content), the computer system detects, via the one or more input devices, a second input (e.g., 605e, 605f1, and/or 605f2) (e.g., as described above with respect to FIGS. 6E-6F) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (e.g., different from the first input). In some embodiments, the second input includes content, such as audio, written text, typed text, and/or a graphical representation. In some embodiments, in response to detecting the second input (and/or while maintaining display of the first indication, the second indication, and/or the first content), the computer system displays, via the display generation component, a third indication (e.g., 614g) (e.g., text and/or image) corresponding to (and/or of) the second input (e.g., as described above with respect to FIGS. 6E-6G) (e.g., the third indication is displayed concurrently with the first indication and/or the second indication), wherein: the third indication is different (e.g., different words and/or phrases) from the second indication; in accordance with a determination that a first set of one or more criteria is satisfied (e.g., the second indication and the third indication are displayed) while detecting the set of one or more inputs, the second content (e.g., automatically-generated visual content and or generative visual content) (e.g., 618 and/or 634) corresponds to (and/or is generated (e.g., using an AI process or a generative AI process) based on) the third indication and the second indication; and in accordance with a determination that a second set of one or more criteria, different from the first set of one or more criteria, is satisfied (e.g., the third indication is not displayed) while detecting the set of one or more inputs (e.g., as described above with respect to FIG. 6G), the second content corresponds to (and/or is generated based on) the second indication but not the third indication. In some embodiments, in accordance with a determination that a third set of one or more criteria, different from the first set of one or more criteria and the second set of one or more criteria, is satisfied (e.g., the second indication is not displayed but the third indication is displayed) while detecting the set of one or more inputs, the second content (e.g., automatically-generated visual content and or generative visual content) corresponds to (and/or is generated (e.g., using an AI process or a generative AI process) based on) the third indication but not the second indication. In some embodiments, in accordance with a determination that a fourth set of one or more criteria, different from the first set of one or more criteria, the second set of one or more criteria, and the third set of one or more criteria, is satisfied (e.g., the second indication and the third indication are not displayed) while detecting the set of one or more inputs, the second content does not correspond to (and/or is not generated based on) the second indication and/or the third indication. The content corresponding and/or not corresponding to specific indications when a certain set of criteria is made allows the computer system to selectively change the second content, thereby reducing the number inputs needed to perform an operation, performing an operation when a set of conditions has been met without requiring further user input, and/or providing improved visual feedback to the user.

In some embodiments, while displaying the third indication corresponding to the second input (e.g., 614a-g) (and/or while displaying the first indication, the second indication, and/or the first content), the computer system detects, via the one or more input devices, a third input (e.g., 605j) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (e.g., different from the first input) to remove (and/or delete and/or cease display of) the third indication (e.g., as described above with respect to FIG. 6J). In some embodiments, in response to detecting the third input to remove the third indication (and/or while maintaining display of the first indication, the second indication, and/or the first content), the computer system ceases (and/or removes) display of the third indication (e.g., 614a-g), wherein the second set of one or more criteria includes a criterion that is satisfied when the third indication is not displayed (e.g., as described above with respect to FIG. 6K). Ceasing displaying the third indication and changing the second content allows the computer system to change the second content to include only characteristics shown as indications, thereby reducing the number inputs needed to perform an operation, performing an operation when a set of conditions has been met without requiring further user input, and/or providing improved visual feedback to the user.

In some embodiments, while displaying the second content (e.g., automatically-generated visual content and or generative visual content) (e.g., 618) corresponding to the second indication (e.g., 614a-f) (and/or while displaying the first indication, the second indication, and/or the first content), the computer system detects, via the one or more input devices, a fourth input (e.g., 605k) (e.g., as described above with respect to FIG. 6K) (e.g., a swipe input and/or a non-swipe input (e.g., a verbal input, an audible request, an audible command, an audible statement, a tap input, a hold-and-drag input, a gaze input, an air gesture, mouse movement, and/or a mouse click)) (e.g., different from the first input). In some embodiments, in response to detecting the fourth input, the computer system displays (e.g., using an AI process or a generative AI process), via the display generation component, third content (e.g., automatically-generated visual content and or generative visual content) corresponding to (and/or generated based on) the second indication (and/or corresponding to the first content), wherein the third content (e.g., 618 as described above with respect to FIG. 6L) is displayed at the first location, and wherein the third content is different from the first content (e.g., 604 and/or 606) and the second content. Displaying new content in response to an input allows the computer system to change the generated content in response to detecting a request from the user, thereby providing improved visual feedback and/or providing additional control options without cluttering the user interface with additional displayed controls.

In some embodiments, the second content (e.g., 618 and/or 634) is displayed at a first size in response to detecting the set of one or more inputs. In some embodiments, while displaying the second content (e.g., 618 and/or 634) at the first size (e.g., after detecting the set of one or more inputs) (e.g., without displaying the first indication and/or the second indication) (and/or while displaying the first content), the computer system detects, via the one or more input devices, a fifth input (e.g., 605m) (e.g., to resize) (e.g., a hold-and-drag input and/or a non-hold-and-drag input (e.g., a tap input, a verbal input, an audible request, an audible command, an audible statement, a swipe input, a gaze input, an air gesture, mouse movement, and/or a mouse click)) (e.g., different from the first input). In some embodiments, in response to detecting the fifth input (and/or while displaying the first content), the computer system displays, via the display generation component, the second content (e.g., 618 and/or 634) at a second size (e.g., bigger, or smaller size) different from the first size (e.g., as described above with respect to FIGS. 6M-6N). Displaying the second content at a second size in response to an input allows the computer system to edit a visual characteristic of the second content after detecting a user request, thereby providing improved visual feedback and/or providing additional control options without cluttering the user interface with additional displayed controls.

In some embodiments, while (e.g., after) displaying the second content (e.g., 618 and/or 634) (and/or while displaying the first indication, the second indication, and/or the first content), the computer system detects, via the one or more input devices, a sixth input (e.g., 605e, 605f1, and/or 605f2) (e.g., as described above with respect to FIGS. 6E-6F) (e.g., a tap input and/or a non-tap input (e.g., a verbal input, an audible request, an audible command, an audible statement, a gaze input, an air gesture, and/or a mouse click)) (e.g., including typed text, handwritten text, and/or a voice input) (e.g., corresponding to selection of a user interface element, such as an enter or submit button) (e.g., different from the first input). In some embodiments, in response to detecting the sixth input (and/or while displaying the first indication, the second indication, and/or the first content), the computer system displays, via the display generation component a fourth indication (e.g., 614g) (e.g., text and/or image) corresponding to the sixth input (concurrently with the second indication), wherein the fourth indication is different (e.g., different words and/or phrases) from the second indication (e.g., 614a-f) (e.g., as described above with respect to FIGS. 6F-6G) (and/or the first indication). Displaying a fourth indication corresponding to the sixth input allows the user to include new indications to provide to the computer system for the second content in order to make changes to generated content, thereby providing improved visual feedback and/or performing an operation when a set of conditions has been met.

In some embodiments, while (e.g., after) displaying the fourth indication (e.g., 614g) (and/or while displaying the first indication, the second indication, and/or the first content), the computer system detects, via the one or more input devices, a seventh input (e.g., 605l) (e.g., to generate and/or finalize content) (e.g., a tap input and/or a non-tap input (e.g., a verbal input, an audible request, an audible command, an audible statement, a gaze input, an air gesture, and/or a mouse click)) (e.g., different from the first input). In some embodiments, in response to detecting the seventh input (and/or while displaying the first content), the computer system displays, via the display generation component, fifth content (e.g., automatically-generated visual content and or generative visual content) (e.g., media, generated content, an image, a video, and/or text) (e.g., without displaying the first indication, the second indication, and/or the fourth indication) corresponding to (and/or generated (e.g., using an AI process or a generative AI process) based on) the fourth indication (and/or the second indication), wherein the fifth content is different from the first content (e.g., 604 and/or 606) (e.g., as described above with respect to FIGS. 6E-6F) (and/or the second content). In some embodiments, a representation of the fifth content is displayed before detecting the seventh input. In some embodiments, in response to detecting the seventh input, the computer system ceases display of the fourth indication (and/or the first indication and/or the second indication). Displaying different content after adding a new indication allows the computer system to change the content to include the new defining indication when a user requests the change, thereby providing improved visual feedback and/or performing an operation when a set of conditions has been met.

In some embodiments, while (e.g., after) displaying the second indication (e.g., 614a-f) (and/or the first indication, a representation of the second content, and/or the first content), the computer system detects, via the one or more input devices, an eighth input (e.g., 605e) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (e.g., to add an indication and/or edit an indication). In some embodiments, in response to detecting the eighth input (and/or while displaying the first content), the computer system displays, via the display generation component, one or more suggestions (e.g., automatically-generated suggestions) (e.g., 626) (e.g., corresponding (e.g., directly or indirectly) to the first content) including a first suggestion at a first location (e.g., as described above with respect to FIG. 6F) (e.g., in proximity and/or adjacent to a virtual keyboard, such as above the virtual keyboard). In some embodiments, the first suggestion corresponds to the first content and/or the second indication. In some embodiments, the first suggestion does not correspond to the first content and/or the second indication. In some embodiments, the first suggestion includes text, an image, a graphic, and/or a video. In some embodiments, in response to detecting the eighth, the computer system displays, via the display generation component, the virtual keyboard. In some embodiments, while displaying the one or more suggestions (and/or the first indication, the second indication, a representation of the second content, and/or the first content) including the first suggestion at the first location, the computer system detects, via the one or more input devices, a ninth input corresponding to the first suggestion (e.g., as described above with respect to FIG. 6F). In some embodiments, in response to detecting the ninth input corresponding to the first suggestion (and/or while displaying the first content), the computer system displays, via the display generation component, the first suggestion (and/or a representation (e.g., smaller, larger, and/or condensed version) of the first suggestion) at a second location (e.g., overlapping the first indication) different from the first location (e.g., as described above with respect to FIGS. 6F-6G). In some embodiments, in response to detecting the ninth input corresponding to the first suggestion, the computer system ceases display of, via the display generation component, the first suggestion at the first location (e.g., while maintaining display of one or more other suggestions of the one or more suggestions). In some embodiments, in response to detecting the ninth input corresponding to the first suggestion, the computer system ceases display of, via the display generation component, the one or more suggestions. In some embodiments, in response to detecting the ninth input corresponding to the first suggestion and in accordance with a determination that the second content is displayed while detecting the ninth input, the computer system displays, via the display generation component, new content that corresponds to (e.g., is generated based on) the second indication and the first suggestion. In some embodiments, the second content corresponds to the second indication and the first suggestion after detecting the ninth input corresponding to the first suggestion. Displaying one or more suggestions and in response to an input on one of the one or more suggestions allows the computer system to provide relevant possible defining words that would then be used to generate content without the user needing to type the word in to add as a new indication, thereby providing improved visual feedback and/or providing additional control options without cluttering the user interface with additional displayed controls.

In some embodiments, the first suggestion (e.g., 626) is generated (and/or determined) based on the first content (e.g., 604 and/or 606) (and/or the second indication and/or the second content). The one or more suggestion being generated based on the first content allows the computer system to automatically run a content analysis and display relevant suggestions to the user, thereby providing improved visual feedback, providing additional control options without cluttering the user interface with additional displayed controls, and/or performing an operation when a set of conditions has been met without requiring further user input.

In some embodiments, the second content (e.g., automatically-generated visual content and or generative visual content) (e.g., 618 and/or 634) (and/or a representation of the second content) is displayed concurrently with the second indication (e.g., 614a-f) (e.g., as described above with respect to FIGS. 6D-6M). In some embodiments, the second content (and/or a representation of the second content) is not displayed with the first indication.

In some embodiments, while (e.g., after) displaying the second content (e.g., automatically-generated visual content and or generative visual content) (e.g., 618 and/or 634) (and/or the second indication, the first content, and/or a representation of the second content), the computer system detects, via the one or more input devices, a tenth input (e.g., 6051) (e.g., to generate and/or finalize content) (e.g., a tap input and/or a non-tap input (e.g., a verbal input, an audible request, an audible command, an audible statement, a gaze input, an air gesture, and/or a mouse click)) (e.g., different from the first input). In some embodiments, in response to detecting the tenth input (and/or while displaying the first content), the computer system displays, via the display generation component, the second content (e.g., 618 and/or 634) without displaying the first indication (e.g., 612) and the second indication (e.g., 614a-f) (e.g., as described above with respect to FIG. 6M). In some embodiments, in conjunction with displaying the second content, the computer system displays, via the display generation component, a set of one or more controls (e.g., that were not displayed before detecting the tenth input and/or while displaying the first indication and/or the second indication). In some embodiments, the second content is displayed at the first location. In some embodiments, the second content is displayed at a size corresponding to the first indication (and/or the first input). Displaying the second content without displaying the first indication and the second indication allows the computer system to transition out of a generative state and display the second content as a generated image, thereby performing an operation when a set of conditions has been met and/or providing improved visual feedback to the user.

In some embodiments, while displaying the first content (e.g., 604 and/or 606) (and/or before detecting the first input), the computer system detects, via the one or more input devices, a tenth input (e.g., 605a and/or 605b) (e.g., as described above with respect to FIGS. 6A-6B) (e.g., a tap input, an hold-drag-and-release input that surrounds a portion of the first content (e.g., the portion of the first content described below), and/or a non-tap input (e.g., a verbal input, an audible request, an audible command, an audible statement, a swipe input, a hold-and-drag input, a gaze input, an air gesture, mouse movement, and/or a mouse click)) (e.g., different from the first input). In some embodiments, the tenth input includes the same path and/or is at the same position as the first input. In some embodiments, in response to detecting the tenth input (and/or while displaying the first content), in accordance with a determination that a first tool (e.g., 610a) (e.g., content generation tool) is selected, the computer system displays, via the display generation component, the first indication of the input (e.g., 612) and the second indication corresponding to the portion of the first content (e.g., 614a-f) (e.g., as described above with respect to FIGS. 6A-6B). In some embodiments, in response to detecting the tenth input, in accordance with a determination that that a second tool (e.g., 610d) (e.g., pencil tool, pen tool and/or eraser tool), different from the first tool, is selected, the computer system performs an operation (e.g., displays, via, the display generation component, a line along a path of the tenth input) without displaying the first indication (e.g., 612) (e.g., 614a-f) (e.g., as described above with respect to FIG. 6A-6B) and the second indication. Selectively displaying the first indication depending on which tool is being used allows the computer system to only move into a generative state when a tool for generating content is used, thereby performing an operation when a set of conditions has been met, providing additional control options without cluttering the user interface with additional displayed controls, and/or providing improved visual feedback to the user.

Note that details of the processes described above with respect to method 900 (e.g., FIG. 9) are also applicable in an analogous manner to other methods described herein. For example, method 1200 optionally includes one or more of the characteristics of the various methods described above with reference to method 900. For example, the first input of method 900 can be the first input of method 1200. For brevity, these details are not repeated herein.

FIG. 10 is a flow diagram illustrating a method (e.g., method 1000) for generating and/or interacting with content based on displayed content in accordance with some embodiments. Some operations in method 1000 are, optionally, combined, the orders of some operations are, optionally, changed, and some operations are, optionally, omitted.

As described below, method 1000 provides an intuitive way for generating (e.g., using an AI process or a generative AI process) and/or interacting with content based on displayed content. Method 1000 reduces the cognitive burden on a user, thereby creating a more efficient human-machine interface. For battery-operated computing devices, enabling a user to interact with such devices faster and more efficiently conserves power and increases the time between battery charges.

In some embodiments, method 1000 is performed at a computer system (e.g., 600) that is in communication with a display generation component (e.g., a display screen, a projector, and/or a touch-sensitive display) and one or more input devices (e.g., a camera, a depth sensor, a microphone, an electronic stylus, an electronic pencil, a hardware input mechanism, a rotatable input mechanism, a heart monitor, a temperature sensor, and/or a touch-sensitive surface). In some embodiments, the computer system is a watch, a phone, a tablet, a fitness tracking device, a processor, a head-mounted display (HMD) device, a communal device, a media device, a speaker, a television, and/or a personal computing device.

While (e.g., after) displaying, via the display generation component, first content (e.g., 602, 604, 606, 634, 702, 704, 712, 802, 804, 806, 808, 810, 812, and/or 818) (e.g., an image, a video, text, a text box, a shape, a line, computer-generated content, and/or user inputted content, such as handwritten or typed content), the computer system detects (1002), via the one or more input devices, a first input (e.g., 705a and/or 705b) (e.g., a tap input, an hold-drag-and-release input that surrounds a portion of the first content (e.g., the portion of the first content described below), and/or a non-tap input (e.g., a verbal input, an audible request, an audible command, an audible statement, a swipe input, a hold-and-drag input, a gaze input, an air gesture, mouse movement, and/or a mouse click)) corresponding to a portion (e.g., as described above with respect to FIG. 7A-7B) of the first content.

In response to detecting the first input corresponding to the portion of the first content (e.g., 704) (and/or while displaying at least another portion of the first content different from the portion of the first content), the computer system displays (1004), via the display generation component: (1006) a representation (e.g., 706) (e.g., a copy, a smaller version, a larger version, a subset, a summary, an image, and/or a video) of (and/or corresponding to) the portion of the first content (e.g., 704); and an (1008) input mechanism (e.g., 620) (e.g., as described above with respect to FIG. 7B-7C) (e.g., a keyboard, a button to display a keyboard, a text-insertion indication, a text box, a button to initiate a microphone, and/or an indication that a microphone is active) (e.g., a user interface element corresponding to an input mechanism).

The computer system detects (1010), via the one or more input devices, a set of one or more inputs (e.g., 705d1, 705d2, 705e, 705f1, 705f2, 705g, 705h, and/or 705i) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (and/or while displaying at least another portion of the first content different from the portion of the first content), wherein a second input (e.g., 705d1, 705d2, 705e, 705f1, 705f2, 705g, 705h, and/or 705i) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) of the set of one or more inputs is detected while displaying the representation of the portion of the first content (and/or while displaying the input mechanism) (e.g., as described above with respect to FIGS. 7C-7I). In some embodiments, another input (e.g., different from the second input) of the set of one or more inputs is detected while no longer displaying the representation and/or the input mechanism. In some embodiments, another input (e.g., different from the second input) of the set of one or more inputs is directed to a user interface element to generate additional content.

In response to detecting the set of one or more inputs (and/or while displaying at least another portion of the first content different from the portion of the first content), the computer system displays (1012), via the display generation component, second content (e.g., automatically-generated visual content and or generative visual content) (e.g., 712 and/or 718) (e.g., media, generated content, an image, a video, and/or text) corresponding to (and/or generated (e.g., using an AI process or a generative AI process) based on) the representation (e.g., 706) of the portion of the first content (and/or corresponding to the first content), wherein the second content is different from the first content (e.g., 702 and/or 704) (e.g., as described above with respect to FIGS. 7D-7J). Displaying the representation of a portion of the first content and the input mechanism in response to detecting the first input corresponding to a portion of the content allows the computer system to automatically prompt a user to describe the portion of the first content, thereby providing improved visual feedback and/or reducing the number of inputs needed to perform an operation. Displaying the second content corresponding to the representation of a portion of the first content allows the computer system to display new content based on inputs received and other content being displayed, thereby, providing improved visual feedback and/or performing an operation when a set of conditions has been met without requiring further user input.

In some embodiments, the second content (e.g., 712 and/or 718) is a generated image (e.g., automatically-generated visual content and or generative visual content) (e.g., as described above with respect to FIGS. 7D-7J) (e.g., text, animation, and/or video). In some embodiments, the second content is generated content. In some embodiments, the second content is generated (e.g., using an AI process or a generative AI process) (e.g., by the computer system and/or another computer system different from the computer system) based on the second indication in response to detecting the first input corresponding to the first location, in response to detecting the set of one or more inputs, and/or in response to detecting an input of the set of one or more inputs. The second content being generated image allows the computer system to use provided content to easily create new media that is relevant to the first content, thereby reducing the number of inputs needed to perform an operation.

In some embodiments, the portion of the first content (e.g., 704) includes a first set of one or more visual characteristics (e.g., a size, a color, a shape, and/or a texture). In some embodiments, the representation (e.g., 706) of the first content includes a second set of one or more visual characteristics (e.g., a size, a color, a shape, and/or a texture) different from the first set of one or more visual characteristics (e.g., as described above with respect to FIGS. 7D-7J). In some embodiments, the representation of the portion of the first content includes a shrunken version of the portion of the first content. In some embodiments, the representation of the portion of the first content includes a larger version of the portion of the first content. The portion of the first content including a first set of visual characteristics and the representation of the first content including a second set of visual characteristic allows the computer system to modify the display of the portion of the first content in a manner that is more visually appealing to the user and/or more efficient from a screen usage perspective to make room for the input mechanism, thereby providing improved visual feedback and/or performing an operation when a set of conditions has been met without requiring further user input.

In some embodiments, in response to detecting the first input (e.g., 705b) corresponding to the portion of the first content (e.g., 704) (and/or while displaying at least another portion of the first content different from the portion of the first content), the computer system displays, via the display generation component, a first indication of (and/or corresponding to) the first input (e.g., 612) (e.g., as described above with respect to FIGS. 7B-7D) (e.g., a text-insertion indication and/or a bounding area where content will be placed). In some embodiments, a size of the first indication corresponds to (and/or is the same as) a size of the first input, such as an area within the first input. In some embodiments, the first indication is displayed at the location of the first input. Displaying the first indication of the first input in response to detecting the first input allows the computer system to provide the user with an indication to show that the computer system has transitioned to a generative state and/or where generated content is to be placed, thereby providing improved visual feedback to the user and/or performing an operation when a set of conditions has been met without requiring further user input.

In some embodiments, the representation (e.g., 706) of the portion of the first content overlaps (e.g., visually overlaps) a portion (e.g., an area, an edge, and/or a boundary) of the first indication of the input (e.g., as described above with respect to FIG. 7C) (e.g., without overlapping the input mechanism). In some embodiments, a portion of the representation of the portion of the first content is overlaid on top of a portion of the first indication. The representation of the portion of the first content overlapping a portion of the first indication allows the computer system to visually group the first indication and the second indication as part of an operation being performed, thereby providing improved visually feedback to the user.

In some embodiments, the first input (e.g., 706a and/or 705b) corresponds to (and/or is) a respective area (e.g., area of input as described above at with respect to FIG. 7A-7B) (e.g., location and/or size). In some embodiments, an area within the first input is the respective area. In some embodiments, the first input defines a size and/or a location for the second content to be the respective area. In some embodiments, a left-most, a top-most, a right-most, and/or a bottom-most portion of the first input defines the respective area. In some embodiments, in accordance with a determination that the respective area is a first area, the second content is displayed based on (e.g., with, having, and/or at) the first area (e.g., when displayed in response to detecting the set of one or more inputs) (e.g., as described above with respect to FIG. 7J). In some embodiments, in accordance with the determination that the respective area is the first area, the first indication is displayed based on (e.g., with, having, and/or at) the first area. In some embodiments, in accordance with a determination that the respective area is a second area different from the first area, the second content is displayed based on (e.g., with, having, and/or at) the second area (e.g., as described above with respect to FIG. 7J) (e.g., when displayed in response to detecting the set of one or more inputs) (e.g., and not the first area). In some embodiments, in accordance with the determination that the respective area is the first area, the first indication is a size and/or displayed a location of the second area (e.g., and not the first area). In some embodiments, in response to detecting the first input and in accordance with the determination that the respective area is the first area, the computer system displays, via the display generation component, the first indication of (and/or corresponding to) the first input based on the first area. In some embodiments, in response to detecting the first input and in accordance with the determination that the respective area is the second area, the computer system displays, via the display generation component, the first indication of (and/or corresponding to) the first input based on the second size. In some embodiments, a size and/or a location of the first indication corresponds to (and/or is the same as) a size and/or a location of the first input, such as an area of the first input. In some embodiments, in response to detecting the set of one or more inputs and in accordance with the determination that the respective area is the first area, the computer system displays, via the display generation component, the second content corresponding to the representation of the portion of the first content (and/or corresponding to the first content) based on the first area. In some embodiments, in response to detecting the set of one or more inputs and in accordance with the determination that the respective area is the second area, the computer system displays, via the display generation component, the second content corresponding to the representation of the portion of the first content (and/or corresponding to the first content) based on the second area. In some embodiments, the first input corresponding to the portion of the first content defines one or more characteristics (e.g., one or more visual characteristics) (and/or an area) (e.g., location and/or size) of (and/or for) the second content (e.g., to be placed). In some embodiments, the second content is display with the one or more characteristics in response to detecting the set of one or more inputs based on the first input defining the set one or more characteristics of the second content. Displaying the second content in and/or having a different area depending on an initial input allows the computer system to automatically identify a location and/or size for the second content, thereby, reducing the number inputs needed to perform an operation, performing an operation when a set of conditions has been met without requiring further user input and/or providing improved visual feedback to the user.

In some embodiments, the first input (e.g., 705b) corresponding to the portion of first content surrounds (e.g., partially and/or fully circles and/or surrounds) the portion of the first content (e.g., 704) (e.g., as described above with respect to FIG. 7J). In some embodiments, the representation of the portion of the first content is all content surrounded by the first input (e.g., corresponding to the first input). In some embodiments, the first input corresponding to the portion of the first content encircles the portion of the first content. In some embodiments, in response to detecting the first input corresponding to the portion of the first content (and/or while displaying at least another portion of the first content different from the portion of the first content) and in accordance with a determination that the first input corresponding to the portion of the first input encircles the first portion of the first content, the computer system displays, via the display generation component, the representation of the first portion of the first content. In some embodiments, in response to detecting an input (and/or while displaying at least another portion of the first content different from the portion of the first content) and in accordance with a determination that the input does not encircle the first portion of the first content, the computer system forgoes display of the representation of the first portion of the first content (e.g., and performs a different operation and/or displays an indication of the input). The first input surrounding the portion of the first content allows a user to identify which content to be used for generating (e.g., using an AI process or a generative AI process) other content, thereby reducing the number inputs needed to perform an operation and/or providing improved visual feedback to the user.

In some embodiments, the portion of the first content (e.g., 704) includes handwritten content (e.g., detected via the one or more input devices and/or received by the computer system from another computer system different from the computer system). In some embodiments, the representation (e.g., 706) of the portion of the first content includes a representation (e.g., typed text (e.g., that is a transcription of the handwritten content), a larger reproduction, and/or a smaller reproduction) of the handwritten content (e.g., as described above with respect to FIGS. 7B-7C). The portion of the first content including handwritten content and the representation of the portion of the first content including a representation of the handwritten content allows the computer system to be able to transcribe handwritten content to text indication and/or a representation of the handwritten content, thereby providing improved visual feedback to the user and/or performing an operation when a set of conditions has been met without requiring further user input.

In some embodiments, the portion of the first content (e.g., 704) includes typed content (e.g., detected via the one or more input devices and/or received by the computer system from another computer system different from the computer system). In some embodiments, the representation (e.g., 706) of the portion of the first content includes a representation (e.g., the typed content itself, the typed content in a different color, font, and/or size, a larger reproduction, and/or a smaller reproduction) of the typed content (e.g., as described above with respect to FIGS. 7B-7C). The portion of the first content including typed content and the representation of the portion of the first content including a representation of the typed content allows the computer system to be able to transcribe typed content to a text indication and/or a representation of the typed content, thereby providing improved visual feedback to the user and/or performing an operation when a set of conditions has been met without requiring further user input.

In some embodiments, the input mechanism (e.g., 620) is a virtual keyboard (e.g., as described above with respect to FIGS. 7C-7D and 7F). In some embodiments, the virtual keyboard includes a prompt to define the representation of the first portion of the content.

In some embodiments, the set of one or more inputs is a first set of one or more inputs. In some embodiments, while displaying the input mechanism (e.g., 620), the computer system detects, via the one or more input devices, a second set of one or more inputs corresponding to a first set of one or more words (e.g., 705d1-2) (e.g., as described above with respect to FIGS. 7C-7D). In some embodiments, the first set of one or more inputs includes the second set of one or more inputs. In some embodiments, the second set of one or more inputs is different and/or separate from the first set of one or more inputs. In some embodiments, in response to detecting the second set of one or more inputs (and/or while displaying at least another portion of the first content different from the portion of the first content), the computer system displays, via the display generation component, the first set of one or more words (e.g., 710) with (e.g., in close proximity, next to, overlapping, and/or within) the representation (e.g., 706) of the portion of the first content (e.g., as described above with respect to FIGS. 7D-7E). Displaying the first set of one or more words with the representation of the first portion of the first content in response to detecting the second set of one or more inputs corresponding to the one or more words allows the computer system to indicate that the one or more inputs has been detected and allows the computer system to use one or more words when generating new content, thereby reducing the number inputs needed to perform an operation and/or providing improved visual feedback to the user.

In some embodiments, while (e.g., after) displaying the first set of one or more words (e.g., 710) (and/or while displaying at least another portion of the first content different from the portion of the first content), the computer system detects, via the one or more input devices, a third set of one or more inputs (e.g., 705e, 705f1, and/or 705f2) corresponding to a second set of one or more words, wherein the third set of one or more inputs are separate from the second set of one or more inputs (e.g., as described above with respect to FIGS. 7E-7F). In some embodiments, in response to detecting the third set of one or more inputs (and/or while displaying at least another portion of the first content different from the portion of the first content) (and/or while displaying the representation of the first portion of the content), the computer system displays, via the display generation component, the second set of one or more words (e.g., 716) at a location different (and/or away) from (e.g., not with) the representation of the portion of the content first content (e.g., 706) (e.g., as described above with respect to FIGS. 7F-7G) (e.g., while displaying the first set of one or more words) (e.g., at least partially overlapping the first indication). In some embodiments, while displaying the second set of words at the location different from the representation of the first content, the computer system displays, via the display generation component, content (e.g., automatically generated visual content and or generative visual content) corresponding to (e.g., generated (e.g., using an AI process or a generative AI process) based on) the second set of one or more words, the first set of one or more words, and/or the representation of the first portion of the content. Displaying the first set of one or more words with the representation of the first portion of the first content at a different location than the first set of one or more words in response to detecting the second set of one or more inputs corresponding to the one or more words allows the computer system to indicate that the one or more inputs has been detected and allows the computer system to use one or more words when generating new content, thereby, reducing the number inputs needed to perform an operation and/or providing improved visual feedback to the user.

In some embodiments, the second content (e.g., automatically generated visual content and or generative visual content) (e.g., 712) corresponds to (and/or is generated (e.g., using an AI process or a generative AI process) based on) the representation (e.g., 706) of the portion of the first content (and/or corresponding to the first content) and the first set of one or more word (e.g., 716) (e.g., as described above with respect to FIGS. 7G-7H) (and/or the second set of one or more words). The second content corresponding to the representation of the portion of the first content and the sets of one or more words allows the computer system to include the representation and the sets of the one or more words as defining characteristics when generating content, thereby reducing the number inputs needed to perform an operation, performing an operation when a set of conditions has been met without requiring further user input, and/or providing improved visual feedback to the user.

In some embodiments, while displaying the second content (e.g., 712 or 718) (and/or while displaying at least another portion of the first content different from the portion of the first content), the computer system detects, via the one or more input devices, a second input (e.g., 705g and/or 705h) (e.g., as described above with respect to FIGS. 7G-7H) (e.g., a swipe input and/or a non-swipe input (e.g., a verbal input, an audible request, an audible command, an audible statement, a tap input, a hold-and-drag input, a gaze input, an air gesture, mouse movement, and/or a mouse click)). In some embodiments, the second input corresponds to a request to generate (e.g., using an AI process or a generative AI process) new content. In some embodiments, in response to detecting the second input, the computer system displays, via the display generation component, a set of one or more words at a location different from the representation of the first content while displaying the third content. In some embodiments, in response to detecting the second input, the computer system displays, via the display generation component, third content (e.g., automatically generated visual content and/or generative visual content) (e.g., 712 or 718) corresponding to (and/or generated (e.g., using an AI process or a generative AI process) based on) the representation (e.g., 706) of the portion of the first content (and/or corresponding to the first content), wherein the third content is different from the first content and the second content (e.g., as described above with respect to FIGS. 7H-7I). Displaying the third content in response to detecting the second input allows the computer system to generate more content after detecting a request from the user to change and/or modify the content, thereby providing improved visual feedback and/or performing an operation when a set of conditions has been met without requiring further user input.

In some embodiments, the second content (e.g., 712 at FIG. 7J) is displayed at a first size in response to detecting the set of one or more inputs. In some embodiments, while displaying the second content at the first size (e.g., after detecting the set of one or more inputs) (e.g., without displaying the representation of the portion of the first content and/or the input mechanism) (and/or while displaying at least another portion of the first content different from the portion of the first content), the computer system detects, via the one or more input devices, a third input (e.g., to resize) (e.g., a hold-and-drag input and/or a non-hold-and-drag input (e.g., a tap input, a verbal input, an audible request, an audible command, an audible statement, a swipe input, a gaze input, an air gesture, mouse movement, and/or a mouse click)) (e.g., different from the first input) (e.g., as described above with respect to FIG. 7J). In some embodiments, in response to detecting the third input (and/or while displaying at least another portion of the first content different from the portion of the first content), the computer system displays, via the display generation component, the second content at a second size (e.g., bigger and/or smaller size) different from the first size (e.g., as described above with respect to FIG. 7J). Displaying the second content at a second size in response to an input, allows the computer system to edit a visual characteristic of the second content after detecting a user request, thereby providing improved visual feedback and/or performing an operation when a set of conditions has been met without requiring further user input.

In some embodiments, the second content (e.g., 712 and/or 718) (and/or a representation of the second content) is displayed concurrently with the representation (e.g., 706) of the portion of the first content (e.g., as described above with respect to FIGS. 7E-7I). In some embodiments, the second content (and/or a representation of the second content) is not displayed with the representation of the portion of the first content.

In some embodiments, while (e.g., after) displaying the second content (e.g., 712) and the representation (e.g., 706) of the portion of the first content (and/or the input mechanism and/or a representation of the second content), the computer system detects, via the one or more input devices, a fourth input (e.g., 705i) (e.g., as described above with respect to FIG. 7I) (e.g., to generate (e.g., using an AI process or a generative AI process) and/or finalize content) (e.g., a tap input and/or a non-tap input (e.g., a verbal input, an audible request, an audible command, an audible statement, a gaze input, an air gesture, and/or a mouse click)). In some embodiments, in response to detecting the fourth input (e.g., 705i) (and/or while displaying at least another portion of the first content different from the portion of the first content), the computer system displays, via the display generation component, the second content (e.g., 712) without the representation (e.g., 706) of the portion of the first content (e.g., as described above with respect to FIGS. 7I-7J). In some embodiments, in response to detecting the fourth input and/or in conjunction with displaying the second content without the representation of the portion of the first content, the computer system displays, via the display generation component, a set of one or more controls (e.g., that were not displayed before detecting the fourth input and/or while displaying the representation of the portion of the first content and/or the input mechanism). Displaying the second content without displaying the representation of the portion of the first content allows the computer system to transition out of a generative state and display the second content as a generated image (e.g., automatically generated visual content and/or generative visual content), thereby performing an operation when a set of conditions has been met and/or providing improved visual feedback to the user.

In some embodiments, while displaying the first content (e.g., 702 and/or 704) and in response to detecting an input (e.g., 705b) corresponding to the portion of the first content (e.g., 704) while a respective tool (e.g., 610a or 610d) is being used (and/or is selected) (e.g., as described above with respect to FIGS. 7A-7B), in accordance with a determination that the respective tool is a first tool (610a) (e.g., generation tool), the computer system displays, via the display generation component, the representation (e.g., 706) of the portion of the first content and the input mechanism (e.g., 620) (e.g., as described above with respect to FIGS. 7A-7C). In some embodiments, while displaying the first content and in response to detecting an input corresponding to the portion of the first content while the respective tool is being used, in accordance with a determination that the respective tool is a second tool (e.g., 610d) (e.g., pencil tool, pen tool, and/or eraser tool) different from the first tool, the computer system performs an operation (e.g., displays, via, the display generation component, a line along a path of the tenth input) without displaying the representation (e.g., 706) of the portion of the first content and the input mechanism (e.g., 620) (e.g., as described above with respect to FIGS. 7A-7C). Selectively displaying the representation of the portion of the first content based on which tool is being used allows the computer system to only move into a generative state when a tool for generating (e.g., using an AI process or a generative AI process) content is used, thereby performing an operation when a set of conditions has been met, providing additional control options without cluttering the user interface with additional displayed controls, and/or providing improved visual feedback to the user.

In some embodiments, in response to detecting the first input (e.g., 705b) corresponding to the portion of the first content, the computer system ceases display of, via the display generation component, the portion of the first content (e.g., 704) (e.g., as described above with respect to FIGS. 7B-7C). In some embodiments, in response to detecting the first input corresponding to the portion of the first content and/or while displaying the representation of the portion of the first content, the computer system ceases display of the portion of the first content and displays an indication of the first input (e.g., bounding area). Ceasing display of the portion of the first content in response to detecting the first input allows the computer system to provide more space for generating (e.g., using an AI process or a generative AI process) new content and/or the input mechanism as well as provide a user with an indication of the area new content will go, thereby providing improved visual feedback and/or performing an operation when a set of conditions has been met without requiring further user input.

In some embodiments, before detecting the first input (e.g., 705b) corresponding to the portion of the first content (e.g., 704), the computer system detects, via the one or more input devices, a fifth input (705a) corresponding to an area (e.g., 720) (e.g., on the user interface), wherein the second content is displayed in the area (e.g., as described above with respect to FIGS. 7A-7B and FIG. 7J) (e.g., in response to detecting the set of one or more inputs (and/or while displaying at least another portion of the first content different from the portion of the first content)) (e.g., in conjunction with ceasing display of the representation of the portion of the first content and/or the input mechanism). In some embodiments, the area does not include the portion of the first content. Detecting the fifth input corresponding to an area, wherein the second content is displayed in the area, before detecting the first input allows the computer system to add a location condition when displaying generated media, thereby performing an operation when a set of conditions has been met without requiring further user input and/or providing improved visual feedback to the user.

Note that details of the processes described above with respect to method 1000 (e.g., FIG. 10) are also applicable in an analogous manner to other methods described herein. For example, method 1100 optionally includes one or more of the characteristics of the various methods described above with reference to method 1000. For example, the representation of method 1000 can be the representation of method 1100. For brevity, these details are not repeated herein.

FIG. 11 is a flow diagram illustrating a method (e.g., method 1100) for generating (e.g., using an AI process or a generative AI process) and/or interacting with content based on displayed text in accordance with some embodiments. Some operations in method 1100 are, optionally, combined, the orders of some operations are, optionally, changed, and some operations are, optionally, omitted.

As described below, method 1100 provides an intuitive way for generating and/or interacting with content based on displayed text. Method 1100 reduces the cognitive burden on a user, thereby creating a more efficient human-machine interface. For battery-operated computing devices, enabling a user to interact with such devices faster and more efficiently conserves power and increases the time between battery charges.

In some embodiments, method 1100 is performed at a computer system (e.g., 600) that is in communication with a display generation component (e.g., a display screen, a projector, and/or a touch-sensitive display) and one or more input devices (e.g., a camera, a depth sensor, a microphone, an electronic stylus, an electronic pencil, a hardware input mechanism, a rotatable input mechanism, a heart monitor, a temperature sensor, and/or a touch-sensitive surface). In some embodiments, the computer system is a watch, a phone, a tablet, a fitness tracking device, a processor, a head-mounted display (HMD) device, a communal device, a media device, a speaker, a television, and/or a personal computing device.

While (e.g., after) displaying, via the display generation component, first content (e.g., 602, 604, 606, 634, 702, 704, 712, 802, 804, 806, 808, 810, 812, and/or 818) (e.g., an image, a video, text, a text box, a shape, a line, computer-generated content, and/or user inputted content, such as handwritten or typed content), the computer system detects (1102), via the one or more input devices, a first input (e.g., 805b) (e.g., a tap input, an hold-drag-and-release input that surrounds a portion of the first content (e.g., the portion of the first content described below), and/or a non-tap input (e.g., a verbal input, an audible request, an audible command, an audible statement, a swipe input, a hold-and-drag input, a gaze input, an air gesture, mouse movement, and/or a mouse click)) corresponding to a first portion (e.g., 804, 806, 808, 810 and/or 812) of the first content (e.g., as described above with respect to FIG. 8B).

In response to detecting the first input corresponding to the first portion of the first content (and/or while displaying at least another portion of the first content different from the portion of the first content), the computer system displays (1104), via the display generation component: (1106) a representation (e.g., 816) (e.g., a copy, a smaller version, a larger version, a subset, a summary, an image, and/or a video) of (and/or corresponding to) the first portion of the first content (e.g., as described above with respect to FIG. 8C); and an (1108) indication (e.g., 814a-f) (e.g., text and/or image) corresponding to (and/or of) a second portion (e.g., 802, 804, 806, 808, 810 and/or 812) (e.g., the first portion and/or another portion different from the first portion) of the first content, wherein the indication corresponding to the second portion of the first content is different from the representation of the first portion of the first content (e.g., as described above with respect to FIG. 8C). In some embodiments, the indication includes one or more key words from the first portion of the first content. In some embodiments, the indication includes one or more key words from content not included in the first portion of the first content.

The computer system detects (1110), via the one or more input devices, a set of one or more inputs (e.g., 805c, 805d1-2, 805e) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (and/or while displaying at least another portion of the first content different from the portion of the first content), wherein a second input (e.g., 805c, 805d1-2, 805e) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) of the set of one or more inputs is detected while displaying the indication (e.g., 814a-f) corresponding to the second portion of the first content (and/or while displaying the representation of the first portion of the first content) (e.g., as described above with respect to FIGS. 8C-8E). In some embodiments, another input (e.g., different from the second input) of the set of one or more inputs is detected while no longer displaying the representation and/or the indication. In some embodiments, another input (e.g., different from the second input) of the set of one or more inputs is directed to a user interface element to generate additional content.

In response to detecting the set of one or more inputs (and/or while displaying at least another portion of the first content different from the portion of the first content), the computer system displays (1112), via the display generation component, second content (e.g., automatically-generated visual content and/or generative visual content) (e.g., 818) (e.g., media, generated content, an image, a video, and/or text) corresponding to the indication (e.g., 814a-f) corresponding to (and/or generated (e.g., using an AI process or a generative AI process) based on) the second portion of the first content (and/or corresponding to the representation of the first portion of the first content), wherein the second content is different from the first content (e.g., 802, 804, and 808-812) (e.g., as described above with respect to FIGS. 8E-8F). Displaying the representation of the first portion of the input and the second indication corresponding to the second portion of the first content in response to detecting the first input allows the computer system to respond to an input with multiple contextual information obtained from content being displayed, thereby providing improved visual feedback and/or reducing the number of inputs need to perform an operation. Displaying the second content corresponding to the second indication corresponding to the second portion of the first content in response to detecting the set of one or more inputs allows the computer system to display new content based on inputs received and other content being displayed, thereby providing improved visual feedback and/or performing an operation when a set of conditions has been met without requiring further user input.

In some embodiments, the second content (e.g., 818) is a generated image (e.g., automatically-generated visual content and/or generative visual content) (e.g., as described above with respect to FIGS. 8E-8F) (e.g., text, animation, and/or video). In some embodiments, the second content is generated content. In some embodiments, the second content is generated (e.g., using an AI process or a generative AI process) (e.g., by the computer system and/or another computer system different from the computer system) based on the second indication in response to detecting the first input corresponding to the first location, in response to detecting the set of one or more inputs, and/or in response to detecting an input of the set of one or more inputs. The second content being a generated image allows the computer system to use provided content to easily create new media that is relevant to the content, thereby reducing the number of inputs needed to perform an operation.

In some embodiments, the first portion of the first content (e.g., 804, 806, 808, 810 and/or 812) includes a first set of one or more visual characteristics (e.g., a size, a color, a shape, and/or a texture). In some embodiments, the representation of the first content (e.g., 816) includes a second set of one or more visual characteristics (e.g., a size, a color, a shape, and/or a texture) different from the first set of one or more visual characteristics (e.g., as described above with respect to FIGS. 8A-8C). In some embodiments, the representation of the first portion of the first content includes a shrunken version of the first portion of the first content. In some embodiments, the representation of the portion of the first content includes a larger version of the first portion of the first content. In some embodiments, the representation of the first portion of the first content includes different visual characteristic than the portion of the first content corresponding to the first input. The representation of the first content including a second set of one or more visual characteristics and the representation of the first content including a second set of visual characteristic allows the computer system to modify the display of the first portion of the first content in a manner that is more visually appealing to the user and/or more efficient from a screen usage perspective to make room for other content, thereby providing improved visual feedback and/or performing an operation when a set of conditions has been met without requiring further user input.

In some embodiments, in response to detecting the first input (e.g., 805b) corresponding to the first portion of the first content (and/or while displaying at least another portion of the first content different from the portion of the first content), the computer system displays, via the display generation component, an indication (e.g., a text-insertion indication and/or a bounding area where content will be placed) of (and/or corresponding to) the input (e.g., 612), wherein the indication of the first input is different from the indication corresponding to the second portion of the first content (e.g., 814a-f) (e.g., as described above with respect to FIG. 8C). In some embodiments, a size of the indication of the first input corresponds to (and/or is the same as) a size of the first input, such as an area within the first input. In some embodiments, the first indication is displayed at the location of the first input. Displaying the first indication of the first input in response to detecting the first input allows the computer system to provide the user with an indication to show that the computer system has transitioned to a generative state and/or where generated content is to be placed, thereby providing improved visual feedback to the user and/or performing an operation when a set of conditions has been met without requiring further user input.

In some embodiments, the representation (e.g., 816) of the first content overlaps (e.g., visually overlaps) at least a portion (e.g., an area, an edge and/or a boundary) of the indication (e.g., 612) of the input (e.g., as described above with respect to FIG. 8C) (e.g., without overlapping the indication corresponding to the second portion of the first content). In some embodiments, the indication corresponding to the second portion of the first content overlaps at least a portion (e.g., an area, an edge and/or a boundary) of the indication of the input (e.g., without overlapping the representation of the representation of the first content). In some embodiments, a portion of the representation of the first content is overlaid on top of a portion of the indication of the input. The representation of the portion of the first content overlapping a portion of the first indication allows the computer system to visually group the first indication and the second indication as part of an operation being performed, thereby providing improved visually feedback to the user.

In some embodiments, the indication (e.g., 814a-f) corresponding to the second portion of the first content does not overlap (e.g., does not visually overlap) the representation (e.g., 816) of the first content (e.g., as described above with respect to FIG. 8C). In some embodiments, a portion of the indication corresponding to the second portion of the first content is overlaid on top of a portion of the indication of the input at a first location and the representation of the first portion of content is overlaid on top of a portion the indication of the input at a second location different from the first location.

In some embodiments, the first input (e.g., 805b) corresponds to (and/or includes) a respective area (e.g., as described above with respect to FIG. 8B) (e.g., location and/or size). In some embodiments, an area within the first input is the respective area. In some embodiments, the first input defines a size and/or a location for the second content to be the respective area. In some embodiments, a left-most, a top-most, a right-most, and/or a bottom-most portion of the first input defines the respective area. In some embodiments, in accordance with a determination that the respective area is a first area, the second content (e.g., 818) is displayed based on (e.g., with, having, and/or at) the first area (e.g., as described above with respect to FIGS. 8E-8F) (e.g., when displayed in response to detecting the set of one or more inputs). In some embodiments, in accordance with the determination that the respective area is the first area, the first indication is displayed based on (e.g., with, having, and/or at) the first area. In some embodiments, in accordance with a determination that the respective area is a second area different from the first area, the second content is displayed based on (e.g., with, having, and/or at) the second area (e.g., as described above with respect to FIGS. 8E-8F) (e.g., when displayed in response to detecting the set of one or more inputs) (e.g., and not the first area). In some embodiments, in accordance with the determination that the respective area is the first area, the second content is a size and/or displayed a location of the second area (e.g., and not the first area). In some embodiments, in response to detecting the first input and in accordance with the determination that the respective area is the first area, the computer system displays, via the display generation component, an indication of (and/or corresponding to) the first input based on the first area. In some embodiments, in response to detecting the first input and in accordance with the determination that the respective area is the second area, the computer system displays, via the display generation component, an indication of (and/or corresponding to) the first input based on the second size. In some embodiments, a size and/or a location of the second content corresponds to (and/or is the same as) a size and/or a location of the first input, such as an area of the first input. In some embodiments, in response to detecting the set of one or more inputs and in accordance with the determination that the respective area is the first area, the computer system displays, via the display generation component, the second content (e.g., automatically-generated visual content and/or generative visual content) corresponding to the representation of the portion of the first content (and/or corresponding to the first content) based on the first area. In some embodiments, in response to detecting the set of one or more inputs and in accordance with the determination that the respective area is the second area, the computer system displays, via the display generation component, the second content (e.g., automatically-generated visual content and/or generative visual content) corresponding to the representation of the portion of the first content (and/or corresponding to the first content) based on the second area. In some embodiments, the first input corresponding to the portion of the first content defines one or more characteristics (e.g., one or more visual characteristics) (and/or an area) (e.g., location and/or size) of (and/or for) the second content (e.g., to be placed). In some embodiments, the second content is display with the one or more characteristics in response to detecting the set of one or more inputs based on the first input defining the set one or more characteristics of the second content. Displaying the second content in and/or having a different area depending on an initial input allows the computer system to automatically identify a location and/or size for the second content, thereby reducing the number inputs needed to perform an operation, performing an operation when a set of conditions has been met without requiring further user input and/or providing improved visual feedback to the user.

In some embodiments, the first input (e.g., 805b) corresponding to the first content surrounds (e.g., partially and/or fully circles and/or surrounds) the first portion (e.g., 804, 806, 808, 810 and/or 812) of the first content (e.g., as described above with respect to FIG. 8B). In some embodiments, the representation of the portion of the first content is content surrounded by the first input (e.g., corresponding to the first input). In some embodiments, the first input corresponding to the portion of the first content encircles the portion of the first content. In some embodiments, in response to detecting the first input corresponding to the portion of the first content (and/or while displaying at least another portion of the first content different from the portion of the first content) and in accordance with a determination that the first input corresponding to the portion of the first input encircles the first portion of the first content, the computer system displays, via the display generation component, the representation of the first portion of the first content. In some embodiments, in response to detecting an input (and/or while displaying at least another portion of the first content different from the portion of the first content) and in accordance with a determination that the input does not encircle the first portion of the first content, the computer system forgoes display of the representation of the first portion of the first content (e.g., and performs a different operation and/or displays an indication of the input). The first input surrounding the first portion of the first content allows a user to identify which content to be used for generating other content, thereby reducing the number inputs needed to perform an operation and/or providing improved visual feedback to the user.

In some embodiments, the first content includes handwritten content (e.g., 802, 804, and/or 808-812) (e.g., detected via the one or more input devices and/or received by the computer system from another computer system different from the computer system). In some embodiments, the indication (e.g., 814a-f) corresponding to the second portion of the first content includes a representation (e.g., typed text (e.g., that is a transcription of the handwritten content), a larger reproduction, and/or a smaller reproduction) of the handwritten content (e.g., as described above with respect to FIGS. 8A-8C). In some embodiments, the representation of the first portion of the first content includes a representation of the handwritten content. The first content including handwritten content and the indication corresponding to the second portion of the second content including a representation of the handwritten content allows the computer system to be able to transcribe handwritten content to text indication and/or a representation of the handwritten content, thereby providing improved visual feedback to the user and/or performing an operation when a set of conditions has been met without requiring further user input.

In some embodiments, the first content (e.g., 802, 804, and 808-812) includes typed content (e.g., detected via the one or more input devices and/or received by the computer system from another computer system different from the computer system). In some embodiments, the indication (e.g., 814a-f) corresponding to the second portion of the first content includes a representation (e.g., the typed content itself, the typed content in a different color, font, and/or size, a larger reproduction, and/or a smaller reproduction) of the typed content (e.g., as described above with respect to FIGS. 8A-8C). In some embodiments, the representation of the first portion of the first content includes a representation of the typed content. The first content including typed content and the indication of the second portion of the second content including a representation of the handwritten content allows the computer system to be able to transcribe typed content to a text indication and/or a representation of the typed content, thereby providing improved visual feedback to the user and/or performing an operation when a set of conditions has been met without requiring further user input.

In some embodiments, the first content (e.g., 802, 804, and/or 808-812) includes handwritten text and a handwritten drawing (e.g., detected via the one or more input devices and/or received by the computer system from another computer system different from the computer system). In some embodiments, the representation (e.g., typed text (e.g., that is a transcription of the handwritten text and the handwritten drawing), a larger reproduction, and/or a smaller reproduction) of the first portion of the first content (and/or the indication corresponding to the second portion of the content) includes a representation of the handwritten text and the handwritten drawing (e.g., as described above with respect to FIGS. 8A-8C). In some embodiments, the indication corresponding to the second portion of the first content includes a representation of the handwritten text and the handwritten drawing. In some embodiments, the representation of the first portion of the first content includes a representation of the handwritten drawing but not the handwritten text. In some embodiments, the representation of the first portion of the first content includes a representation of the handwritten text but not the handwritten drawing. The first content including handwritten text and handwritten drawing and the indication of the second portion of the second content including a representation of handwritten text and handwritten drawing allows the computer system to be able to transcribe handwritten text and handwritten drawing to text indication and/or a representation of handwritten text and handwritten drawing, thereby providing improved visual feedback to the user and/or performing an operation when a set of conditions has been met without requiring further user input.

In some embodiments, the indication (e.g., 814a-f) corresponding to the second portion (e.g., 802) of the first content includes text (e.g., as described above with respect to FIG. 8C) (e.g., corresponding to the second portion of the first content) (of the first content (e.g., an image, a video, text, a text box, a shape, a line, computer-generated content, and/or user inputted content, such as handwritten or typed content)). In some embodiments, the representation of the first portion of the first content includes text.

In some embodiments, in response to detecting the first input (e.g., 805b) corresponding to the first content (e.g., 802, 804, and/or 808-812) (and/or while displaying at least another portion of the first content different from the portion of the first content), the computer system displays, via the display generation component, a user interface element (e.g., 820) (e.g., add user interface element, icon, and/or control), wherein the user interface element overlaps (e.g., visually overlaps) a portion of the representation (e.g., 816) of the first portion of the first content (e.g., as described above with respect to FIGS. 8B-8C) (e.g., without overlapping the indication corresponding to the second portion of the content). In some embodiments, the computer system detects, via the one or more input devices, a second input (e.g., 806c) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (and/or while displaying at least another portion of the first content different from the portion of the first content) corresponding to the user interface element (e.g., 820) (e.g., as described above with respect to FIG. 8C). In some embodiments, in response to detecting the second input corresponding to the user interface element (and/or while displaying at least another portion of the first content different from the portion of the first content), the computer system displays, via the display generation component, an input mechanism (e.g., 620) (e.g., as described above with respect to FIGS. 8C-8D) (e.g., a keyboard, a button to display a keyboard, a text-insertion indication, a text box, a button to initiate a microphone, and/or an indication that a microphone is active). In some embodiments, the input mechanism includes a prompt to define the representation of the first portion of the content. Displaying a user interface element in response to detecting the first input and displaying an input mechanism in response to a second input allows the computer system to respond to the first input by displaying a user interface element without the input mechanism in order to display the user interface in manner that is more visually appealing to the user and/or more efficient from a screen usage perspective and only adding the input mechanism when the user request to change the description of the representation of the first portion of the first content, thereby reducing the number inputs needed to perform an operation, providing improved visual feedback to the user, and/or performing an operation when a set of conditions has been met without requiring further user input.

In some embodiments, the set of one or more inputs is a first set of one or more inputs. In some embodiments, while displaying the input mechanism (e.g., 620) (and/or while displaying at least another portion of the first content different from the portion of the first content), the computer system detects, via the one or more input devices, a second set of one or more inputs (e.g., 805d1-2) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (e.g., including typed text, handwritten text, and/or a voice input) (e.g., corresponding to selection of another user interface element, such as an enter or submit button) (e.g., different from the first input) corresponding to a first set of one or more words (e.g., as described above with respect to FIG. 8D). In some embodiments, the first set of one or more inputs includes the second set of one or more inputs. In some embodiments, in response to detecting the second set of one or more inputs, the computer system replaces (e.g., changes and/or modifies) the user interface element (e.g., 820) with the first set of one or more words (e.g., as described above with respect to FIGS. 8D-8E). In some embodiments, the display of the first set one or more words overlaps the representation of the portion of the first content. In some embodiments, in response to detecting the second set of one or more inputs, the computer system ceases display of the user interface element (e.g., at a first location) and displays the first set of one or more words (e.g., at the first location). Displaying the first set of one or more words with the representation of the first portion of the first content in response to detecting the second set of one or more inputs corresponding to the one or more words allows the computer system to indicate that the one or more inputs has been detected and allows the computer system to use one or more words when generating new content, thereby reducing the number inputs needed to perform an operation and/or providing improved visual feedback to the user.

In some embodiments, in response to detecting the first input (e.g., 805b) corresponding to the first portion (e.g., 804, 806, 808, 810 and/or 812) of the first content (and/or while displaying at least another portion of the first content different from the portion of the first content), the computer system displays, via the display generation component, an indication corresponding to (e.g., from, associated with, and/or based on) to third content different from the first content and the second content, wherein the indication corresponding to the third content is different from the representation (e.g., 816) of the first portion of the first content and the indication (e.g., 814a-f) corresponding to the second portion of the first content (e.g., as described above with respect to FIG. 8C). Displaying an indication corresponding to a third content allows the computer system to include content relevant to the first content and/or the second content, thereby performing an operation when a set of conditions has been met without requiring further user input, and/or providing improved visual feedback to the user.

In some embodiments, the second content (e.g., 818) (and/or a representation of the second content) is displayed concurrently with the indication (e.g., 814a-f). corresponding to the second portion of the first content (e.g., as described above with respect to FIG. 8E). In some embodiments, the second content (and/or a representation of the second content) is not displayed with the first representation.

In some embodiments, while (e.g., after) displaying the second content (e.g., 818) and the indication corresponding to the second portion of the first content (e.g., 814a-f), the computer system detects, via the one or more input devices, a third input (e.g., 805e) (e.g., as described above with respect to FIG. 8E) (e.g., done) (e.g., a tap input and/or a non-tap input (e.g., a verbal input, an audible request, an audible command, an audible statement, a gaze input, an air gesture, and/or a mouse click)). In some embodiments, in response to detecting the third input, the computer system displays, via the display generation component, the second content (e.g., automatically-generated visual content and/or generative visual content) without the representation (e.g., 816) of the portion of the first content and the indication corresponding to the second portion the first content (e.g., 814a-f) (e.g., as described above with respect to FIG. 8F). In some embodiments, in response to detecting the third input and/or in conjunction with displaying the second content without the representation of the portion of the first content and the indication corresponding to the second portion the first content, the computer system displays, via the display generation component, a set of one or more controls. In some embodiments, the second content without the representation of the portion of the first content is at the first size corresponding to the first indication.

In some embodiments, in response to detecting the first input (e.g., 805b) corresponding to the first portion of the first content (and/or while displaying at least another portion of the first content different from the portion of the first content), the computer system ceases display of, via the display generation component, the first portion (e.g., 804, 806, 808, 810 and/or 812) of the first content (e.g., as described above with respect to FIGS. 8B-8C and FIG. 8F). In some embodiments, while displaying the representation of the portion of the first content, the computer system ceases display of the first portion of the first content corresponding to the input and displays the representation of the first portion of the input and the indication corresponding to the second portion of the first content. Displaying the second content without displaying the representation and the indication allows the computer system to transition out of a generative state and display the second content as a generated image, thereby performing an operation when a set of conditions has been met and/or providing improved visual feedback to the user.

Note that details of the processes described above with respect to method 1100 (e.g., FIG. 11) are also applicable in an analogous manner to other methods described herein. For example, method 900 optionally includes one or more of the characteristics of the various methods described above with reference to method 1100. For example, the indication of method 1100 can be the second indication of method 900. For brevity, these details are not repeated herein.

FIG. 12 is a flow diagram illustrating a method (e.g., method 1200) for generating (e.g., using an AI process or a generative AI process) content in a generative state in accordance with some embodiments. Some operations in method 1200 are, optionally, combined, the orders of some operations are, optionally, changed, and some operations are, optionally, omitted.

As described below, method 1200 provides an intuitive way for generating content in a generative state. Method 1200 reduces the cognitive burden on a user, thereby creating a more efficient human-machine interface. For battery-operated computing devices, enabling a user to interact with such devices faster and more efficiently conserves power and increases the time between battery charges.

In some embodiments, method 1200 is performed at a computer system (e.g., 600) that is in communication with a display generation component (e.g., a display screen, a projector, and/or a touch-sensitive display) and one or more input devices (e.g., a camera, a depth sensor, a microphone, an electronic stylus, an electronic pencil, a hardware input mechanism, a rotatable input mechanism, a heart monitor, a temperature sensor, and/or a touch-sensitive surface). In some embodiments, the computer system is a watch, a phone, a tablet, a fitness tracking device, a processor, a head-mounted display (HMD) device, a communal device, a media device, a speaker, a television, and/or a personal computing device.

While (e.g., after) displaying, via the display generation component, a first indication (e.g., 614a-f as described above with respect to FIG. 6C) (e.g., 706 and/or 716 as described above with respect to FIGS. 7C-7G) (e.g., 814a-f and/or 816 as described above with respect to FIG. 8C) (e.g., text and/or image) corresponding to (and/or of) first content (e.g., 604 and/or 606 as described above with respect to FIG. 6A) (e.g., 802, 804, and 808-812 as described above with respect to FIG. 8A) (e.g., 702 and/or 704 as described above with respect to 7A) (e.g., an image, a video, text, a text box, a shape, a line, computer-generated content, and/or user inputted content, such as handwritten or typed content) (and/or while displaying the first content), the computer system detects (1202), via the one or more input devices, a first input (e.g., a tap input, an hold-drag-and-release input that surrounds a portion of the first content (e.g., the portion of the first content described below), and/or a non-tap input (e.g., a verbal input, an audible request, an audible command, an audible statement, a swipe input, a hold-and-drag input, a gaze input, an air gesture, mouse movement, and/or a mouse click)) (e.g., 605b, 605f2, 605h, 605j, 605k, 605l, 705d2, 705f2, 705g, 705h, 705i, 805b, 805d2, and/or 805e) corresponding to a request to generate (and/or obtain and/or display) (e.g., using an AI process or a generative AI process) content (e.g., new content, additional content, automatically-generated visual content and/or generative visual content). In some embodiments, the first indication includes a representation of the portion of the first content (e.g., a smaller or larger version of the portion of the first content). In some embodiments, the first indication includes the portion of the first content. In some embodiments, the first indication is a representation (e.g., a copy, a smaller version, a larger version, a subset, a summary, an image, and/or a video) of (and/or corresponding to) the portion of the first content.

In response to detecting the first input corresponding to the request to generate (e.g., using an AI process or a generative AI process) content (and/or while displaying the first content), the computer system displays (1204), via the display generation component, second content (e.g., automatically-generated visual content and/or generative visual content) (e.g., 618 as described above with respect to FIG. 6D and/or FIGS. 6I-6J) (e.g., 712 as described with respect to FIGS. 7F-7G) (e.g., media, generated content, an image, a video, and/or text) corresponding to the first indication (and/or corresponding to the first content) while maintaining display of the first indication corresponding to the first content, wherein the second content is different from the first content.

While (and/or after) displaying the second content (e.g., automatically-generated visual content and/or generative visual content) corresponding to the first indication and the first indication corresponding to the first content (and/or while displaying the first content), the computer system detects (1206), via the one or more input devices, a second input (e.g., 605k, 705g, and/or 705h) (e.g., a swipe input and/or a non-swipe input (e.g., a verbal input, an audible request, an audible command, an audible statement, a tap input, a hold-and-drag input, a gaze input, an air gesture, mouse movement, and/or a mouse click)) (e.g., to change the second content).

In response to detecting the second input (and/or while displaying the first content), the computer system displays (1208), via the display generation component, third content (e.g., automatically-generated visual content and/or generative visual content) (e.g., 634 or 718) (e.g., media, generated content, an image, a video, and/or text) corresponding to the first indication (and/or corresponding to the first content) while maintaining display of the first indication corresponding to the first content without displaying the second content, wherein the third content is different from the first content and the second content.

While (and/or after) displaying the third content (e.g., automatically-generated visual content and/or generative visual content) and the first indication (and/or while displaying the first content), the computer system detects (1210), via the one or more input devices, a third input (e.g., 605l, 705i, and/or 805e) (e.g., a tap input and/or a non-tap input (e.g., a verbal input, an audible request, an audible command, an audible statement, a swipe input, a hold-and-drag input, a gaze input, an air gesture, mouse movement, and/or a mouse click)).

In response to (1212) detecting the third input (and/or while displaying the first content), the computer system maintains (1214) display of, via the display generation component, the third content (e.g., automatically-generated visual content and/or generative visual content).

In response to (1212) detecting the third input, the computer system ceases (1216) display of, via the display generation component, the first indication (e.g., as described above with respect to FIGS. 6L-6M, FIGS. 7I-7J, and/or FIGS. 8E-8F). Displaying the second content in response to the first input corresponding to the request to generate content allows the computer system to generate second content after a user or computer system adds the first indication of the first content, which acts as a descriptor for the generated content, thereby providing improved visual feedback and/or performing an operation when a set of conditions has been met without requiring further user input. Displaying the third content in response to the second input allows the computer system to display more content after detecting a request from the user to change and/or modify the content, thereby providing improved visual feedback and/or performing an operation when a set of conditions has been met without requiring further user input. Displaying the third content while ceasing display of the first indication of the first content allows the computer system to exit a generative state and inform the user that the third content is now movable content, thereby providing improved visual feedback and/or performing an operation when a set of conditions has been met without requiring further user input.

In some embodiments, the first indication (e.g., 614a-f as described above with respect to FIG. 6C) (e.g., 706 and/or 716 as described above with respect to FIGS. 7C-7G) (e.g., 814a-f and/or 816 as described above with respect to FIG. 8C) includes text (e.g., corresponding to a portion of the content (e.g., an image, a video, text, a text box, a shape, a line, computer-generated content, and/or user inputted content, such as handwritten or typed content)).

In some embodiments, the second content (e.g., 618 as described above with respect to FIG. 6D and/or FIGS. 6I-6J) (e.g., 712 as described above with respect to FIGS. 7F-7G) is a first generated image (e.g., automatically-generated visual content and/or generative visual content). In some embodiments, the third content (e.g., 634 or 718) is a second generated image different from the first generated image (e.g., as described above with respect to FIGS. 6K-6L or FIGS. 7G-7I) (e.g., automatically-generated visual content and/or generative visual content). In some embodiments, the second content and/or the third content is an animation. In some embodiments, the second content and/or the third content is text. In some embodiments, the second content and/or the third content is video. In some embodiments, the second content and/or the third content is generated (e.g., using an AI process or a generative AI process) (e.g., by the computer system and/or another computer system different from the computer system) based on the first indication in response to, before, and/or after detecting the first input and/or the second input. The second content and the third content being generated images allows the computer system to use provided content to easily create new content that is relevant to the first content, thereby reducing the number of inputs need to perform an operation.

In some embodiments, while displaying the first indication, the computer system displays, via the display generation component, a first user interface element (e.g., 616a) (e.g., a remove user interface element, icon and/or control) in conjunction with (e.g., adjacent to, in proximity to, on top of, within, and/or as part of) the first indication (e.g., as described above with respect to FIGS. 6C, 7C and 8C). In some embodiments, while displaying the first user interface element (e.g., 616a) and the first indication (and/or the first content), the computer system detects, via the one or more input devices, a fourth input corresponding to the first user interface element (e.g., as described above with respect to FIGS. 6C, 7C and/or 8C). In some embodiments, in response to detecting the fourth input corresponding to the first user interface element, the computer system ceases display of the first indication (e.g., as described above with respect to FIGS. 6C, 7C and/or 8C) (and/or the first user interface element). Ceasing display of the first indication in response to detecting a input corresponding to the first user interface element displayed allows the computer system to automatically remove an indication in response to an input on a control, thereby reducing the number of inputs needed to perform an operation, providing additional control options without cluttering the user interface with additional displayed controls, and/or providing improved visual feedback to the user.

In some embodiments, while displaying the first indication of the first content, the computer system detects, via the one or more input devices, a fifth input (e.g., 616d, 705e and/or 805c) (e.g., as described above with respect to FIGS. 6D, 7E, and/or 8C) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (e.g., to add a second indication) (e.g., different from the first input, the second input, and/or the third input). In some embodiments, in response to detecting the fifth input, the computer system displays, via the display generation component, a second indication (e.g., 614g or 716) corresponding to the first content, wherein the second indication is different from the first indication. In some embodiments, the second indication includes a representation of a portion of the first content (e.g., a smaller or larger version of the portion of the first content). In some embodiments, the second indication includes the portion of the first content. Displaying a second indication while displaying the first indication of the first content and in response to a new input allows the computer system to detect new limitations for generating content from the user before displaying any generated content, thereby reducing the number of inputs needed to perform an operation and/or providing improved visual feedback to the user.

In some embodiments, the first input is a tap input (e.g., as described above with respect to FIG. 6C).

In some embodiments, the second input (e.g., 605k, 705g, and/or 705h) is a swipe input (e.g., as described above with respect to FIGS. 6K-6L or FIGS. 7G-7I). The second input being a swipe input allows the computer system to provide a seamless way to change from the first content to the second content (e.g., different generated content that, in some embodiments, is generated in response to the swipe input), thereby providing improved visual feedback to the user and/or providing additional control options without cluttering the user interface with additional displayed controls.

In some embodiments, the third input (6051, 705i, and/or 805e) is a tap input (e.g., as described above with respect to FIGS. 6L, 7I, and/or 8E).

In some embodiments, while displaying the third content without displaying the first indication of the first content, the computer system detects, via the one or more input devices, a sixth input (e.g., a swipe input and/or a non-swipe input (e.g., a verbal input, an audible request, an audible command, an audible statement, a tap input, a hold-and-drag input, a gaze input, an air gesture, mouse movement, and/or a mouse click)) (e.g., to enter into a generative state, as described above) (e.g., as described above with respect to FIGS. 6M, 7J and/or 8F). In some embodiments, in response to detecting the sixth input (and/or while maintaining display of the third content), the computer system displays, via the display generation component, the first indication of the first content (e.g., as described above with respect to FIGS. 6M, 7J, and/or 8F). Displaying the first indication of the first content in response to an input detected while displaying the third content without the first indication of the first content allows the computer system to go back to a generative state and make edits to the third content when needed, thereby providing improved visual feedback to the user and/or performing an operation when a set of conditions has been met without requiring further user input.

In some embodiments, while displaying the first indication of the first content (e.g., 618) (and/or while displaying the first content, the second content, and/or the third content), the computer system displays, via the display generation component, a second user interface element (e.g., 616e) (e.g., as described above with respect to FIG. 6G) (e.g., style user interface element, icon, and/or control). In some embodiments, while displaying the second user interface element (and/or the first content, the second content, the third content, and/or the first indication of the first content), the computer system detects, via the one or more input devices, a seventh input (e.g., 606g and/or 605h) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) corresponding to the second user interface element (e.g., as described above with respect to FIGS. 6G-6H). In some embodiments, in response to detecting the seventh input (e.g., 606g and/or 605h) corresponding to the second user interface element, the computer system changes the second content (and/or the third content) from a first type (e.g., image, text and/or animation) of content to a second type of content different from the first type of content (e.g., as described above with respect to FIGS. 6H-6J). In some embodiments, in response to detecting the seventh input corresponding to the second user interface element, the computer system ceases display of the second content and/or the third content. In some embodiments, in response to detecting the seventh input corresponding to the second user interface element, the computer system display, via the display generation component, another content (e.g., automatically-generated visual content and/or generative visual content) different from the first content and the second content. In some embodiments, the second content and/or the third content is the first type of content. In some embodiments, the other content is the second type of content. In some embodiments, after detecting the seventh input corresponding to the second user interface element while the second content is displayed without the third content, the third content is the second type of content instead of the first type of content as a result of changing the second content from the first type of content to the second type of content (e.g., the third content is the first type of content without detecting the seventh input corresponding to the second user interface element while the second content is displayed without the third content). Changing the second content in response to detecting an input corresponding to the second user interface element allows the computer system to automatically change content from one type to a second type (and/or generate new content of the second type) in response to an input on a control, thereby reducing the number of inputs needed to perform an operation, providing additional control options without cluttering the user interface with additional displayed controls and/or providing improved visual feedback to the user.

In some embodiments, while displaying the first indication of the first content (and/or while displaying the first content, the second content, and/or the third content), the computer system displays, via the display generation component, a third user interface element (e.g., 616d) (e.g., add user interface element, icon, and/or control). In some embodiments, while displaying the third user interface element (and/or the first content, the second content, and/or the third content), the computer system detects, via the one or more input devices, an eighth input (e.g., 605d, 705e and/or 805c) (e.g., as described above with respect to FIGS. 6D, 7E, and/or 8C) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) corresponding to the third user interface element. In some embodiments, in response detecting the eighth input (e.g., 605d, 705e and/or 805c) corresponding to the third user interface element (e.g., 620) (and/or while displaying the third user interface element, the first content, the second content, and/or the third content), the computer system displays, via the display generation component, an input mechanism (e.g., a keyboard, a button to display a keyboard, a text-insertion indication, a text box, a button to initiate a microphone, and/or an indication that a microphone is active) (e.g., a user interface element corresponding to an input mechanism). In some embodiments, while displaying the input mechanism (and/or the third user interface element, the first content, the second content, and/or the third content), the computer system detects, via the one or more input devices, a ninth input (e.g., 605f1-2 or 705f1-2) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (e.g., corresponding to the input mechanism and/or a user interface element to accept new content (e.g., text, a set of one or more words, and/or a graphic)). In some embodiments, in response to detecting the ninth input (and/or while displaying the input mechanism, the third user interface element, the first content, the second content, and/or the third content), the computer system displays, via the display generation component, a third indication (e.g., 614g or 716) corresponding to the ninth input (e.g., as described above with respect to FIGS. 6F and/or 7F). In some embodiments, in response to detecting the ninth input, the computer system ceases display of the input mechanism, the second content, and/or the third content. In some embodiments, the third indication is displayed at least partially overlaid on top of an area that previously included the second content and/or the third content. In some embodiments, in response to detecting the ninth input, the computer system displays new content different from the second content and/or the third content at a location that previously included the second content and/or the third content. In some embodiments, the new content is generated (e.g., using an AI process or a generative AI process) based on the ninth input and/or one or more pieces of content that the second content and/or the third content is generated based on. Displaying an input mechanism in response to detecting a input corresponding to the third user interface element displayed and displaying an third indication corresponding to one or more inputs detected while displaying the input mechanism allows the computer system to display a keyboard when needed that can be used to add additional indications to a generative state, thereby reducing the number of inputs needed to perform an operation, providing additional control options without cluttering the user interface with additional displayed controls, and/or providing improved visual feedback to the user.

In some embodiments, the first indication (e.g., 614a-f as described above with respect to FIG. 6C) (e.g., 706 and/or 716 as described above with respect to FIGS. 7C-7G) (e.g., 814a-f and/or 816 as described above with respect to FIG. 8C) (e.g., as described above with respect to FIGS. 6D-6G and/or FIGS. 7E-7G) is displayed at a first location before displaying the third indication corresponding to the ninth input (e.g., 605f1-2 and/or 705f1-2) (and/or before and/or while detecting the ninth input). In some embodiments, in conjunction with (e.g., before, while, and/or after) displaying the third indication (e.g., 614g and/or 716) corresponding to the ninth input, the computer system displays, via the display generation component, the first indication (e.g., 614a-f as described above with respect to FIG. 6C) (e.g., 706 and/or 716 as described above with respect to FIGS. 7C-7G) (e.g., 814a-f and/or 816 as described above with respect to FIG. 8C) (e.g., as described above with respect to FIGS. 6D-6G and/or FIGS. 7E-7G) at a second location different from the first location. In some embodiments, in conjunction with (e.g., before, while, and/or after) displaying the third indication corresponding to the ninth input, the computer system displays, via the display generation component, the first indication moving from the first location to the second location. Displaying the first indication at a second location while displaying the third indication allows the computer system to automatically move the previous indication displayed to make room for the additional indication, thereby performing an operation when a set of conditions has been met without requiring further user input and/or providing improved visual feedback to the user.

In some embodiments, in response to detecting the third input (e.g., 605l, 705i, or 805e), the computer system displays, via the display generation component, a set of one or more indications (e.g., 612 and/or 636) (e.g., selection and/or resizing indicator, user interface element, control and/or tool) that the third content is selected (e.g., as described about with respect to FIG. 6M) (e.g., while maintaining display of the third content and no longer displaying the first indication of the first content). In some embodiments, the set of one or more indications surrounds the third content. In some embodiments, each indication of the set of one or more indications is located at a border, edge, and/or corner of the third content. In some embodiments, the set of one or more indications are part of and/or included with the third content. Displaying a set of one or more indications when the third content is selected in response to the third input allows the computer system to display controls that the user can use to easily change the size of the content when needed, thereby providing additional control options without cluttering the user interface with additional displayed controls and/or providing improved visual feedback to the user.

In some embodiments, while displaying the set of one or more indications (e.g., 614a-f) and the third content (e.g., 634) at a first size, the computer system detects, via the one or more input devices, a tenth input (e.g., 605m) (e.g., a swipe input and/or a non-swipe input (e.g., a verbal input, an audible request, an audible command, an audible statement, a tap input, a hold-and-drag input, a gaze input, an air gesture, mouse movement, and/or a mouse click)) corresponding to the third content (e.g., as described above with respect to FIG. 6M) (and/or an indication of the set of one or more indications). In some embodiments, in response to detecting the tenth input (e.g., 605m) corresponding to the third content, the computer system displays, via the display generation component, the third content at a second size different from the first size (e.g., as described above with respect to FIG. 6N). In some embodiments, in conjunction with displaying the third content at the second size, the computer system displays the set of one or more indications with a different appearance (e.g., to maintain their position relative to the third content and/or to change size in a similar manner as the third content). In some embodiments, after detecting the tenth input corresponding to the third content, the computer system maintains display of the set of one or more indications such that the set of one or more indications continue to surround the third content (e.g., when the third content is at the second size). In some embodiments, after detecting the tenth input corresponding to the third content, the computer system maintains display of the set of one or more indications such that each indication of the set of one or more indications is located at a border, edge, and/or corner of the third content (e.g., when the third content is at the second size). In some embodiments, the third content changes size while detecting the tenth input. In some embodiments, the third content changes size after detecting release of the tenth input.

In some embodiments, in response to detecting the third input (e.g., 605l, 705i, or 805e) (e.g., as described above with respect to FIGS. 6L, 7I, and/or 8E), the computer system displays, via the display generation component, a plurality of drawing tools (e.g., 610) (e.g., a plurality of user interface elements) (e.g., as described above with respect to FIGS. 6L, 7I and/or 8E). In some embodiments, the plurality of drawings tools are not displayed while detecting the first input, displaying the second content in response to detecting the first input, detecting the second input, displaying the third content in response to detecting the second input, and/or while detecting the third input. In some embodiments, while displaying the plurality of drawing tools, the computer system detects, via the one or more input devices, an eleventh input (e.g., 605m) (e.g., a swipe input and/or a non-swipe input (e.g., a verbal input, an audible request, an audible command, an audible statement, a tap input, a hold-and-drag input, a gaze input, an air gesture, mouse movement, and/or a mouse click)) corresponding to a respective tool (e.g., pencil tool, eraser tool, and/or pen tool) of the plurality of drawing tools, wherein the computer system (e.g., 600) is configured to respond to an input detected via the one or more input devices in a first manner (e.g., initiate the process described above, including displaying the second content content) while (and/or before) detecting the first input. In some embodiments, in response to detecting the eleventh input corresponding to a respective tool, in accordance with a determination that the respective tool is a first tool (e.g., 610a), the computer system configures the computer system to respond to an input detected via the one or more input devices in a second manner (e.g., display a line or a highlight and/or cease display of content at a location of the input) different from the first manner. In some embodiments, in response to detecting the eleventh input corresponding to the respective tool, in accordance with a determination that the respective tool is a second tool (e.g., 610d), the computer system configures the computer system to respond to an input detected via the one or more input devices in a third manner different from the second manner (e.g., as described above with respect to FIG. 6M). Responding differently to an input depending on which tool is being used allows the computer system to display relevant controls to the user when exiting the generative state that can cause the computer system to perform different operations, thereby providing additional control options without cluttering the user interface with additional displayed controls, performing an operation when a set of conditions has been met without requiring further user input, and/or providing improved visual feedback to the user.

In some embodiments, before displaying the first indication (e.g., 614a-f as described above with respect to FIG. 6C) (e.g., 706 and/or 716 as described above with respect to FIGS. 7C-7G) (e.g., 814a-f and/or 816 as described above with respect to FIG. 8C), the computer system displays, via the display generation component, the plurality of tools (e.g., 610, including 610a and/or 610d) (e.g., as described with respect to FIGS. 6A, 7A, and/or 8A).

Note that details of the processes described above with respect to method 1200 (e.g., FIG. 12) are also applicable in an analogous manner to the methods described herein. For example, method 1000 optionally includes one or more of the characteristics of the various methods described herein with reference to method 1200. For example, the second content of method of 1200 can be based on the portion of the first content of method 1000. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to efficiently manipulate content. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for manipulating content. Accordingly, use of such personal information data enables users to have a computer system perform operations for manipulating content. Further, other uses for personal information data that benefit the user are also contemplated by the present disclosure. For instance, historical interactions when manipulating old data may be used to provide insights into a user's intended use for the manipulated content or may be used to improve interactions that the device engages in with the user while manipulating new content.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app. While the use of personal information can benefit a user by improving the operation of the device, the present disclosure contemplates that embodiments of the present technology can be used without such data. For example, operations of the device can use non-personal information (e.g., instead of and/or in place of personal information). Other techniques include making inferences based on non-personal information data or a minimal amount of personal information.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with a display generation component and one or more input devices:
while displaying, via the display generation component, a first indication corresponding to first content, detecting, via the one or more input devices, a first input corresponding to a request to generate content;
in response to detecting the first input corresponding to the request to generate content, displaying, via the display generation component, second content corresponding to the first indication while maintaining display of the first indication corresponding to the first content, wherein the second content is different from the first content;
while displaying the second content corresponding to the first indication and the first indication corresponding to the first content, detecting, via the one or more input devices, a second input;
in response to detecting the second input, displaying, via the display generation component, third content corresponding to the first indication while maintaining display of the first indication corresponding to the first content without displaying the second content, wherein the third content is different from the first content and the second content;
while displaying the third content and the first indication, detecting, via the one or more input devices, a third input; and
in response to detecting the third input:
maintaining display of, via the display generation component, the third content; and
ceasing display of, via the display generation component, the first indication.

2. The method of claim 1, wherein the first indication includes text.

3. The method of claim 1, wherein the second content is a first generated image, and wherein the third content is a second generated image different from the first generated image.

4. The method of claim 1, further comprising:
while displaying the first indication, displaying, via the display generation component, a first user interface element in conjunction with the first indication; and
while displaying the first user interface element and the first indication, detecting, via the one or more input devices, a fourth input corresponding to the first user interface element; and
in response to detecting the fourth input corresponding to the first user interface element, ceasing display of the first indication.

5. The method of claim 1, further comprising:
while displaying the first indication of the first content, detecting, via the one or more input devices, a fifth input; and
in response to detecting the fifth input, displaying, via the display generation component, a second indication corresponding to the first content, wherein the second indication is different from the first indication.

6. The method of claim 1, wherein the first input is a tap input.

7. The method of claim 1, wherein the second input is a swipe input.

8. The method of claim 1, wherein the third input is a tap input.

9. The method of claim 1, further comprising:
while displaying the third content without displaying the first indication of the first content, detecting, via the one or more input devices, a sixth input; and
in response to detecting the sixth input, displaying, via the display generation component, the first indication of the first content.

10. The method of claim 1, further comprising:
while displaying the first indication of the first content, displaying, via the display generation component, a second user interface element;
while displaying the second user interface element, detecting, via the one or more input devices, a seventh input corresponding to the second user interface element; and
in response to detecting the seventh input corresponding to the second user interface element, changing the second content from a first type of content to a second type of content different from the first type of content.

11. The method of claim 1, further comprising:
while displaying the first indication of the first content, displaying, via the display generation component, a third user interface element; and
while displaying the third user interface element, detecting, via the one or more input devices, an eighth input corresponding to the third user interface element;
in response detecting the eighth input corresponding to the third user interface element, displaying, via the display generation component, an input mechanism;
while displaying the input mechanism, detecting, via the one or more input devices, a ninth input; and
in response to detecting the ninth input, displaying, via the display generation component, a third indication corresponding to the ninth input.

12. The method of claim 11, wherein the first indication is displayed at a first location before displaying the third indication corresponding to the ninth input, the method further comprising:
in conjunction with displaying the third indication corresponding to the ninth input, displaying, via the display generation component, the first indication at a second location different from the first location.

13. The method of claim 1, further comprising:
in response to detecting the third input, displaying, via the display generation component, a set of one or more indications that the third content is selected.

14. The method of claim 13, further comprising:
while displaying the set of one or more indications and the third content at a first size, detecting, via the one or more input devices, a tenth input corresponding to the third content; and
in response to detecting the tenth input corresponding to the third content, displaying, via the display generation component, the third content at a second size different from the first size.

15. The method of claim 1, further comprising:
in response to detecting the third input, displaying, via the display generation component, a plurality of drawing tools; and
while displaying the plurality of drawing tools, detecting, via the one or more input devices, an eleventh input corresponding to a respective tool of the plurality of drawing tools, wherein the computer system is configured to respond to an input detected via the one or more input devices in a first manner while detecting the first input; and
in response to detecting the eleventh input corresponding to a respective tool:
in accordance with a determination that the respective tool is a first tool, configuring the computer system to respond to an input detected via the one or more input devices in a second manner different from the first manner; and
in accordance with a determination that the respective tool is a second tool, configuring the computer system to respond to an input detected via the one or more input devices in a third manner different from the second manner.

16. The method claim 15, further comprising:
before displaying the first indication, displaying, via the display generation component, the plurality of tools.

17. A non-transitory computer-readable storage medium storing one or more programs configured to be executed by one or more processors of a computer system that is in communication with a display generation component and one or more input devices, the one or more programs including instructions for:
while displaying, via the display generation component, a first indication corresponding to first content, detecting, via the one or more input devices, a first input corresponding to a request to generate content;
in response to detecting the first input corresponding to the request to generate content, displaying, via the display generation component, second content corresponding to the first indication while maintaining display of the first indication corresponding to the first content, wherein the second content is different from the first content;
while displaying the second content corresponding to the first indication and the first indication corresponding to the first content, detecting, via the one or more input devices, a second input;
in response to detecting the second input, displaying, via the display generation component, third content corresponding to the first indication while maintaining display of the first indication corresponding to the first content without displaying the second content, wherein the third content is different from the first content and the second content;
while displaying the third content and the first indication, detecting, via the one or more input devices, a third input; and
in response to detecting the third input:
maintaining display of, via the display generation component, the third content; and
ceasing display of, via the display generation component, the first indication.

18. A computer system configured to communicate with a display generation component and one or more input devices, comprising:
one or more processors; and
memory storing one or more programs configured to be executed by the one or more processors, the one or more programs including instructions for:
while displaying, via the display generation component, a first indication corresponding to first content, detecting, via the one or more input devices, a first input corresponding to a request to generate content;
in response to detecting the first input corresponding to the request to generate content, displaying, via the display generation component, second content corresponding to the first indication while maintaining display of the first indication corresponding to the first content, wherein the second content is different from the first content;
while displaying the second content corresponding to the first indication and the first indication corresponding to the first content, detecting, via the one or more input devices, a second input;
in response to detecting the second input, displaying, via the display generation component, third content corresponding to the first indication while maintaining display of the first indication corresponding to the first content without displaying the second content, wherein the third content is different from the first content and the second content;
while displaying the third content and the first indication, detecting, via the one or more input devices, a third input; and
in response to detecting the third input:
maintaining display of, via the display generation component, the third content; and
ceasing display of, via the display generation component, the first indication.
